(19) United States
(12) Patent Application Publication
(10) Pub. No.: US 2026/0205582 A1
(43) Pub. Date: Jul. 16, 2026

(54) IMAGE DECODING METHOD, IMAGE DECODING APPARATUS, IMAGE ENCODING METHOD, AND IMAGE ENCODING APPARATUS FOR ADAPTIVE LOOP FILTERING

(71) Applicant: SAMSUNG ELECTRONICS CO., LTD., Suwon-si (KR)

(72) Inventors: Yinji PIAO, Suwon-si (KR); Kwangpyo CHOI, Suwon-si (KR)

(73) Assignee: SAMSUNG ELECTRONICS CO., LTD., Suwon-si (KR)

(21) Appl. No.: 19/563,787

(22) Filed: Mar. 11, 2026

Related U.S. Application Data
(63) Continuation of application No. PCT/KR2024/009792, filed on Jul. 9, 2024.

(30) Foreign Application Priority Data
Sep. 12, 2023 (KR) 10-2023-0121385
Feb. 23, 2024 (KR) 10-2024-0026718

(51) Int. Cl. H04N 19/117; H04N 19/184; H04N 19/196; H04N 19/82

(52) U.S. Cl. CPC H04N 19/117; H04N 19/184; H04N 19/196; H04N 19/82

(57) ABSTRACT

An image decoding method may include obtaining information regarding adaptive loop filtering from a bitstream, obtaining a first filtered residual sample corresponding to a current sample by performing filtering based on a residual sample for the current sample and a first filter, obtaining a second filtered residual sample corresponding to the current sample by performing filtering based on the first filtered residual block and a second filter, and obtaining an adaptive loop filtered sample based on the first filtered residual sample, the second filtered residual sample, and at least one adaptive filter coefficient obtained from the information regarding the adaptive loop filtering.

### CROSS-REFERENCE TO RELATED APPLICATIONS

This application is a continuation of International Application No. PCT/KR2024/009792, filed on Jul. 9, 2024, which is based on and claims priority Korean Provisional Application No. 10-2023-0121385, filed on Sep. 12, 2023, and Korean Patent Application No. 10-2024-0026718, filed on Feb. 23, 2024, in the Korean Ministry of Intellectual Property, the disclosures of which are incorporated by reference herein in their entireties.

### BACKGROUND

### 1. Field

The present disclosure relates to the field of image encoding and decoding, and more particularly, to a method and apparatus for encoding and decoding an image by performing adaptive loop filtering on a current block included in a current image.

### 2. Description of Related Art

Image data is encoded in accordance with a predefined data compression standard and is then stored on a recording medium in the form of a bitstream or transmitted through a communication channel.

With the development and spread of hardware capable of reproducing and storing high-resolution or high-definition image content, the need for codecs that effectively encode or decode high-resolution or high-definition image content is increasing. Encoded image content may be decoded and reproduced. Recently, methods of effectively compressing high-resolution or high-definition image content have been implemented. For example, it is proposed that image compression technology may be effectively implemented through a process of manipulating a filtering method that is used in image encoding and decoding processes.

As one of the techniques for manipulating a filtering method, filtering parameters used for in-loop filtering may be variously modified, and decoded or encoded data used for filtering may be diversified.

### SUMMARY

An image encoding method and apparatus and an image decoding method and apparatus, according to an embodiment, aim to improve the performance of prediction encoding and prediction decoding with respect to a current block.

An image encoding method and apparatus and an image decoding method and apparatus, according to an embodiment, aim to contribute to improving image quality by reducing noise in a filtered block or reducing an error between an original block and a filtered block.

The technical problems to be solved by the present disclosure are not limited to those described above, and other technical problems that are not described herein will be clearly understood by those of ordinary skill in the art from the following description.

In an embodiment of the present disclosure, an image decoding method for adaptive loop filtering is provided. The image decoding method may include obtaining information regarding adaptive loop filtering from a bitstream. The image decoding method may include obtaining a first filtered residual sample corresponding to a current sample by performing filtering based on a residual sample for the current sample and a first filter. The image decoding method may include obtaining a second filtered residual sample corresponding to the current sample by performing filtering based on the first filtered residual sample and a second filter. The image decoding method may include obtaining an adaptive loop filtered sample based on the first filtered residual sample, the second filtered residual sample, and at least one adaptive filter coefficient obtained from the information regarding the adaptive loop filtering.

In an embodiment of the present disclosure, an image decoding apparatus for adaptive loop filtering, including at least one memory storing at least one instruction and at least one processor configured to operate according to the at least one instruction, is provided. The at least one processor may obtain information regarding adaptive loop filtering from a bitstream. The at least one processor may obtain a first filtered residual sample corresponding to the current sample by performing filtering on the residual sample for the current sample based on the first filter. The at least one processor may obtain a second filtered residual sample corresponding to the current sample by performing filtering based on the first filtered residual sample and a second filter. The at least one processor may obtain an adaptive loop filtered sample based on the first filtered residual sample, the second filtered residual sample, and at least one adaptive filter coefficient obtained from the information regarding the adaptive loop filtering.

In an embodiment of the present disclosure, an image encoding method for adaptive loop filtering is provided. The image encoding method may include obtaining a first filtered residual sample corresponding to a current sample by performing filtering based on a residual sample for the current sample and a first filter. The image encoding method may include obtaining a second filtered residual sample corresponding to the current sample by performing filtering based on the first filtered residual block and a second filter. The image encoding method may include determining at least one adaptive filter coefficient for performing adaptive loop filtering on a current block based on the first filtered residual sample and the second filtered residual sample. The image encoding method may include generating a bitstream including information regarding the adaptive loop filtering based on the at least one adaptive filter coefficient. In an embodiment of the present disclosure, an image encoding apparatus for adaptive loop filtering, including at least one memory storing at least one instruction and at least one processor operating according to the at least one instruction, is provided. The at least one processor may obtain a first filtered residual sample corresponding to the current sample by performing filtering based on the residual sample for the current sample and the first filter. The at least one processor may obtain a second filtered residual sample corresponding to the current sample by performing filtering based on a first filtered residual block and a second filter. The at least one processor may determine at least one adaptive filter coefficient for performing adaptive loop filtering on a current block based on the first filtered residual sample and the second filtered residual sample. The at least one processor may generate a bitstream including information regarding adaptive loop filtering based on at least one adaptive filter coefficient.

In an embodiment, a computer-readable recording medium having a bitstream recorded thereon is provided. The bitstream may include information regarding adaptive loop filtering. The information regarding the adaptive loop filtering may be based on at least one adaptive filter coefficient for performing adaptive loop filtering on a current block including the current sample, wherein the at least one adaptive filter coefficient may be determined based on a first filtered residual sample and a second filtered residual sample, wherein the first filtered residual sample corresponding to the current sample may be obtained by performing filtering based on a residual sample for the current sample and a first filter, and wherein the second filtered residual sample corresponding to the current sample may be obtained by performing filtering based on the first filtered residual sample and a second filter.

An image encoding method and apparatus and an image decoding method and apparatus, according to one or more embodiments, may improve the performance of prediction encoding and prediction decoding with respect to a current block.

An image encoding method and apparatus and an image decoding method and apparatus, according to one or more embodiments, may improve image quality by reducing noise in a filtered block or reducing an error between an original block and a filtered block.

The technical problems to be solved by the present disclosure are not limited to those described above, and other technical problems that are not described herein will be clearly understood by those of ordinary skill in the art from the following description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an image decoding apparatus according to an embodiment;

FIG. 2 is a block diagram of an image encoding apparatus according to an embodiment;

FIG. 3 illustrates a process of determining at least one coding unit by splitting a current coding unit, according to an embodiment;

FIG. 4 illustrates a process of determining at least one coding unit by splitting a non-square-shaped coding unit, according to an embodiment;

FIG. 5 illustrates a process of splitting a coding unit based on at least one of block shape information and split shape mode information, according to an embodiment;

FIG. 6 illustrates a method of determining a certain coding unit among an odd number of coding units, according to an embodiment;

FIG. 7 illustrates the order in which a plurality of coding units are processed when the plurality of coding units are determined by splitting a current coding unit, according to an embodiment;

FIG. 8 illustrates a process of, when it is impossible to process coding units in a certain order, determining that a current coding unit is split into an odd number of coding units, according to an embodiment;

FIG. 9 illustrates a process of determining at least one coding unit by splitting a first coding unit, according to an embodiment;

FIG. 10 illustrates that a splittable shape is limited when a non-squared-shaped second coding unit determined by splitting a first coding unit satisfies a certain condition, according to an embodiment;

FIG. 11 illustrates a process of splitting a square-shaped coding unit when split shape mode information is unable to indicate “split into four square-shaped coding units,” according to an embodiment;

FIG. 12 illustrates that a processing order between a plurality of coding units may vary depending on a process of splitting a coding unit, according to an embodiment;

FIG. 13 illustrates a process in which, when a coding unit is recursively split to determine a plurality of coding units, the depth of the coding unit is determined as the shape and size of the coding unit change, according to an embodiment;

FIG. 14 illustrates an index (a part index, hereinafter PID) for depth and coding unit distinction, which may be determined according to the shape and size of coding units, according to an embodiment;

FIG. 15 illustrates that a plurality of coding units are determined according to a plurality of certain data units included in a picture, according to an embodiment;

FIG. 16 illustrates coding units that may be determined for each picture when a combination of shapes into which coding units are splittable is different for each picture, according to an embodiment;

FIG. 17 illustrates various shapes of coding units that may be determined based on split shape mode information expressed in binary code, according to an embodiment;

FIG. 18 illustrates other shapes of coding units that may be determined based on split shape mode information expressed in binary code, according to an embodiment;

FIG. 19 illustrates a block diagram of an image encoding and decoding system that performs in-loop filtering, according to an embodiment;

FIG. 20 is a block diagram illustrating a configuration of an image decoding apparatus according to an embodiment;

FIG. 21 is a diagram illustrating adaptive loop filtering performed in an in-loop filtering unit, according to an embodiment;

FIG. 22 is a diagram for describing an operation of performing filtering on a current sample, according to an embodiment;

FIG. 23 is a diagram for describing an operation of performing adaptive loop filtering, according to an embodiment;

FIG. 24 is a diagram illustrating adaptive loop filtering performed in an in-loop filtering unit, according to an embodiment;

FIG. 25 is a diagram for describing an operation of performing filtering on a current sample, according to an embodiment;

FIG. 26 is a diagram for describing an operation of performing filtering on a current sample, according to an embodiment;

FIG. 27 is a diagram illustrating adaptive loop filtering performed in an in-loop filtering unit, according to an embodiment;

FIG. 28 is a diagram illustrating adaptive loop filtering performed in an in-loop filtering unit, according to an embodiment;

FIG. 29 is a diagram illustrating adaptive loop filtering performed in an in-loop filtering unit, according to an embodiment;

FIG. 30 is a diagram illustrating adaptive loop filtering performed in an in-loop filtering unit, according to an embodiment;

FIG. 31 is a flowchart of an image decoding method according to an embodiment;

FIG. 32 is a block diagram illustrating a configuration of an image encoding apparatus according to an embodiment; and

FIG. 33 is a flowchart of an image encoding method according to an embodiment.

### DETAILED DESCRIPTION

As the present disclosure allows for various changes and numerous embodiments, embodiments will be illustrated in the drawings and described in detail in the detailed description. However, this is not intended to limit the embodiments of the present disclosure, and the present disclosure includes all modifications, equivalents, and substitutes falling within the spirit and technical scope of various embodiments.

In describing embodiments, when the detailed description of the relevant known technologies is determined to unnecessarily obscure the gist of the present disclosure, the detailed description thereof may be omitted herein. Also, numbers (e.g., first, second, etc.) used in the description of embodiments may correspond to identification symbols for distinguishing one element from another.

Throughout the present disclosure, the expression “at least one of a, b or c” indicates only a, only b, only c, both a and b, both a and c, both b and c, or all of a, b, and c.

When one element is referred to as being “connected” or “coupled” to another element, the one element may be directly connected or coupled to the other element, but the elements may be connected or coupled to each other via an intervening element therebetween unless otherwise stated.

An element represented by “unit,” “module,” etc. in the present disclosure may be one element in which two or more elements are combined, or may be two or more elements into which one element is more subdivided. Also, each of the elements to be described below may additionally perform, in addition to the main function thereof, some or all of the functions that other elements are responsible for, and some of the main functions that the respective elements are responsible for may be dedicated by other elements.

In the present disclosure, an ‘image’ may represent a picture, a still image, a frame, a moving image composed of a plurality of consecutive still images, or a video.

In the present disclosure, a ‘sample’ may refer to data to be processed as data assigned to a sampling location of an image. For example, a pixel in a frame of a spatial domain may correspond to the sample. A unit including a plurality of samples may be defined as a block.

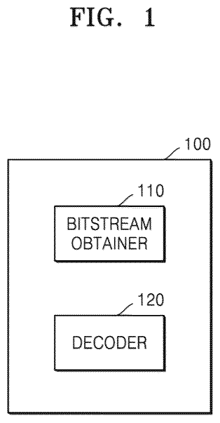

Hereinafter, an image encoding method and apparatus and an image decoding method and apparatus, based on a tree-structured coding unit and a transform unit, according to an embodiment, are disclosed with reference to FIGS. 1 to 33.

FIG. 1 illustrates a block diagram of an image decoding apparatus 100 according to an embodiment.

The image decoding apparatus 100 may include a bitstream obtainer 110 and a decoder 120. The bitstream obtainer 110 and the decoder 120 may include at least one processor. In addition, the bitstream obtainer 110 and the decoder 120 may include memory that stores instructions that are executed by at least one processor individually or collectively.

The bitstream obtainer 110 may receive a bitstream. The bitstream includes information about an image encoded by an image encoding apparatus 200 described below. In addition, the bitstream may be transmitted from the image encoding apparatus 200. The image encoding apparatus 200 and the image decoding apparatus 100 may be connected to each other by wire or wirelessly, and the bitstream obtainer 110 may receive the bitstream by wire or wirelessly. The bitstream obtainer 110 may receive the bitstream from a storage medium, such as an optical media or a hard disk. The decoder 120 may reconstruct an image based on information obtained from the received bitstream. The decoder 120 may obtain, from the bitstream, a syntax element for reconstructing the image. The decoder 120 may reconstruct the image based on the syntax element.

To describe in detail the operation of the image decoding apparatus 100, the bitstream obtainer 110 may receive the bitstream.

The image decoding apparatus 100 may perform an operation of obtaining, from the bitstream, a bin string corresponding to a split shape mode of a coding unit. The image decoding apparatus 100 may perform an operation of determining a splitting rule of a coding unit. In addition, the image decoding apparatus 100 may perform an operation of splitting a coding unit into a plurality of coding units based on at least one of the bin string corresponding to the split shape mode and the splitting rule. To determine the splitting rule, the image decoding apparatus 100 may determine a first allowable range of the size of the coding unit according to the width-to-height ratio of the coding unit. To determine the splitting rule, the image decoding apparatus 100 may determine a second allowable range of the size of the coding unit according to the split shape mode of the coding unit.

Hereinafter, the splitting of the coding unit according to an embodiment of the present disclosure is described in detail.

First, a picture may be divided into one or more slices or one or more tiles. One slice or one tile may be a sequence of one or more coding tree units (CTUs). Depending on the implementation, one slice may include one or more tiles, and one slice may include one or more CTUs. The slice including one or more tiles may be determined within a picture.

As a concept contrasted with the CTU, there is a coding tree block (CTB). The CTB is an N×N block including N×N samples (where N is an integer). Each color component may be divided into one or more CTUs.

When the picture has three sample arrays (sample arrays for Y, Cr, and Cb components), the CTU is a unit that includes a CTB of a luma sample, two CTBs of chroma samples corresponding thereto, and syntax structures used to encode the luma samples and the chroma samples. When the picture is a monochrome picture, the CTU is a unit that includes a CTB of a monochrome sample and syntax structures used to encode monochrome samples. When the picture is a picture encoded as a color plane divided for each color component, the CTU is a unit that includes syntax structures used to encode the picture and samples of the picture.

One CTB may be divided into M×N coding blocks including M×N samples (where M and N are integers).

When the picture has three sample arrays for Y, Cr, and Cb components, a coding unit (CU) is a unit that includes a coding block of a luma sample, two coding blocks of chroma samples corresponding thereto, and syntax structures used to encode the luma samples and the chroma samples. When the picture is a monochrome picture, the CU is a unit that includes a coding block of a monochrome sample and syntax structures used to encode monochrome samples. When the picture is a picture encoded as a color plane divided for each color component, the CU is a unit that includes syntax structures used to encode the picture and samples of the picture.

As described above, the CTB and the CTU are distinct concepts, and the coding block and the CU are distinct concepts. That is, the CU (the CTU) refers to a data structure including the coding block (the CTB) including the corresponding sample and the syntax structure corresponding thereto. However, those of ordinary skill in the art may understand that the CU (the CTU) or the coding block (the CTB) refers to a block of a certain size including a certain number of samples. Therefore, in the following specification, the CTB and the CTU, or the coding block and the CU may be described without distinction unless there are special circumstances.

An image may be divided into CTUs. The size of the CTU may be determined based on information obtained from the bitstream. The shape of the CTUs be squares with the same size. However, embodiments of the present disclosure are not limited thereto.

For example, information about a maximum size of a luma coding block may be obtained from the bitstream. For example, the maximum size of the luma coding block indicated by the information about the maximum size of the luma coding block may be one of 4×4, 8×8, 16×16, 32×32, 64×64, 128×128, and 256×256.

For example, information about the maximum size of the luma coding block that may be split into two and the luma block size difference may be obtained from the bitstream. The information about the luma block size difference may indicate the size difference between the luma CTU and the maximum luma coding block that may be split into two. Therefore, the size of the luma CTU may be determined by combining the information about the maximum size of the luma coding block that may be split into two and the information about the luma block size difference, which are obtained from the bitstream. The size of the chroma CTU may also be determined by using the size of the chroma CTU. For example, when a Y:Cb:Cr ratio is 4:2:0 according to a color format, the size of the chroma block may be half the size of the luma block, and similarly, the size of the chroma CTU may be half the size of the luma CTU.

According to an embodiment, because information about the maximum size of the luma coding block capable of binary split is obtained from the bitstream, the maximum size of the luma coding block capable of binary split may be variably determined. In contrast, the maximum size of the luma coding block capable of ternary split may be fixed. For example, the maximum size of the luma coding block capable of ternary split in an I picture may be 32×32, and the maximum size of the luma coding block capable of ternary split in a P picture or a B picture may be 64×64.

In addition, the CTU may be hierarchically split into CUs based on the split shape mode information obtained from the bitstream. As the split shape mode information, at least one of information indicating quad split or non-quad split, information indicating multi-split or non-multi-split, split direction information, and split type information may be obtained from the bitstream.

For example, the information indicating quad split or non-quad split may indicate whether a current CU is to be quad split (QUAD_SPLIT) or not to be quad split.

When the current CU is not quad-split, the information indicating multi-split or non-multi-split may indicate whether the current CU will be no longer split (NO_SPLIT) or whether the current CU will be binary/ternary split.

When the current CU is binary split or ternary split, the split direction information indicates that the current CU is split in either a horizontal direction or a vertical direction.

When the current CU is split in the horizontal direction or the vertical direction, the split type information indicates that the current CU is binary split or ternary split.

The split mode of the current CU may be determined according to the split direction information and the split type information. The split mode when the current CU is binary split in the horizontal direction may be determined as binary horizontal split (SPLIT_BT_HOR), the split mode when the current CU is ternary split in the horizontal direction may be determined as ternary horizontal split (SPLIT_TT_HOR), the split mode when the current CU is binary split in the vertical direction may be determined as binary vertical split (SPLIT_BT_VER), and the split mode when the current CU is ternary split in the vertical direction may be determined as ternary vertical split (SPLIT_TT_VER).

The image decoding apparatus 100 may obtain the split shape mode information from the bitstream as one bin string. The form of the bitstream received by the image decoding apparatus 100 may include fixed length binary code, unary code, truncated unary code, predetermined binary code, etc. The bin string represents information as a sequence of binary digits. The bin string may include at least one bit. The image decoding apparatus 100 may obtain split shape mode information corresponding to the bin string based on the splitting rule. The image decoding apparatus 100 may determine whether or not to quad split the CU, the split direction, and the split type based on one bin string.

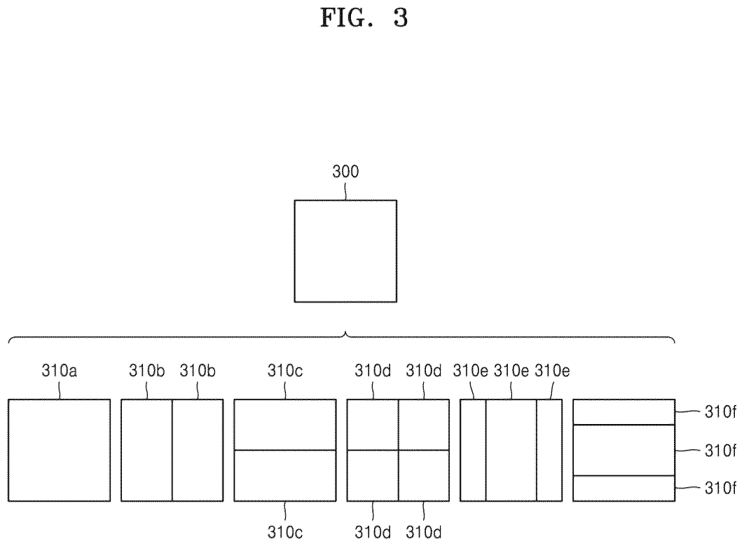

The CU may be less than or equal to the CTU. For example, because the CTU is also a CU with a maximum size, the CTU is one of the CUs. When the split shape mode information for the CTU indicates “not split,” the CU determined from the CTU has the same size as the CTU. When the split shape mode information for the CTU indicates “split,” the CTU may be split into CUs. In addition, when the split shape mode information for the CU indicates “split,” the CUs may be split into CUs with smaller sizes. However, the splitting of the image is not limited thereto, and the CTU and the CU may not be distinguished. The splitting of the CU is described in more detail with reference to FIGS. 3 to 16.

In addition, one or more prediction blocks for prediction may be determined from the CU. The prediction block may be less than or equal to the CU. In addition, one or more transform blocks for transformation may be determined from the CU. The transform block may be less than or equal to the CU.

The shape and size of the transform block and the prediction block may be unrelated.

In another embodiment, prediction may be performed by using the CU as the prediction block. In addition, transformation may be performed by using the CU as the transform block.

The splitting of the CU is described in more detail with reference to FIGS. 3 to 16. A current block and a neighboring block of the present disclosure may represent one of the CTU, the CU, the prediction block, and the transform block. In addition, the current block or the current CU is a block that is currently being decoded or encoded or a block that is currently being split. The neighboring block may be a block that has be reconstructed before the current block. The neighboring block may be spatially or temporally adjacent to the current block. The neighboring block may be positioned on one of a lower left side, a left side, an upper left side, an upper right side, a right side, and a lower right side of the current block.

FIG. 3 illustrates a process in which the image decoding apparatus 100 determines at least one CU by splitting a current CU, according to an embodiment.

The block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a width-to-height ratio, or a size of a CU.

The shape of the CU may include a square and a non-square. When the lengths of the width and the height of the CU are equal to each other (that is, when the block shape of the CU is 4N×4N), the image decoding apparatus 100 may determine the block shape information of the CU as a square. The image decoding apparatus 100 may determine that the shape of the CU is a non-square.

When the lengths of the width and the height of the CU are different from each other (that is, when the block shape of the CU is 4N×2N, 2N×4N, 4N×N, N×4N, 32N×N, N×32N, 16N×N, N×16N, 8N×N, or N×8N), the image decoding apparatus 100 may determine the block shape information of the CU as a non-square. When the shape of the CU is a non-square, the image decoding apparatus 100 may determine the width-to-height ratio among the pieces of block shape information of the CU as at least one of 1:2, 2:1, 1:4, 4:1, 1:8, 8:1, 1:16, 16:1, 1:32, and 32:1. In addition, the image decoding apparatus 100 may determine whether the CU is in the horizontal direction or the vertical direction, based on the lengths of the width and the height of the CU. In addition, the image decoding apparatus 100 may determine the size of the CU based on at least one of the length of the width of the CU, the length of the height of the CU, or the area of the CU.

According to an embodiment, the image decoding apparatus 100 may determine the shape of the CU by using the block shape information, and may determine the shape into which the CU is split by using the split shape mode information. That is, the splitting method of the CU indicated by the split shape mode information may be determined according to what block shape the block shape information used by the image decoding apparatus 100 indicates.

The image decoding apparatus 100 may obtain the split shape mode information from the bitstream. However, embodiments of the present disclosure are not limited thereto, and the image decoding apparatus 100 and the image encoding apparatus 200 may determine prearranged split shape mode information based on the block shape information. The image decoding apparatus 100 may determine prearranged split type mode information for a CTU or a minimum CU. For example, the image decoding apparatus 100 may determine the split shape mode information for the CTU as quad split. In addition, the image decoding apparatus 100 may determine the split shape mode information for the minimum CU as “not split.” Specifically, the image decoding apparatus 100 may determine the size of the CTU as 256×256. The image decoding apparatus 100 may determine the prearranged split type mode information as quad split. The quad split is a split shape mode that bisects both the width and the height of the CU. The image decoding apparatus 100 may obtain a CU with a size of 128×128 from a CTU with a size of 256×256 based on the split shape mode information. In addition, the image decoding apparatus 100 may determine the size of the minimum CU as 4×4. The image decoding apparatus 100 may obtain the split shape mode information indicating “not split” for the minimum CU.

According to an embodiment, the image decoding apparatus 100 may use block shape information indicating that a current CU has a square shape. For example, the image decoding apparatus 100 may determine whether to not split the square-shaped CU, whether to split the square-shaped CU vertically, whether to split the square-shaped CU horizontally, or whether to split the square-shaped CU into four CUs, based on the split shape mode information. Referring to FIG. 3, when block shape information of a current CU 300 indicates a square shape, the decoder 120 may not split a CU 310a having the same size as the current CU 300 according to the split shape mode information indicating “not split,” or may determine split CUs 310b, 310c, 310d, 310e, 310f, etc. based on the split shape mode information indicating a certain splitting method.

Referring to FIG. 3, the image decoding apparatus 100 may determine two CUs 310b that are split from the current CU 300 in the vertical direction based on the split shape mode information indicating “split in the vertical direction,” according to an embodiment. The image decoding apparatus 100 may determine two CUs 310c that are split from the current CU 300 in the horizontal direction based on the split shape mode information indicating “split in the horizontal direction.” The image decoding apparatus 100 may determine four CUs 310d that are split from the current CU 300 in the vertical direction and the horizontal direction based on the split shape mode information indicating “split in the vertical direction and the horizontal direction.” The image decoding apparatus 100 may determine three CUs 310e that are split from the current CU 300 in the vertical direction based on the split shape mode information indicating “ternary split in the vertical direction,” according to an embodiment. The image decoding apparatus 100 may determine three CUs 310f that are split from the current CU 300 in the horizontal direction based on the split shape mode information indicating “ternary split in the horizontal direction.” However, the split shape into which the square-shaped CU is splittable should not be interpreted as being limited to the above-described shape, and may include various shapes that may be represented by the split shape mode information. The certain split shapes into which the square-shaped CU is split are described in detail below through various embodiments.

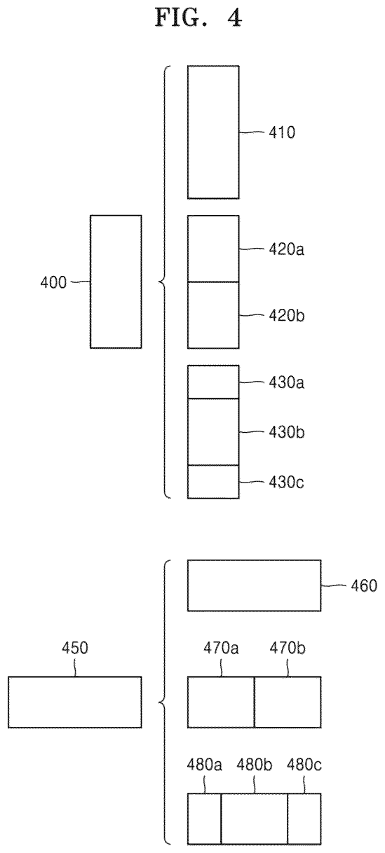

FIG. 4 illustrates a process in which the image decoding apparatus 100 determines at least one CU by splitting a non-square-shaped CU, according to an embodiment.

According to an embodiment, the image decoding apparatus 100 may use block shape information indicating that a current CU has a non-square shape. The image decoding apparatus 100 may determine whether not to split the non-square-shaped current CU or whether to split the non-square-shaped current CU in a certain method, based on the split shape mode information. Referring to FIG. 4, when block shape information of a current CU 400 or 450 indicates a non-square shape, the image decoding apparatus 100 may determine a CU 410 or 460 having the same size as the current CU 400 or 450 according to the split shape mode information indicating “not split,” or may determine split CUs 420a, 420b, 430a, 430b, 430c, 470a, 470b, 480a, 480b, and 480c based on the split shape mode information indicating a certain splitting method. The certain splitting method by which the non-square-shaped CU is split is described in detail below through various embodiments.

According to an embodiment, the image decoding apparatus 100 may determine the shape into which the CU is split by using the split shape mode information, and in this case, the split shape mode information may indicate the number of at least one CU generated by splitting the CU. Referring to FIG. 4, when the split shape mode information indicates that the current CU 400 or 450 is split into two CUs, the image decoding apparatus 100 may determine two CUs 420a and 420b or 470a and 470b included in the current CU by splitting the current CU 400 or 450 based on the split shape mode information.

According to an embodiment, when the image decoding apparatus 100 splits the non-square-shaped current CU 400 or 450 based on the split shape mode information, the image decoding apparatus 100 may split the current CU by taking into account the location of the long side of the non-square-shaped current CU 400 or 450. For example, the image decoding apparatus 100 may determine a plurality of CUs by splitting the current CU 400 or 450 in a direction that splits the long side of the current CU 400 or 450 by taking into account the shape of the current CU 400 or 450.

According to an embodiment, when the split shape mode information indicates that the CU is split (ternary split) into an odd number of blocks, the image decoding apparatus 100 may determine an odd number of CUs included in the current CU 400 or 450. For example, when the split shape mode information indicates that the current CU 400 or 450 is split into three CUs, the image decoding apparatus 100 may split the current CU 400 or 450 into three CUs 430a, 430b, and 430c, or 480a, 480b, and 480c.

In an embodiment, the width-to-height ratio of the current CU 400 or 450 may be 4:1 or 1:4. When the width-to-height ratio is 4:1, the block shape information may be the horizontal direction because the width is longer than the height. When the width-to-height ratio is 1:4, the block shape information may be the vertical direction because the width is shorter than the height. The image decoding apparatus 100 may determine to split the current CU into the odd number of blocks based on the split shape mode information. In addition, the image decoding apparatus 100 may determine the split direction of the current CU 400 or 450 based on the block shape information of the current CU 400 or 450. For example, when the current CU 400 is in the vertical direction, the image decoding apparatus 100 may determine the CUs 430a, 430b, and 430c by splitting the current CU 400 in the horizontal direction. In addition, when the current CU 450 is in the horizontal direction, the image decoding apparatus 100 may determine the CUs 480a, 480b, and 480c by splitting the current CU 450 in the vertical direction.

According to an embodiment, the image decoding apparatus 100 may determine the odd number of CUs included in the current CU 400 or 450, and the sizes of the determined CUs may not all be the same. For example, among the determined odd number of CUs 430a, 430b, and 430c, or 480a, 480b, and 480c, the size of the certain CU 430b or 480b may be different from the size of the other CUs 430a and 430c, or 480a and 480c. That is, the CU into which the current CU 400 or 450 may be split and determined may have a plurality of types of sizes, and in some cases, the odd number of CUs 430a, 430b, and 430c, or 480a, 480b, and 480c may have different sizes.

According to an embodiment, when the split shape mode information indicates that the CU is split into an odd number of blocks, the image decoding apparatus 100 may determine an odd number of CUs included in the current CU 400 or 450, and furthermore, the image decoding apparatus 100 may impose predetermined restrictions on at least one CU among the odd number of CUs generated by splitting. Referring to FIG. 4, the image decoding apparatus 100 may perform a decoding process for the CU 430b or 480b, which is positioned in the center among three CUs 430a, 430b, and 430c, or 480a, 480b and 480c generated by splitting the current CU 400 or 450, differently from the other CUs 430a and 430c, or 480a and 480c. For example, the image decoding apparatus 100 may restrict the CU 430b or 480b positioned in the center not to be split any longer, unlike the other CUs 430a and 430c, or 480a and 480c, or may restrict the CU 430b or 480b to be split only a certain number of times.

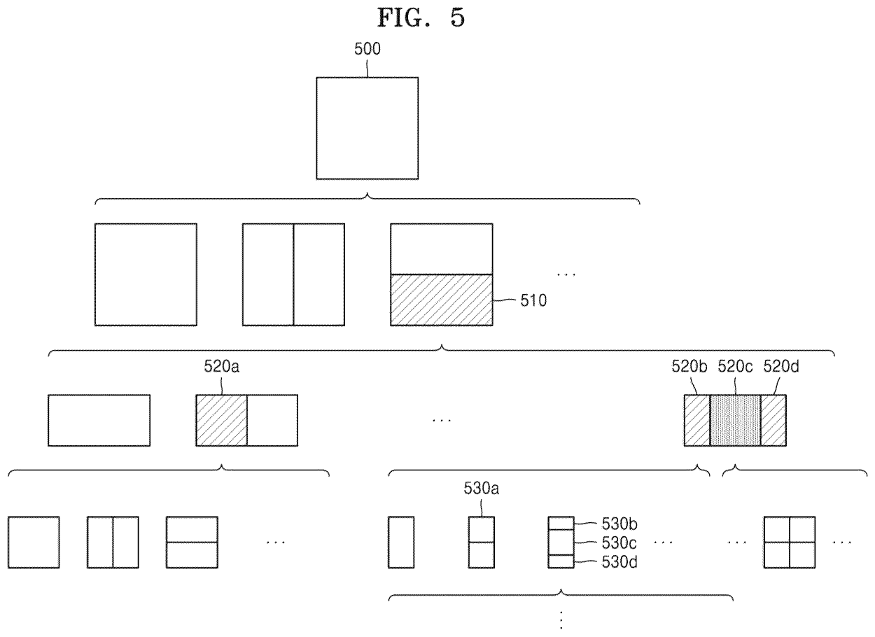

FIG. 5 illustrates a process in which the image decoding apparatus 100 splits a CU based on at least one of block shape information and split shape mode information, according to an embodiment.

According to an embodiment, the image decoding apparatus 100 may determine to split or not to split a square-shaped first CU 500 into CUs based on at least one of block shape information and split shape mode information. According to an embodiment, when the split shape mode information indicates splitting the first CU 500 in the horizontal direction, the image decoding apparatus 100 may determine a second CU 510 by splitting the first CU 500 in the horizontal direction. The first CU, the second CU, and a third CU used according to an embodiment are terms used to understand the relationship before and after splitting between CUs. For example, when the first CU is split, the second CU may be determined, and when the second CU is split, the third CU may be determined. Hereinafter, the relationship between the first CU, the second CU, and the third CU used may be understood as following the above-described characteristics.

According to an embodiment, the image decoding apparatus 100 may determine to split or not split the determined second CU 510 into CUs based on the split shape mode information. Referring to FIG. 5, the image decoding apparatus 100 may split the non-square-shaped second CU 510 determined by splitting the first CU 500 into at least one third CU 520a, 520b, 520c, 520d, etc. based on the split shape mode information, or may not split the second CU 510. The image decoding apparatus 100 may obtain the split shape mode information, the image decoding apparatus 100 may split a plurality of second CUs (e.g., 510) of various shapes by splitting the first CU 500 based on the obtained split shape mode information, and the second CU 510 may be split according to the method in which the first CU 500 is split based on the split shape mode information. According to an embodiment, when the first CU 500 is split into the second CU 510 based on the split shape mode information for the first CU 500, the second CU 510 may also be split into the third CU (e.g., 520a, 520b, 520c, 520d, etc.) based on the split shape mode information for the second CU 510. That is, the CU may be recursively split based on the split shape mode information associated with each CU. Therefore, the square-shaped CU may be determined from the non-square-shaped CU, and the square-shaped CU may be recursively split to determine the non-square-shaped CU.

Referring to FIG. 5, a certain CU (e.g., a CU positioned in the center or a square-shaped CU) among an odd number of third CUs 520b, 520c, and 520d determined by splitting the non-square-shaped second CU 510 may be split recursively. According to an embodiment, the non-square-shaped third CU 520b, which is one of the odd number of third CUs 520b, 520c, and 520d, may be horizontally split into a plurality of fourth CUs. The non-square-shaped fourth CU 530b or 530d, which is one of the plurality of fourth CUs 530a, 530b, 530c, and 530d, may be further split into a plurality of CUs. For example, the non-square-shaped fourth CU 530b or 530d may be further split into an odd number of CUs. Methods that may be used for recursive splitting of CUs are described below with reference to various embodiments.

According to an embodiment, the image decoding apparatus 100 may split each of the third CUs 520a, 520b, 520c, 520d, etc. into CUs based on the split shape mode information. In addition, the image decoding apparatus 100 may determine not to split the second CU 510 based on the split shape mode information. According to an embodiment, the image decoding apparatus 100 may split the non-square-shaped second CU 510 into the odd number of third CUs 520b, 520c, and 520d. The image decoding apparatus 100 may impose certain restrictions on a certain third CU among the odd number of third CUs 520b, 520c, and 520d. For example, the image decoding apparatus 100 may restrict the CU 520c positioned in the center among the odd number of third CUs 520b, 520c, and 520d not to be split any longer, or may restrict the CU 520c to be split a settable number of times.

Referring to FIG. 5, the image decoding apparatus 100 may restrict the CU 520c positioned in the center among the odd number of third CUs 520b, 520c, and 520d included in the non-square-shaped second CU 510 not to be split any longer, or to be split in a certain split shape (e.g., to be split into only four CUs or to be split in a shape corresponding to the split shape of the second CU 510), or to be split only a certain number of times (e.g., to be split only n times, where n>0). However, the above restriction on the CU 520c positioned in the center are merely simple embodiments and should not be interpreted as being limited to the above-described embodiments, but should be interpreted as including various restrictions that allow the CU 520c positioned in the center to be decoded differently from the other CUs 520b and 520d.

According to an embodiment, the image decoding apparatus 100 may obtain, from a certain location within the current CU, the split shape mode information used to split the current CU.

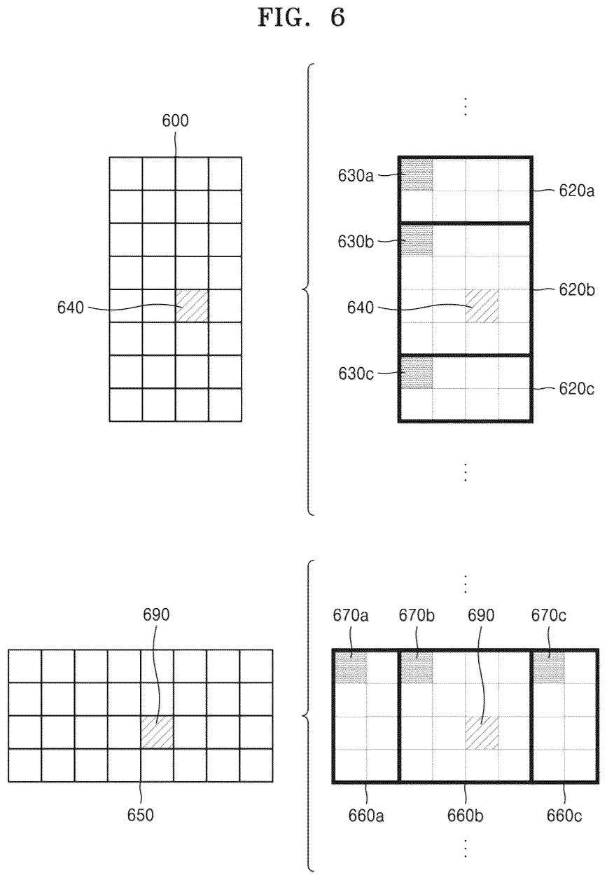

FIG. 6 illustrates a method, performed by the image decoding apparatus 100, of determining a certain CU among an odd number of CUs, according to an embodiment.

Referring to FIG. 6, split shape mode information of a current CU 600 or 650 may be obtained from a sample of a certain location among a plurality of samples included in the current CU 600 or 650 (e.g., a sample 640 or 690 positioned in the center). However, the certain location within the current CU 600 where at least one piece of the split shape mode information may be obtained should not be interpreted as being limited to the center position illustrated in FIG. 6, but should be interpreted as including various locations that may be included within the current CU 600 (e.g., top, bottom, left, right, top left, bottom left, top right, or bottom right, etc.). The image decoding apparatus 100 may obtain the split shape mode information obtained from the certain location and determine to split or not to split the current CU into CUs with various shapes and sizes.

According to an embodiment, when the current CU is split into a certain number of CUs, the image decoding apparatus 100 may select one of the CUs. There may be various methods of selecting one of the plurality of CUs, and such methods are described below with reference to various embodiments provided below.

According to an embodiment, the image decoding apparatus 100 may split a current CU into a plurality of CUs and determine a CU of a certain location.

According to an embodiment, the image decoding apparatus 100 may use information indicating the location of each of an odd number of CUs to determine the CU positioned in the center among the odd number of CUs. Referring to FIG. 6, the image decoding apparatus 100 may determine an odd number of CUs 620a, 620b, and 620c or an odd number of CUs 660a, 660b, and 660c by splitting the current CU 600 or the current CU 650. The image decoding apparatus 100 may determine the central CU 620b or the central CU 660b by using information about the locations of the odd number of CUs 620a, 620b, and 620c or the odd number of CUs 660a, 660b, and 660c. For example, the image decoding apparatus 100 may determine the CU 620b positioned in the center by determining the locations of the CUs 620a, 620b, and 620c based on information indicating the locations of certain samples included in the CUs 620a, 620b, and 620c. Specifically, the image decoding apparatus 100 may determine the CU 620b positioned in the center by determining the locations of the CUs 620a, 620b, and 620c based on information indicating the locations of the top left samples 630a, 630b, and 630c of the CUs 620a, 620b, and 620c.

According to an embodiment, the information indicating the locations of the top left samples 630a, 630b, and 630c respectively included in the CUs 620a, 620b, and 620c may include information about the location or coordinates of the CUs 620a, 620b, and 620c within the picture. According to an embodiment, the information indicating the locations of the top left samples 630a, 630b, and 630c respectively included in the CUs 620a, 620b, and 620c may include information indicating the width or the height of the CUs 620a, 620b, and 620c included in the current CU 600, and the width or the height may correspond to information indicating the difference between coordinates of the CUs 620a, 620b, and 620c within the picture. That is, the image decoding apparatus 100 may determine the CU 620b positioned in the center by directly using the information about the locations or coordinates of the CUs 620a, 620b, and 620c within the picture or by using the information about the width or the height of the CU corresponding to the difference between the coordinates.

According to an embodiment, information indicating the location of the top left sample 630a of the top CU 620a may indicate (xa, ya) coordinates, information indicating the location of the top left sample 630b of the central CU 620b may indicate (xb, yb) coordinates, and information indicating the location of the top left sample 630c of the bottom CU 620c may indicate (xc, yc) coordinates. The image decoding apparatus 100 may determine the central CU 620b by using the coordinates of the top left samples 630a, 630b, and 630c respectively included in the CUs 620a, 620b, and 620c. For example, when the coordinates of the top left samples 630a, 630b, and 630c are sorted in ascending or descending order, the CU 620b including the coordinates (xb, yb) of the sample 630b positioned in the center may be determined as the CU positioned in the center among the CUS 620a, 620b, and 620c determined by splitting the current CU 600. However, the coordinates indicating the locations of the top left samples 630a, 630b, and 630c may indicate coordinates indicating an absolute location within the picture, and furthermore, based on the location of the top left sample 630a of the top CU 620a, the (dxb, dyb) coordinates, which are information indicating the relative location of the top left sample 630b of the central CU 620b, and the (dxc, dyc) coordinates, which are information indicating the relative location of the top left sample 630c of the bottom CU 620c, may be used. In addition, the method of determining the CU of the certain location by using the coordinates of the sample as the information indicating the location of the sample included in the CU should not be interpreted as being limited to the above-described method, but should be interpreted as various arithmetic methods that may use the coordinates of the sample.

According to an embodiment, the image decoding apparatus 100 may split the current CU 600 into the plurality of CUs 620a, 620b, and 620c, and may select a CU among the CUS 620a, 620b, and 620c in accordance with a certain criterion. For example, the image decoding apparatus 100 may select the CU 620b having a different size among the CUs 620a, 620b, and 620c.

According to an embodiment, the image decoding apparatus 100 may determine the width or the height of each of the CUs 620a, 620b, and 620c by using the (xa, ya) coordinate, which is information indicating the location of the top left sample 630a of the top CU 620a, the (xb, yb) coordinate, which is information indicating the location of the top left sample 630b of the central CU 620b, and the (xc, yc) coordinate, which is information indicating the location of the top left sample 630c of the bottom CU 620c. The image decoding apparatus 100 may determine the size of each of the CUs 620a, 620b, and 620c by using (xa, ya), (xb, yb), and (xc, yc) coordinates indicating the locations of the CUs 620a, 620b, and 620c. According to an embodiment, the image decoding apparatus 100 may determine the width of the top CU 620a as the width of the current CU 600. The image decoding apparatus 100 may determine the height of the top CU 620a as yb-ya. According to an embodiment, the image decoding apparatus 100 may determine the width of the central CU 620b as the width of the current CU 600. The image decoding apparatus 100 may determine the height of the central CU 620b as yc-yb. According to an embodiment, the image decoding apparatus 100 may determine the width or the height of the bottom CU by using the width or the height of the current CU and the widths and heights of the top CU 620a and the central CU 620b. The image decoding apparatus 100 may determine a CU having a different size from the sizes of the other CUs based on the determined widths and heights of the CUs 620a, 620b, and 620c. Referring to FIG. 6, the image decoding apparatus 100 may determine the central CU 620b having a size different from the sizes of the top CU 620a and the bottom CU 620c as the CU of the certain location. However, because the above-described process in which the image decoding apparatus 100 determines a CU having a different size from the sizes of the other CUs is merely an embodiment of determining a CU of a certain location by using the size of the CU determined based on sample coordinates, various processes of determining a CU of a certain location by comparing the sizes of the CUs determined according to certain sample coordinates may be used.

The image decoding apparatus 100 may determine the width or the height of each of the CUs 660a, 660b, and 660c by using (xd, yd) coordinates, which are information indicating a location of a top left sample 670a of the left CU 660a, (xe, ye) coordinates, which are information indicating a location of a top left sample 670b of the central CU 660b, and (xf, yf) coordinates, which are information indicating a location of a top left sample 670c of the right CU 660c. The image decoding apparatus 100 may determine the size of each of the CUs 660a, 660b, and 660c by using the (xd, yd), (xe, ye), and (xf, yf) coordinates indicating the locations of the CUs 660a, 660b, and 660c.

According to an embodiment, the image decoding apparatus 100 may determine the width of the left CU 660a as xe-xd. The image decoding apparatus 100 may determine the height of the left CU 660a as the height of the current CU 650. According to an embodiment, the image decoding apparatus 100 may determine the width of the central CU 660b as xf-xe. The image decoding apparatus 100 may determine the height of the central CU 660b as the height of the current CU 660. According to an embodiment, the image decoding apparatus 100 may determine the width or the height of the left CU 660c by using the width or the height of the current CU 650 and the widths and heights of the left CU 660a and the central CU 660b. The image decoding apparatus 100 may determine a CU having a different size from the sizes of the other CUs based on the determined widths and heights of the CUs 660a, 660b, and 660c. Referring to FIG. 6, the image decoding apparatus 100 may determine the central CU 660b having a size different from the sizes of the left CU 660a and the right CU 660c as the CU of the certain location. However, because the above-described process in which the image decoding apparatus 100 determines a CU having a different size from the sizes of the other CUs is merely an embodiment of determining a CU of at a certain location by using the size of the CU determined based on sample coordinates, various processes of determining a CU of a certain location by comparing the sizes of the CUs determined according to certain sample coordinates may be used.

However, the location of the sample considered for determining the location of the CU should not be interpreted as being limited to the top left described above, and it may be interpreted that information about the location of any sample included in the CU may be used.

According to an embodiment, the image decoding apparatus 100 may select a CU of a certain location among the odd number of CUs determined by splitting the current CU, taking into account the shape of the current CU. For example, when the current CU is a non-square shape with a width longer than a height, the image decoding apparatus 100 may determine a CU of a certain location along the horizontal direction. That is, the image decoding apparatus 100 may determine one of the CUS that have different locations in the horizontal direction and may impose restrictions on the corresponding CU. When the current CU is a non-square shape with a height longer than a width, the image decoding apparatus 100 may determine a CU of a certain location along the vertical direction. That is, the image decoding apparatus 100 may determine one of the CUs that have different locations in the vertical direction and may impose restrictions on the corresponding CU.

According to an embodiment, the image decoding apparatus 100 may use information indicating the location of each of an even number of CUs to determine a CU of a certain location among the even number of CUs. The image decoding apparatus 100 may determine the even number of CUs by splitting (binary splitting) the current CU and may determine a CU of a certain location by using information about the locations of the even number of CUs. In this regard, a specific process may be a process corresponding to the process of determining the CU of the certain location (e.g., the central location) among the odd number of CUs described above with reference to FIG. 6, and thus, the specific process is omitted.

According to an embodiment, when a non-square-shaped current CU is split into a plurality of CUs, certain information about a CU of a certain location may be used in a splitting process so as to determine the CU of the certain location among the plurality of CUs. For example, the image decoding apparatus 100 may use at least one of block shape information and split shape mode information stored in the sample included in the central CU in the splitting process so as to determine the CU positioned in the center among the plurality of CUs into which the current CU is split.

Referring to FIG. 6, the image decoding apparatus 100 may split the current CU 600 into the plurality of CUs 620a, 620b, and 620c based on the split shape mode information, and may determine the CU 620b positioned in the center among the plurality of CUs 620a, 620b, and 620c. Furthermore, the image decoding apparatus 100 may determine the CU 620b positioned in the center by taking into account the location where the split shape mode information is obtained. That is, the split shape mode information of the current CU 600 may be obtained from the sample 640 positioned in the center of the current CU 600. When the current CU 600 is split into the plurality of CUs 620a, 620b, and 620c based on the split shape mode information, the CU 620b including the sample 640 may be determined as the CU positioned in the center. However, the information used to determine the CU positioned in the center should not be interpreted as being limited to the split type mode information, and various types of information may be used in the process of determining the CU positioned in the center.

According to an embodiment, certain information for identifying a CU of a certain location may be obtained from a certain sample included in a CU to be determined. Referring to FIG. 6, the image decoding apparatus 100 may use the split shape mode information obtained from the sample of the certain location within the current CU 600 (e.g., the sample positioned in the center of the current CU 600) so as to determine the CU of the certain location among the plurality of CUs 620a, 620b, and 620c into which the current CU 600 is split (e.g., the CU positioned in the center among the plurality of split CUs). That is, the image decoding apparatus 100 may determine the sample of the certain location by taking into account the block shape of the current CU 600, and the image decoding apparatus 100 may impose certain restrictions by determining the CU 620b including the sample from which certain information (e.g., the split shape mode information) may be obtained, among the plurality of CUs 620a, 620b, and 620c determined by splitting the current CU 600. Referring to FIG. 6, according to an embodiment, the image decoding apparatus 100 may determine the sample 640 positioned in the center of the current CU 600 as the sample from which certain information may be obtained, and the image decoding apparatus 100 may impose certain restrictions on the process of decoding the CU 620b including the sample 640. However, the location of the sample from which certain information may be obtained should not be interpreted as being limited to the above-described location, but may be interpreted as samples of any location included in the CU 620b to be determined so as to impose restrictions thereon.

According to an embodiment, the location of the sample from which certain information may be obtained may be determined according to the shape of the current CU 600. According to an embodiment, the block shape information may determine whether the shape of the current CU is a square or a non-square, and may determine the location of the sample from which certain information may be obtained according to the shape. For example, the image decoding apparatus 100 may determine a sample positioned on a boundary that divides at least one of the width and the height of the current CU into halves as the sample from which certain information may be obtained, by using at least one of information about the width of the current CU and information about the height of the current CU. As another example, when the block shape information related to the current CU indicates a non-square shape, the image decoding apparatus 100 may determine one of samples adjacent to a boundary that divides the long side of the current CU into halves as the sample from which certain information may be obtained.

According to an embodiment, when the image decoding apparatus 100 splits the current CU into the plurality of CUs, the image decoding apparatus 100 may use the split shape mode information so as to determine the CU of the certain location among the plurality of CUs. According to an embodiment, the image decoding apparatus 100 may obtain the split shape mode information from the sample of the certain location included in the CU, and the image decoding apparatus 100 may split the plurality of CUs, which are generated by splitting the current CU, by using the split shape mode information obtained from the sample of the certain location included in each of the plurality of CUs. That is, the CU may be recursively split by using the split shape mode information obtained from the sample of the certain location included in each of the CUs. Because the process of recursively splitting the CU has been described above with reference to FIG. 5, a detailed description thereof is omitted.

According to an embodiment, the image decoding apparatus 100 may determine at least one CU by splitting the current CU, and may determine the order in which the at least one CU is decoded according to a certain block (e.g., the current CU).

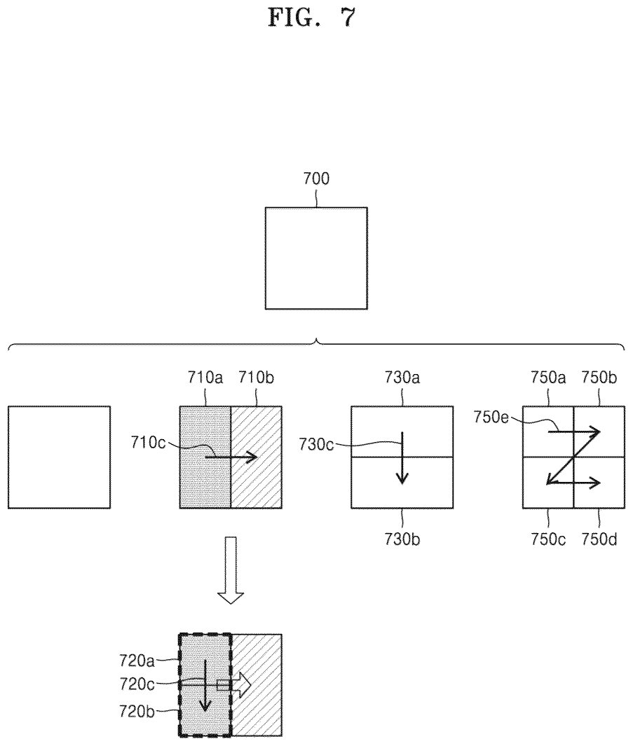

FIG. 7 illustrates the order in which a plurality of CUs are processed when the image decoding apparatus 100 determines the plurality of CUs by splitting a current CU, according to an embodiment.

According to an embodiment, the image decoding apparatus 100 may determine second CUs 710a and 710b by splitting a first CU 700 in the vertical direction, determine second CUs 730a and 730b by splitting the first CU 700 in the horizontal direction, or determine second CUs 750a, 750b, 750c, and 750d by splitting the first CA 700 in the vertical direction and the horizontal direction, according to split shape mode information.

Referring to FIG. 7, the image decoding apparatus 100 may determine the order such that the second CUs 710a and 710b determined by splitting the first CU 700 in the vertical direction are processed in the horizontal direction 710c. The image decoding apparatus 100 may determine, as the vertical direction 730c, the processing order of the second CUs 730a and 730b determined by splitting the first CU 700 in the horizontal direction. The image decoding apparatus 100 may determine the second CUs 750a, 750b, 750c, and 750d determined by splitting the first CU 700 in the vertical direction and the horizontal direction according to a certain order (e.g., a raster scan order 750e or a z scan order) in which CUs positioned in one row are processed and then CUs positioned in a next row are processed.

According to an embodiment, the image decoding apparatus 100 may recursively split the CUS. Referring to FIG. 7, the image decoding apparatus 100 may determine the plurality of CUs 710a, 710b, 730a, 730b, 750a, 750b, 750c, and 750d by splitting the first CU 700, and may recursively split each of the plurality of determined CUs 710a, 710b, 730a, 730b, 750a, 750b, 750c, and 750d. The method of dividing the plurality of CUs 710a, 710b, 730a, 730b, 750a, 750b, 750c, and 750d may be a method corresponding to the method of splitting the first CU 700. Accordingly, each of the plurality of CUs 710a, 710b, 730a, 730b, 750a, 750b, 750c, and 750d may be independently split into a plurality of CUs. Referring to FIG. 7, the image decoding apparatus 100 may determine the second CUs 710a and 710b by splitting the first CU 700 in the vertical direction, and furthermore, may determine to independently split or not to split each of the second CUs 710a and 710b.

According to an embodiment, the image decoding apparatus 100 may split the left second CU 710a in the horizontal direction into third CUs 720a and 720b, and may not split the right second CU 710b.

According to an embodiment, the processing order of the CUs may be determined based on the process of splitting the CUs. In other words, the processing order of the split CUs may be determined based on the processing order of the CUS immediately before being split. The image decoding apparatus 100 may determine the order in which the third CUs 720a and 720b determined by splitting the left second CU 710a are processed, independently of the right second CU 710b. Because the third CUs 720a and 720b are determined by splitting the left second CU 710a in the horizontal direction, the third CUs 720a and 720b may be processed in the vertical direction 720c. In addition, because the order in which the left second CU 710a and the right second CU 710b are processed corresponds to the horizontal direction 710c, the right CU 710b may be processed after the third CUs 720a and 720b included in the left second CU 710a is processed in the vertical direction 720c. The above-described contents are intended to explain the process in which the processing order of the CUs is determined according to the CU before splitting, and therefore, should not be interpreted as being limited to the above-described embodiment, but should be interpreted as being used in various methods by which CUs that are split and determined in various shapes may be independently processed according to a certain order.

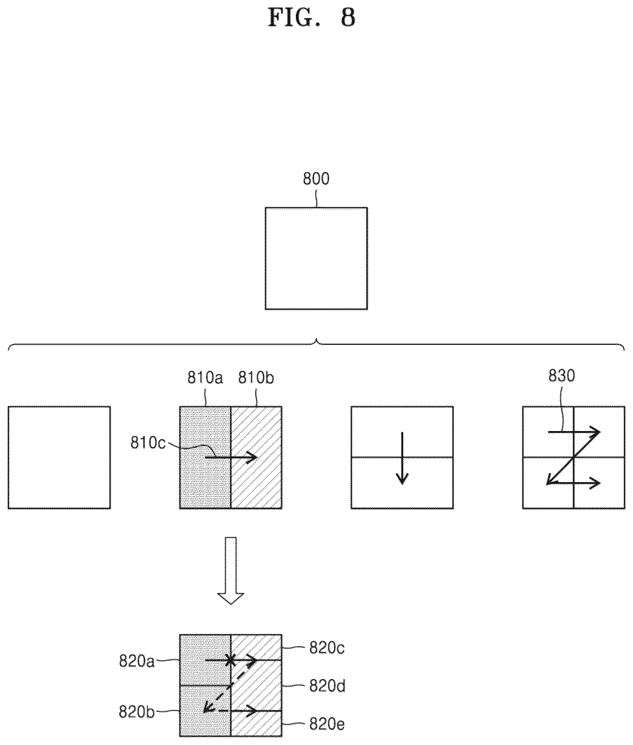

FIG. 8 illustrates a process in which, when it is impossible to process CUs in a certain order, the image decoding apparatus 100 determines that a current CU is split into an odd number of CUs, according to an embodiment.

According to an embodiment, the image decoding apparatus 100 may determine that the current CU is split into the odd number of CUs based on the obtained split shape mode information. Referring to FIG. 8, a square-shaped first CU 800 may be split into non-square-shaped second CUs 810a and 810b, and the second CUs 810a and 810b may be independently split into third CUs 820a, 820b, 820c, 820d, and 820e. According to an embodiment, the image decoding apparatus 100 may determine the plurality of third CUs 820a and 820b by splitting the left CU 810a in the horizontal direction among the second CUs, and the right CU 810b may be split into the odd number of third CUs 820c, 820d, and 820e.

According to an embodiment, the image decoding apparatus 100 may determine the presence or absence of the odd number of split CUs by determining whether the third CUs 820a, 820b, 820c, 820d, and 820e may be processed in a certain order. Referring to FIG. 8, the image decoding apparatus 100 may determine the third CUs 820a, 820b, 820c, 820d, and 820e by recursively splitting the first CU 800. The image decoding apparatus 100 may determine whether the first CU 800, the second CUs 810a and 810b, or the third CUs 820a, 820b, 820c, 820d, and 820e are split into the odd number of CUs among the split shapes, based on at least one of the block shape information and the split shape mode information. For example, the CU positioned on the right side among the second CUs 810a and 810b may be split into the odd number of third CUs 820c, 820d, and 820e. The order in which the plurality of CUs included in the first CU 800 are processed may be a certain order (e.g., a z-scan order 830), and the image decoding apparatus 100 may determine whether the third CUs 820c, 820d, and 820e determined by splitting the right second CU 810b into the odd number of CUs satisfy a condition that the third CUs 820c, 820d, and 820e may be processed according to the certain order.

According to an embodiment, the image decoding apparatus 100 may determine whether the third CUs 820a, 820b, 820c, 820d, and 820e included in the first CU 800 satisfy a condition that the third CUs 820a, 820b, 820c, 820d, and 820e may be processed in the certain order, and the condition is related to whether at least one of the widths and the heights of the second CUs 810a and 810b is divided into halves according to the boundaries of the third CUs 820a, 820b, 820c, 820d, and 820e. For example, the third CUs 820a and 820b determined by dividing the height of the left non-square-shaped second CU 810a into halves may satisfy the condition. Because the boundaries of the third CUs 820c, 820d, and 820e determined by splitting the right second CU 810b into three CUs do not divide the width or the height of the right second CU 810b into halves, it may be determined that the third CUs 820c, 820d, and 820e do not satisfy the condition. When the condition is not satisfied, the image decoding apparatus 100 may determine that there is a disconnection in a scan order, and based on the determination result, may determine that the right second CU 810b is split into the odd number of CUs. According to an embodiment, when the CU is split into the odd number of CUs, the image decoding apparatus 100 may impose certain restrictions on a CU of a certain location among the split CUs. Because the contents of such restrictions, the certain location, etc. have been described above with reference to various embodiments, a detailed description thereof is omitted.

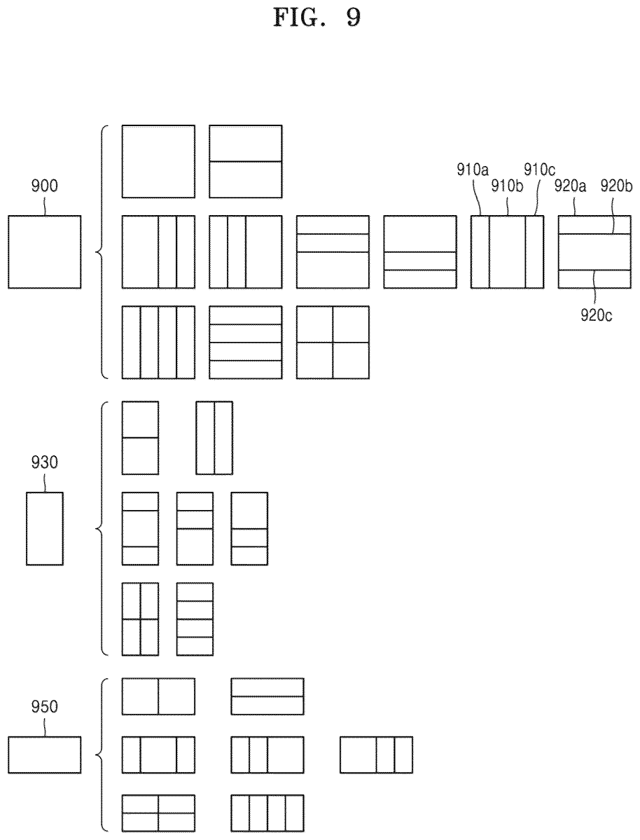

FIG. 9 illustrates a process in which the image decoding apparatus 100 determines at least one CU by splitting a first CU 900, according to an embodiment.

According to an embodiment, the image decoding apparatus 100 may split the first CU 900 based on split shape mode information obtained through the bitstream obtainer 110. The square-shaped first CU 900 may be split into four square-shaped CUs, or may be split into a plurality of non-square-shaped CUs. For example, referring to FIG. 9, when the first CU 900 is square and the split shape mode information indicates “split into non-square-shaped CUs,” the image decoding apparatus 100 may split the first CU 900 into the plurality of non-square-shaped CUs. Specifically, when the split shape mode information indicates that the first CU 900 is split in the horizontal direction or the vertical direction to determine the odd number of CUs, the image decoding apparatus 100 may split the square-shaped first CU 900 into second CUs 910a, 910b, and 910c determined by splitting the first CU 900 in the vertical direction into the odd number of CUs or second CUs 920a, 920b, and 920c determined by splitting the first CU 900 in the horizontal direction into the odd number of CUs.

According to an embodiment, the image decoding apparatus 100 may determine whether the second CUs 910a, 910b, 910c, 920a, 920b, and 920c included in the first CU 900 satisfy a condition that the second CUs 910a, 910b, 910c, 920a, 920b, and 920c may be processed in a certain order, and the condition is related to whether at least one of the width and the height of the first CU 900 is divided into halves according to the boundaries of the second CUs 910a, 910b, 910c, 920a, 920b, and 920c. Referring to FIG. 9, because the boundaries of the second CUs 910a, 910b, and 910c determined by splitting the square-shaped first CU 900 in the vertical direction do not divide the width of the first CU 900 into halves, it may be determined that the first CU 900 does not satisfy a condition that the first CU 900 may be processed in a certain order. In addition, because the boundaries of the second CUs 920a, 920b, and 920c determined by splitting the square-shaped first CU 900 in the horizontal direction do not divide the height of the first CU 900 into halves, it may be determined that the first CU 900 does not satisfy a condition that the first CU 900 may be processed in a certain order. When the condition is not satisfied, the image decoding apparatus 100 may determine that there is a disconnection in a scan order, and based on the determination result, may determine that the first CU 900 is split into the odd number of CUs. According to an embodiment, when the CU is split into the odd number of CUs, the image decoding apparatus 100 may impose certain restrictions on a CU of a certain location among the split CUs. Because the contents of such restrictions, the certain location, etc. have been described above with reference to various embodiments, a detailed description thereof is omitted.

According to an embodiment, the image decoding apparatus 100 may determine CUs with various shapes by splitting the first CU.

Referring to FIG. 9, the image decoding apparatus 100 may split the square-shaped first CU 900 and the non-square-shaped first CU 930 or 950 into CUs with various shapes.

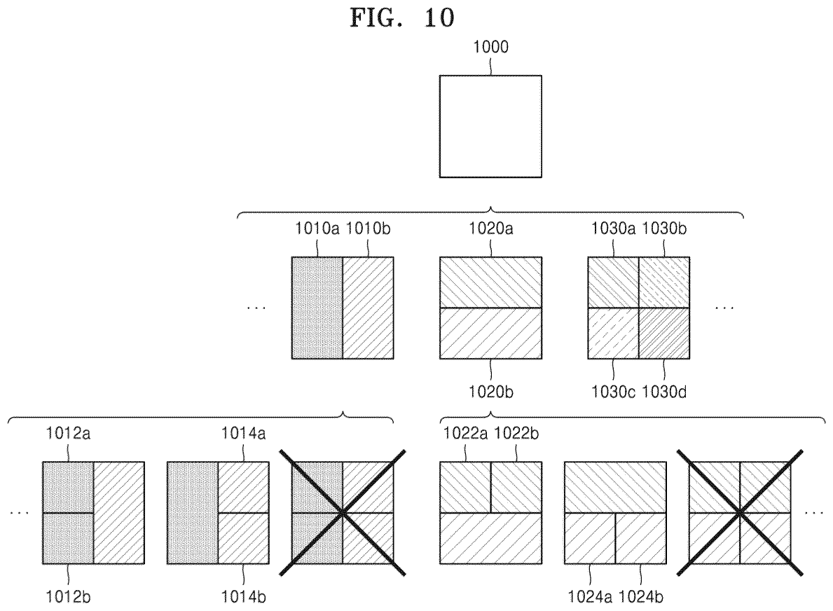

FIG. 10 illustrates that, when a non-square-shaped second CU determined by splitting a first CU 1000 satisfies a certain condition, the image decoding apparatus 100 restricts a shape into which a second CU may be split, according to an embodiment.

According to an embodiment, the image decoding apparatus 100 may determine to split the square-shaped first CU 1000 into non-square-shaped second CUs 1010a, 1010b, 1020a, and 1020b based on split shape mode information obtained through the bitstream obtainer 110. The second CUs 1010a, 1010b, 1020a, and 1020b may be independently split. Accordingly, the image decoding apparatus 100 may determine to split or not to split into a plurality of CUs based on split shape mode information related to each of the second CUs 1010a, 1010b, 1020a, and 1020b. According to an embodiment, the image decoding apparatus 100 may determine third CUs 1012a and 1012b by splitting, in the horizontal direction, the non-square-shaped left second CU 1010a determined by splitting the first CU 1000 in the vertical direction. However, when the image decoding apparatus 100 splits the left second CU 1010a in the horizontal direction, the right second CU 1010b may be restricted from being split in the horizontal direction in the same manner as the direction in which the left second CU 1010a is split. When the right second CU 1010b is split in the same direction to determine the third CUs 1014a and 1014b, the left second CU 1010a and the right second CU 1010b may be independently split in the horizontal direction to determine the third CUs 1012a, 1012b, 1014a, and 1014b. However, this is the same result as the image decoding apparatus 100 splitting the first CU 1000 into four square-shaped second CUs 1030a, 1030b, 1030c, and 1030d based on the split shape mode information, which may be inefficient in terms of image decoding.

According to an embodiment, the image decoding apparatus 100 may determine third CUs 1022a, 1022b, 1024a, and 1024b by splitting, in the vertical direction, the non-square-shaped second CU 1020a or 1020b determined by splitting the first CU 1000 in the horizontal direction. However, when the image decoding apparatus 100 splits one of the second CUs (e.g., the top second CU 1020a) in the vertical direction, the other second CU (e.g., the bottom CU 1020b) may be restricted from being split in the vertical direction in the same manner as the direction in which the top second CU 1020a is split, for the reasons described above.

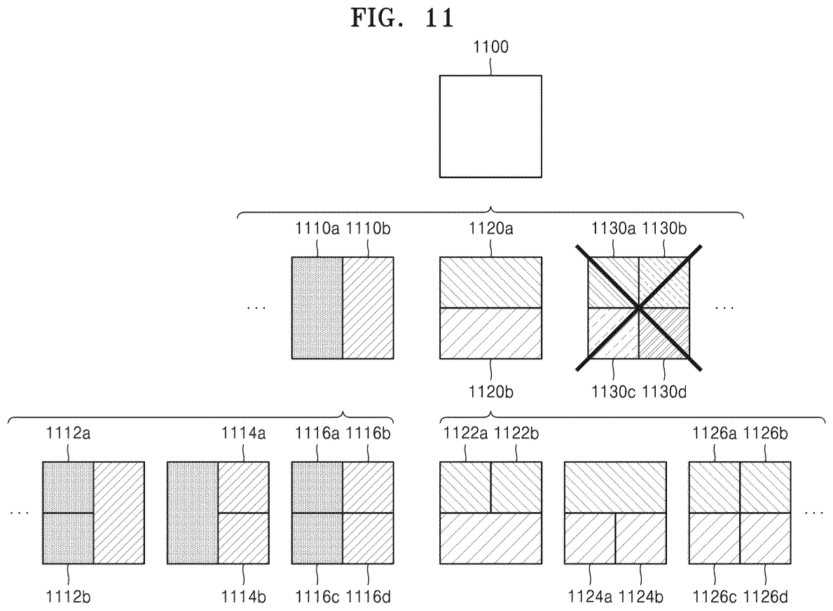

FIG. 11 illustrates a process in which the image decoding apparatus 100 splits a square-shaped CU when split shape mode information is unable to indicate “split into four square-shaped CUs,” according to an embodiment.

According to an embodiment, the image decoding apparatus 100 may determine second CUs 1110a, 1110b, 1120a, 1120b, etc. by splitting a first CU 1100 based on split shape mode information. The split shape mode information may include information about various shapes into which the CU may be split, but the information about the various shapes may not always include information for splitting the CU into four square-shaped CUs. According to the split shape mode information, the image decoding apparatus 100 is unable to split the square-shaped first CU 1100 into four square-shaped second CUs 1130a, 1130b, 1130c, and 1130d. Based on the split shape mode information, the image decoding apparatus 100 may determine the non-square-shaped second CUs 1110a, 1110b, 1120a, 1120b, etc.

According to an embodiment, the image decoding apparatus 100 may independently split each of the non-square-shaped second CUs 1110a, 1110b, 1120a, 1120b, etc. Each of the second CUs 1110a, 1110b, 1120a, 1120b, etc. may be split in a certain order through a recursive method, which may be a splitting method corresponding to a method by which the first CU 1100 is split based on the splitting shape mode information.

For example, the image decoding apparatus 100 may determine square-shaped third CUs 1112a and 1112b by splitting the left second CU 1110a in the horizontal direction, and may determine square-shaped third CUs 1114a and 1114b by splitting the right second CU 1110b in the horizontal direction. Furthermore, the image decoding apparatus 100 may determine square-shaped third CUs 1116a, 1116b, 1116c, and 1116d by splitting both the left second CU 1110a and the right second CU 1110b in the horizontal direction. In this case, the CU may be determined in the same shape as the shape in which the first CU 1100 is split into four square-shaped second CUs 1130a, 1130b, 1130c, and 1130d.

As another example, the image decoding apparatus 100 may determine square-shaped third CUs 1122a and 1122b by splitting the top second CU 1120a in the vertical direction, and may determine square-shaped third CUs 1124a and 1124b by splitting the bottom second CU 1120b in the vertical direction. Furthermore, the image decoding apparatus 100 may determine square-shaped third CUs 1126a, 1126b, 1126c, and 1126d by splitting both the top second CU 1120a and the bottom second CU 1120b in the vertical direction. In this case, the CU may be determined in the same shape as the shape in which the first CU 1100 is split into four square-shaped second CUs 1130a, 1130b, 1130c, and 1130d.

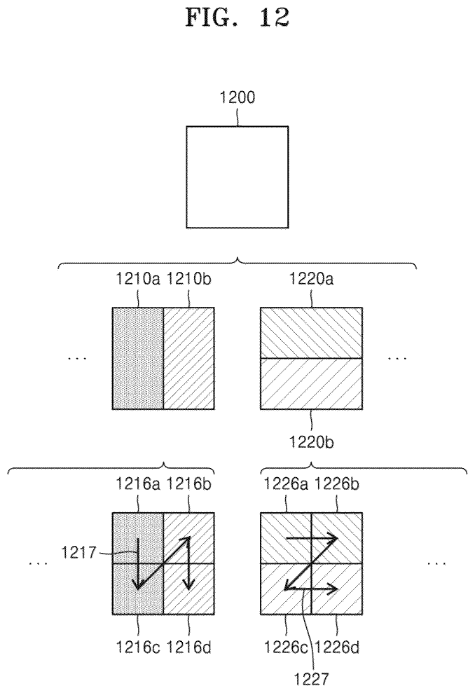

FIG. 12 illustrates that a processing order between a plurality of CUs may vary depending on a process of splitting a CU, according to an embodiment.

According to an embodiment, the image decoding apparatus 100 may split a first CU 1200 based on split shape mode information. When the block shape is a square and the split shape mode information indicates that the first CU 1200 is split in at least one of the horizontal direction and the vertical direction, the image decoding apparatus 100 may determine second CUs (e.g., 1210a, 1210b, 1220a, 1220b, etc.) by splitting the first CU 1200. Referring to FIG. 12, non-square-shaped second CUs 1210a, 1210b, 1220a, and 1220b determined by splitting the first CU 1200 only in the horizontal direction or the vertical direction may be independently split based on the split shape mode information for each thereof. For example, the image decoding apparatus 100 may determine third CUs 1216a, 1216b, 1216c, and 1216d by splitting the second CUs 1210a and 1210b in the horizontal direction, which are generated by splitting the first CU 1200 in the vertical direction, and may determine third CUs 1226a, 1226b, 1226c, and 1226d by splitting the second CUs 1220a and 1220b in the vertical direction, which are generated by splitting the first CU 1200 in the horizontal direction. Because the process of splitting the second CUs 1210a, 1210b, 1220a, and 1220b has been described above with reference to FIG. 11, a detailed description thereof is omitted.

According to an embodiment, the image decoding apparatus 100 may process the CUs in a certain order. Because characteristics of the processing of the CUs according to the certain order have been described above with reference to FIG. 7, a detailed description thereof is omitted. Referring to FIG. 12, the image decoding apparatus 100 may split the square-shaped first CU 1200 to determine four square-shaped third CUs 1216a, 1216b, 1216c, 1216d, 1226a, 1226b, 1226c, and 1226d. According to an embodiment, the image decoding apparatus 100 may determine the processing order of the third CUs 1216a, 1216b, 1216c, 1216d, 1226a, 1226b, 1226c, and 1226d according to the shape into which the first CU 1200 is split.

According to an embodiment, the image decoding apparatus 100 may determine the third CUs 1216a, 1216b, 1216c, and 1216d by splitting the second CUs 1210a and 1210b in the horizontal direction, which are generated by splitting in the vertical direction, and the image decoding apparatus 100 may process the third CUs 1216a, 1216b, 1216c, and 1216d according to an order 1217 of processing the third CUs 1216a and 1216c included in the left second CU 1210a in the vertical direction and then processing the third CUs 1216b and 1216d included in the right second CU 1210b in the vertical direction.

According to an embodiment, the image decoding apparatus 100 may determine the third CUs 1226a, 1226b, 1226c, and 1226d by splitting the second CUs 1220a and 1220b in the vertical direction, which are generated by splitting in the horizontal direction, and the image decoding apparatus 100 may process the third CUs 1226a, 1226b, 1226c, and 1226d according to an order 1227 of processing the third CUs 1226a and 1226c included in the top second CU 1220a in the horizontal direction and then processing the third CUs 1226b and 1226d included in the bottom second CU 1220b in the horizontal direction.

Referring to FIG. 12, the second CUs 1210a, 1210b, 1220a, and 1220b may be respectively split into the square-shaped third CUs 1216a, 1216b, 1216c, 1216d, 1226a, 1226b, 1226c, and 1226d. The second CUs 1210a and 1210b determined by splitting in the vertical direction and the second CUs 1220a and 1220b determined by splitting in the horizontal direction are split into different shapes, but according to the third CUs 1216a, 1216b, 1216c, 1216d, 1226a, 1226b, 1226c, and 1226d determined later, the first CU 1200 is ultimately split into CUs with the same shape. Accordingly, the image decoding apparatus 100 may process the plurality of CUs determined to have the same shape in different orders, even when CUs with the same shape are determined by recursively splitting the CU through different processes based on the split shape mode information.

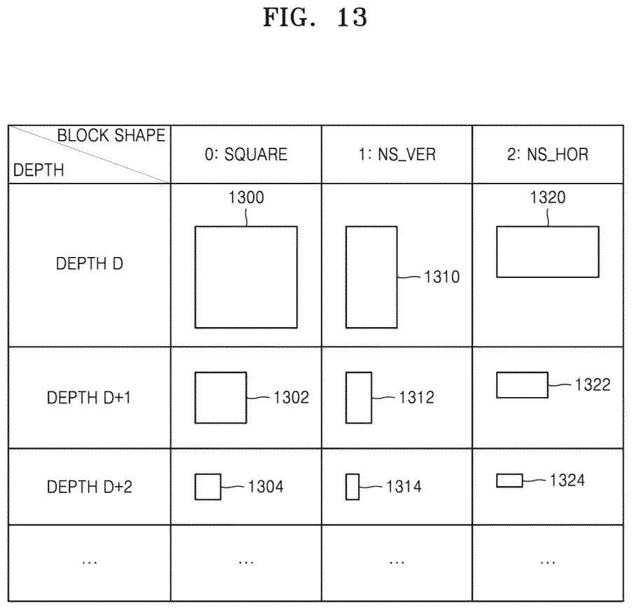

FIG. 13 illustrates a process in which, when a CU is recursively split to determine a plurality of CUs, the depth of the CU is determined as the shape and size of the CU change, according to an embodiment.

According to an embodiment, the image decoding apparatus 100 may determine the depth of the CU in accordance with a certain criterion. For example, the certain criterion may be the length of the long side of the CU. The image decoding apparatus 100 may determine that, when the length of the long side of the current CU is split into 2n (n>0) times the length of the long side of the CU before being split, the depth of the current CU is increased by n, compared to the depth of the CU before being split. Hereinafter, the CU, the depth of which is increased, is expressed as a CU of a lower depth.

Referring to FIG. 13, according to an embodiment, the image decoding apparatus 100 may determine a second CU 1302, a third CU 1304, etc. of a lower depth by splitting a square-shaped first CU 1300, based on block shape information indicating a square shape (for example, the block shape information may indicate ‘0: SQUARE’). When the size of the square-shaped first CU 1300 is 2N×2N, the second CU 1302 determined by splitting the width and the height of the first CU 1300 by ½ may have a size of N×N. Furthermore, the third CU 1304 determined by splitting the width and the height of the second CU 1302 into ½ sizes may have a size of N/2×N/2. In this case, the width and the height of the third CU 1304 correspond to ¼ times the width and the height of the first CU 1300. When the depth of the first CU 1300 is D, the depth of the second CU 1302 which is ½ times the width and the height of the first CU 1300 may be D+1, and the depth of the third CU 1304 which is ¼ times the width and the height of the first CU 1300 may be D+2.

According to an embodiment, based on block shape information indicating a non-square shape (for example, the block shape information may indicate ‘1: NS_VER’ indicating a non-square shape with a height longer than a width or ‘2: NS_HOR’ indicating a non-square shape with a width longer than a height), the image decoding apparatus 100 may determine the second CU 1312 or 1322, the third CU 1314 or 1324, etc. of a lower depth by splitting the non-square-shaped first CU 1310 or 1320.

The image decoding apparatus 100 may determine the second CU (e.g., 1302, 1312, 1322, etc.) by splitting at least one of the width and the height of the first CU 1310 with a size of N×2N. That is, the image decoding apparatus 100 may determine the second CU 1302 with a size of N×N or the second CU 1322 with a size of N×N/2 by splitting the first CU 1310 in the horizontal direction, and may also determine the second CU 1312 with a size of N/2×N by splitting in the horizontal direction and the vertical direction.

According to an embodiment, the image decoding apparatus 100 may determine the second CU (e.g., 1302, 1312, 1322, etc.) by splitting at least one of the width and the height of the first CU 1320 with a size of 2N×N. That is, the image decoding apparatus 100 may determine the second CU 1302 with a size of N×N or the second CU 1312 with a size of N/2×N by splitting the first CU 1320 in the vertical direction, and may also determine the second CU 1322 with a size of N×N/2 by splitting in the horizontal direction and the vertical direction.

According to an embodiment, the image decoding apparatus 100 may determine the third CU (e.g., 1304, 1314, 1324, etc.) by splitting at least one of the width and the height of the second CU 1302 with a size of N×N. That is, the image decoding apparatus 100 may split the second CU 1302 in the vertical direction and the horizontal direction to determine the third CU 1304 with a size of N/2×N/2, the third CU 1314 with a size of N/4×N/2, or the third CU 1324 with a size of N/2×N/4.

According to an embodiment, the image decoding apparatus 100 may determine the third CU (e.g., 1304, 1314, 1324, etc.) by splitting at least one of the width and the height of the second CU 1312 with a size of N/2×N. That is, the image decoding apparatus 100 may determine the third CU 1304 with a size of N/2×N/2 or the third CU 1324 with a size of N/2×N/4 by splitting the second CU 1312 in the horizontal direction, and may also determine the third CU 1314 with a size of N/4×N/2 by splitting the second CU 1312 in the vertical direction and the horizontal direction.

According to an embodiment, the image decoding apparatus 100 may determine the third CU (e.g., 1304, 1314, 1324, etc.) by splitting at least one of the width and the height of the second CU 1322 with a size of N×N/2. That is, the image decoding apparatus 100 may determine the third CU 1304 with a size of N/2×N/2 or the third CU 1314 with a size of N/4×N/2 by splitting the second CU 1322 in the vertical direction, and may also determine the third CU 1324 with a size of N/2×N/4 by splitting the second CU 1322 in the vertical direction and the horizontal direction.

According to an embodiment, the image decoding apparatus 100 may split the square-shaped CU (e.g., 1300, 1302, 1304) in the horizontal direction or the vertical direction. For example, the first CU 1310 with a size of N×2N may be determined by splitting the first CU 1300 with a size of 2N×2N in the vertical direction, or the first CU 1320 with a size of 2N×N may be determined by splitting the first CU 1300 in the horizontal direction. According to an embodiment, when the depth is determined based on the length of the longest side of the CU, the depth of the CU determined by splitting the first CU 1300 with a size of 2N×2N in the horizontal direction or the vertical direction may be equal to the depth of the first CU 1300.

In an embodiment, the width and the height of the third CU 1314 or 1324 may be ¼ times the first CU 1310 or 1320. When the depth of the first CU 1310 or 1320 is D, the depth of the second CU 1312 or 1322, which is ½ times the width and the height of the first CU 1310 or 1320, may be D+1, and the depth of the third CU 1314 or 1324, which is ¼ times the width and the height of the first CU 1310 or 1320 may be D+2.

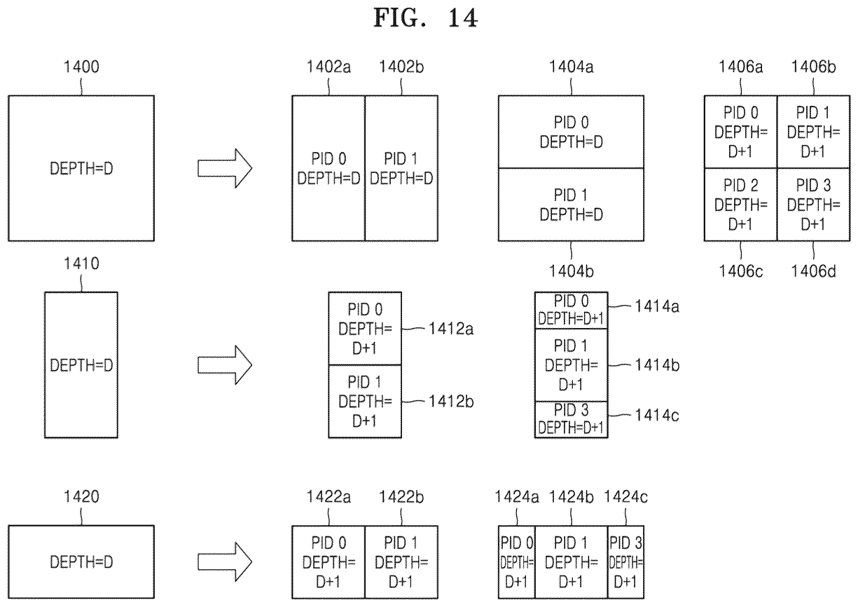

FIG. 14 illustrates an index (a part index, hereinafter PID) for depth and CU distinction, which may be determined according to the shape and size of CUs, according to an embodiment.

According to an embodiment, the image decoding apparatus 100 may determine second CUs with various shapes by splitting a square-shaped first CU 1400. Referring to FIG. 14, the image decoding apparatus 100 may determine second CUs 1402a, 1402b, 1404a, 1404b, 1406a, 1406b, 1406c, and 1406d by splitting the first CU 1400 in at least one of the vertical direction and the horizontal direction according to split shape mode information. That is, the image decoding apparatus 100 may determine the second CUs 1402a, 1402b, 1404a, 1404b, 1406a, 1406b, 1406c, and 1406d based on split shape mode information for the first CU 1400.

According to an embodiment, the depths of the second CUs 1402a, 1402b, 1404a, 1404b, 1406a, 1406b, 1406c, and 1406d determined based on the split shape mode information for the square-shaped first CU 1400 may be determined based on the length of the long side. For example, because the length of one side of the square-shaped first CU 1400 is equal to the length of the long side of the non-square-shaped second CUs 1402a, 1402b, 1404a, and 1404b, the depths of the first CU 1400 and the non-square-shaped second CUs 1402a, 1402b, 1404a, and 1404b may be considered to be equal to D. In contrast, when the image decoding apparatus 100 splits the first CU 1400 into four square-shaped second CUs 1406a, 1406b, 1406c, and 1406d based on the split shape mode information, the length of one side of the square-shaped second CUs 1406a, 1406b, 1406c, and 1406d is ½ times the length of one side of the first CU 1400. Thus, the depths of the second CUs 1406a, 1406b, 1406c, and 1406d may be D+1, which is one depth lower than the depth D of the first CU 1400.

According to an embodiment, the image decoding apparatus 100 may split the first CU 1410, which has a height longer than a width, into a plurality of second CUs 1412a, 1412b, 1414a, 1414b, and 1414c in the horizontal direction according to the split shape mode information. According to an embodiment, the image decoding apparatus 100 may split the first CU 1420, which has a width longer than a height, into a plurality of second CUs 1422a, 1422b, 1424a, 1424b, and 1424c in the vertical direction according to the split shape mode information.

According to an embodiment, the depths of the second CUs 1412a, 1412b, 1414a, 1414b, 1422a, 1422b, 1424c, and 1424d determined based on the split shape mode information for the non-square-shaped first CU 1410 or 1420 may be determined based on the length of the long side. For example, because the length of one side of the square-shaped second CUs 1412a and 1412b is ½ times the length of one side of the non-square-shaped first CU 1410 having a height longer than a width, the depths of the second CUs 1412a and 1412b are D+1, which is one depth lower than the depth D of the non-square-shaped first CU 1410.

Furthermore, the image decoding apparatus 100 may split the non-square-shaped first CU 1410 into an odd number of second CUs 1414a, 1414b, and 1414c based on the split shape mode information. The odd number of second CUs 1414a, 1414b, and 1414c may include non-square-shaped second CUs 1414a and 1414c and a square-shaped second CU 1414b. In this case, because the length of the long side of the non-square-shaped second CUs 1414a and 1414c and the length of one side of the square-shaped second CU 1414b are ½ times the length of one side of the first CU 1410, the depths of the second CUs 1414a, 1414b, and 1414c may be D+1, which is one depth lower than the depth D of the first CU 1410. The image decoding apparatus 100 may determine the depths of the CUs associated with the non-square-shaped first CU 1420 having a width greater than a height by using a method corresponding to the method of determining the depths of the CUs associated with the first CU 1410.

According to an embodiment, when determining an index PID for distinguishing the split CUs, the image decoding apparatus 100 may determine the index based on a size ratio between the CUs when the odd number of split CUs do not have the same size. Referring to FIG. 14, the CU 1414b positioned in the center among the odd number of split CUs 1414a, 1414b, and 1414c may have twice the height of the CUs 1414a and 1414c that have the same width as the other CUs 1414a and 1414c but have different heights from the other CUs 1414a and 1414c. That is, in this case, the CU 1414b positioned in the center may include two different CUs 1414a and 1414c. Accordingly, when the index PID of the CU 1414b positioned in the center according to a scan order is 1, the index of the CU 1414c positioned in a next order may be 3, which is increased by 2. That is, there may be discontinuity in the value of the index. According to an embodiment, the image decoding apparatus 100 may determine whether the odd number of split CUs do not have the same size, based on the presence or absence of discontinuity in the index for distinguishing between the split CUs.

According to an embodiment, the image decoding apparatus 100 may determine whether the CU is split into a specific split shape, based on the value of the index for distinguishing the plurality of CUs determined by splitting from the current CU. Referring to FIG. 14, the image decoding apparatus 100 may determine an even number of CUs 1412a and 1412b or an odd number of CUs 1414a, 1414b, and 1414c by splitting the rectangular first CU 1410 with a height longer than a width. The image decoding apparatus 100 may use the index PID representing each CU so as to distinguish the plurality of CUs. In an embodiment, the PID may be obtained from a sample of a certain location of each CU (e.g., a top left sample).

According to an embodiment, the image decoding apparatus 100 may determine a CU of a certain location among the split and determined CUs by using the index for distinguishing the CUs. According to an embodiment, when the split shape mode information for the rectangular first CU 1410 with a height longer than a width indicates “split into three CUs,” the image decoding apparatus 100 may split the first CU 1410 into three CUs 1414a, 1414b, and 1414c. The image decoding apparatus 100 may assign an index to each of the three CUs 1414a, 1414b, and 1414c. The image decoding apparatus 100 may compare the indices for the respective CUs so as to determine the central CU among the CUs split into an odd number. The image decoding apparatus 100 may determine the CU 1414b having an index corresponding to a middle value among the indices of the CUs as a CU of a central location among the CUs determined by splitting the first CU 1410. According to an embodiment, when determining an index for distinguishing the split CUs, the image decoding apparatus 100 may determine the index based on a size ratio between the CUs when the CUS do not have the same size. Referring to FIG. 14, the CU 1414b generated by splitting the first CU 1410 may be twice the height of the CUs 1414a and 1414c that have the same width as the other CUs 1414a and 1414c but have different heights from the other CUs 1414a and 1414c. In this case, when the index PID of the CU 1414b positioned in the center is 1, the index of the CU 1414c positioned in a next order may be 3, which is increased by 2. As in this case, when the index increases uniformly and then the increase amount changes, the image decoding apparatus 100 may determine that the current CU is split into a plurality of CUs including CUs having different sizes from the other CUs. According to an embodiment, when the split shape mode information indicates “split into an odd number of CUs,” the image decoding apparatus 100 may split the current CU into a shape in which a CU of a certain location among the odd number of CUs (e.g., a central CU) has a different size from the other CUs. In this case, the image decoding apparatus 100 may determine the central CU having the different size by using the index PID for the CU. However, the index and the size or location of the CU of the certain location to be determined are specific for explaining an embodiment and should not be interpreted as being limited thereto, and should be interpreted as being able to use various indices and locations and sizes of CUs.

According to an embodiment, the image decoding apparatus 100 may use a certain data unit from which recursive splitting of the CU begins.

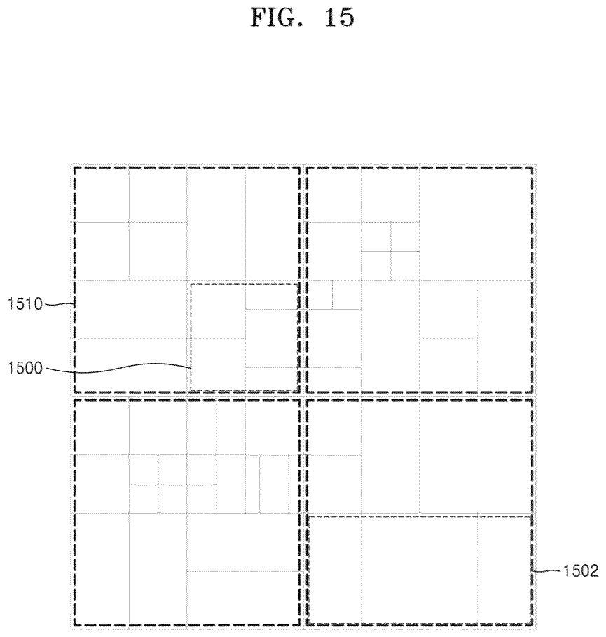

FIG. 15 illustrates that a plurality of CUs are determined according to a plurality of certain data units included in a picture, according to an embodiment.

According to an embodiment, the certain data unit may be defined as a data unit from which the CU begins to be recursively split by using split shape mode information. That is, the certain data unit may correspond to a CU of a highest depth used in a process of determining a plurality of CUs that split a current picture. For convenience of explanation, the certain data units are referred to as reference data units.

According to an embodiment, the reference data unit may represent a certain size and shape. According to an embodiment, the reference data unit may include M×N samples. Here, M and N may be equal to each other, or may be integers expressed as powers of 2. That is, the reference data unit may have a square or a non-square shape, and may be subsequently split into an integer number of CUs.

According to an embodiment, the image decoding apparatus 100 may split the current picture into a plurality of reference data units. According to an embodiment, the image decoding apparatus 100 may split the plurality of reference data units for splitting the current picture by using split shape mode information for each reference data unit. The process of splitting the reference data units may correspond to a splitting process using a quad-tree structure.

According to an embodiment, the image decoding apparatus 100 may predefine a minimum size that the reference data unit included in the current picture may have. Accordingly, the image decoding apparatus 100 may determine reference data units of various sizes having a size greater than or equal to the minimum size, and may determine at least one CU by using the split shape mode information based on the determined reference data units.

Referring to FIG. 15, the image decoding apparatus 100 may use a square-shaped reference CU 1500, or may use a non-square-shaped reference CU 1502. According to an embodiment, the shape and the size of the reference CU may be determined according to various data units (e.g., sequence, picture, slice, slice segment, tile, tile group, CTU, etc.) that may include at least one reference CU.

According to an embodiment, the bitstream obtainer 110 of the image decoding apparatus 100 may obtain at least one of information about the shape of the reference CU and information about the size of the reference CU from the bitstream for each of the various data units. The process of determining at least one CU included in the square-shaped reference CU 1500 has been described above through the process of splitting the current CU 300 of FIG. 3, and the process of determining at least one CU included in the non-square-shaped reference CU 1502 has been described above through the process of splitting the current CU 400 or 450 of FIG. 4, and thus, a detailed description thereof is omitted.

According to an embodiment, the image decoding apparatus 100 may use the index for identifying the size and the shape of the reference CU so as to determine the size and the shape of the reference CU according to some data units predefined based on a certain condition. That is, the bitstream obtainer 110 may obtain only an index for identifying the size and the shape of the reference CU for each slice, slice segment, tile, tile group, CTU, etc., among the various data units (e.g., sequence, picture, slice, slice segment, tile, tile group, CTU, etc.) from the bitstream, as the data unit that satisfies the certain condition (e.g., a data unit having a size smaller than a slice). The image decoding apparatus 100 may determine the size and the shape of the reference data unit for each data unit that satisfies the above-described condition by using an index. When information about the shape of the reference CU and information about the size of the reference CU are obtained from the bitstream for each relatively small-sized data unit and used, the usage efficiency of the bitstream may not be good. Therefore, instead of directly obtaining information about the shape of the reference CU and information about the size of the reference CU, only the index may be obtained and used. In this case, at least one of the size and the shape of the reference CU corresponding to the index indicating the size and the shape of the reference CU may be predefined. That is, the image decoding apparatus 100 may determine at least one of the size and the shape of the reference CU included in the data unit, which serves as a basis for obtaining the index, by selecting at least one of the size and the shape of the predefined reference CU according to the index.

According to an embodiment, the image decoding apparatus 100 may use at least one reference CU included in one CTU 1510. That is, the CTU for splitting the image may include at least one reference CU, and the CU may be determined through a process of recursively splitting each reference CU. In an embodiment, at least one of the width and the height of the CTU may be an integer multiple of at least one of the width and the height of the reference CU. According to an embodiment, the size of the reference CU may be the size of the CTU spilt n times according to the quad tree structure. That is, the image decoding apparatus 100 may determine the reference CU by splitting the CTU n times according to the quad tree structure, and may split the reference CU based on at least one of block shape information and split shape mode information according to various embodiments.

According to an embodiment, the image decoding apparatus 100 may obtain, from the bitstream, and use block shape information indicating the shape of the current CU or split shape mode information indicating the method of splitting the current CU. The split shape mode information may be included in the bitstream associated with various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, and use syntax elements corresponding to the block shape information or the split shape mode information for each CTU and reference CU.

Hereinafter, a method of determining a splitting rule, according to an embodiment of the present disclosure, is described in detail.

The image decoding apparatus 100 may determine an image splitting rule. The splitting rule may be predefined between the image decoding apparatus 100 and the image encoding apparatus 200. The image decoding apparatus 100 may determine the image splitting rule based on the information obtained from the bitstream. For example, the image decoding apparatus 100 may determine the splitting rule based on information obtained from at least one of a sequence parameter set, a picture parameter set, a video parameter set, a slice header, a slice segment header, a tile header, or a tile group header. The image decoding apparatus 100 may determine the splitting rule differently according to a frame, a slice, a tile, a temporal layer, a CUT, or a CU.

The image decoding apparatus 100 may determine the splitting rule based on the block shape of the CU. The block shape may include a size, a shape, a width-to-height ratio, and a direction of the CU. The image encoding apparatus 200 and the image decoding apparatus 100 may predefined the splitting rule based on the block shape of the CU. However, embodiments of the present disclosure are not limited thereto. The image decoding apparatus 100 may determine the splitting rule based on information obtained from the bitstream received from the image encoding apparatus 200.

The shape of the CU may include a square and a non-square. When the width and the height of the CU are equal to each other, the image decoding apparatus 100 may determine that the shape of the CU is a square. In addition, when the width and the height of the CU are not equal to each other, the image decoding apparatus 100 may determine that the shape of the CU is a non-square.

The size of the CU may include various sizes, such as 4×4, 8×4, 4×8, 8×8, 16×4, 16×8, . . . , 256×256. The size of the CU may be classified according to the length of the long side, the length of the short side, or the width of the CU. The image decoding apparatus 100 may apply the same splitting rule to the CUs classified into the same group. For example, the image decoding apparatus 100 may classify CUs, the lengths of the long sides of which are equal to each other, into the same size. In addition, the image decoding apparatus 100 may apply the same splitting rule to CUs, the lengths of the long sides of which are equal to each other.

The width-to-height ratio of the CU may include 1:2, 2:1, 1:4, 4:1, 1:8, 8:1, 1:16, 16:1, 32:1, or 1:32. In addition, the direction of the CU may include the horizontal direction and the vertical direction. The horizontal direction may represent a case where the width of the CU is longer than the height of the CU. The vertical direction may represent a case where the width of the CU is shorter than the height of the CU.

The image decoding apparatus 100 may adaptively determine the splitting rule based on the size of the CU. The image decoding apparatus 100 may determine different allowable split shape modes based on the size of the CU. For example, the image decoding apparatus 100 may determine whether splitting is allowed based on the size of the CU. The image decoding apparatus 100 may determine the split direction according to the size of the CU. The image decoding apparatus 100 may determine an allowable split type according to the size of the CU.

Determining the splitting rule based on the size of the CU may be a splitting rule predefined between the image encoding apparatus 200 and the image decoding apparatus 100. In addition, the image decoding apparatus 100 may determine the splitting rule based on the information obtained from the bitstream.

The image decoding apparatus 100 may adaptively determine the splitting rule based on the location of the CU. The image decoding apparatus 100 may adaptively determine the splitting rule based on the location the CU occupies in the image.

In addition, the image decoding apparatus 100 may determine the splitting rule so that CUs generated through different splitting paths do not have the same block shape. However, embodiments of the present disclosure are not limited thereto, and the CUs generated through different splitting paths may have the same block shape. The CUs generated through different splitting paths may have different decoding processing orders. Because the decoding processing order has been described in conjunction with FIG. 12, a detailed description thereof is omitted.

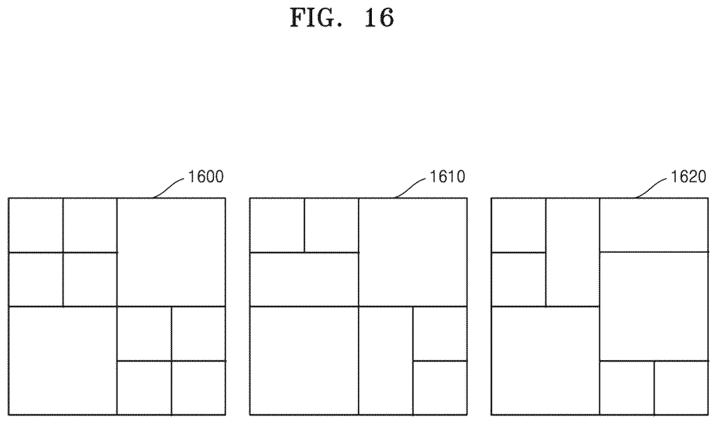

FIG. 16 illustrates CUs that may be determined for each picture when a combination of shapes into which CUs are splittable is different for each picture, according to an embodiment.

Referring to FIG. 16, the image decoding apparatus 100 may determine different combinations of split shapes into which a CU is splittable for each picture. For example, the image decoding apparatus 100 may decode an image by using a picture 1600 that may be split into four CUs among at least one picture included in the image, a picture 1610 that may be split into two or four CUs, and a picture 1620 that may be split into two, three, or four CUs. The image decoding apparatus 100 may use only the split shape information indicating “split into four square-shaped CUs” so as to split the picture 1600 into a plurality of CUs. The image decoding apparatus 100 may use only the split shape information indicating “split into two or four CUs” so as to split the picture 1610. The image decoding apparatus 100 may use only the split shape information indicating “split into two, three, or four CUs” so as to split the picture 1620. The above-described combinations of the split shapes are merely an embodiment for explaining the operation of the image decoding apparatus 100. Therefore, the above-described combinations of the split shapes should not be interpreted as being limited to the embodiment, but should be interpreted as being able to use various combinations of split shapes for each certain data unit.

According to an embodiment, the bitstream obtainer 110 of the image decoding apparatus 100 may obtain a bitstream including an index indicating the combination of the split shape information for each certain data unit (e.g., sequence, picture, slice, slice segment, tile, or tile group, etc.). For example, the bitstream obtainer 110 may obtain an index indicating the combination of the split shape information from a sequence parameter set, a picture parameter set, a slice header, a tile header, or a tile group header. The image decoding apparatus 100 may determine the combinations of the split shapes into which the CU is splittable for each certain data unit by using the obtained index, and accordingly, different combinations of split shapes may be used for each certain data unit.

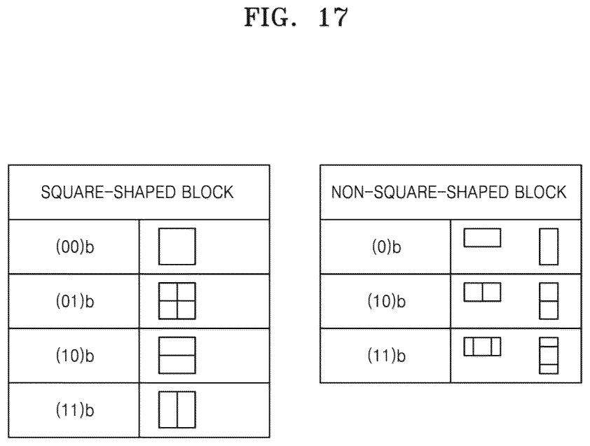

FIG. 17 illustrates various shapes of CUs that may be determined based on split shape mode information expressed in binary code, according to an embodiment.

According to an embodiment, the image decoding apparatus 100 may split a CU into various shapes by using block shape information and split shape mode information obtained through the bitstream obtainer 110. The shapes of the splittable CUs may correspond to various shapes including the shapes described with reference to the above-described embodiments.

Referring to FIG. 17, the image decoding apparatus 100 may split a square-shaped CU in at least one of the horizontal direction and the vertical direction and may split a non-square-shaped CU in the horizontal direction or the vertical direction, based on the split shape mode information.

According to an embodiment, when the image decoding apparatus 100 may split a square-shaped CU into four square-shaped CUs by splitting the square-shaped CU in the horizontal direction and the vertical direction, there may be four types of split shapes that may be indicated by the split shape mode information for the square-shaped CU. According to an embodiment, the split shape mode information may be expressed as two-digit binary code, and the binary code may be assigned to each split shape. For example, when the CU is not split, the split shape mode information may be expressed as (00)b. When the CU is split in the horizontal direction and the vertical direction, the split shape mode information may be expressed as (01)b. When the CU is split in the horizontal direction, the split shape mode information may be expressed as (10)b. When the CU is split in the vertical direction, the split shape mode information may be expressed as (11)b.

According to an embodiment, when the image decoding apparatus 100 splits a non-square-shaped CU in the horizontal direction or the vertical direction, the type of the split shape that may be indicated by the split shape mode information may be determined according to the number of split CUs. Referring to FIG. 17, the image decoding apparatus 100 may split a non-square-shaped CU into up to three CUs, according to an embodiment. The image decoding apparatus 100 may split a CU into two CUs, and in this case, the split shape mode information may be expressed as (10)b. The image decoding apparatus 100 may split a CU into three CUs, and in this case, the split shape mode information may be expressed as (11)b. The image decoding apparatus 100 may determine not to split a CU, and in this case, the split shape mode information may be expressed as (0)b. That is, the image decoding apparatus 100 may use variable length coding (VLC) rather than fixed length coding (FLC) so as to use binary code indicating split shape mode information.

According to an embodiment, referring to FIG. 17, the binary code of the split shape mode information indicating that the CU is not split may be expressed as (0)b. When the binary code of the split shape mode information indicating that the CU is not split is set to (00)b, all binary codes of the 2-bit split shape mode information have to be used even though there is no split shape mode information set to (01)b. However, as illustrated in FIG. 17, when three split shapes are used for a non-square-shaped CU, the image decoding apparatus 100 may determine not to split the CU even though 1-bit binary code (0)b is used as the split shape mode information, and thus, the bitstream may be efficiently used. However, the split shape of the non-square-shaped CU indicated by the split shape mode information should not be interpreted as being limited to only three shapes illustrated in FIG. 17, but should be interpreted as various shapes including the embodiments described above.

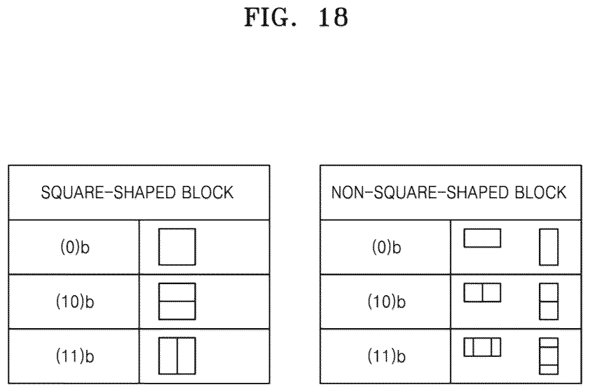

FIG. 18 illustrates other shapes of CUs that may be determined based on split shape mode information expressed in binary code, according to an embodiment.

Referring to FIG. 18, the image decoding apparatus 100 may split a square-shaped CU in the horizontal direction or the vertical direction and may split a non-square-shaped CU in the horizontal direction or the vertical direction, based on the split shape mode information. That is, the split shape mode information may indicate that the square-shaped CU is split in one direction. In this case, the binary code of the split shape mode information indicating that the square-shaped CU is not split may be expressed as (0)b. When the binary code of the split shape mode information indicating that the CU is not split is set to (00)b, all binary codes of the 2-bit split shape mode information have to be used even though there is no split shape mode information set to (01)b. However, as illustrated in FIG. 18, when three split shapes are used for a square-shaped CU, the image decoding apparatus 100 may determine not to split the CU even though 1-bit binary code (0)b is used as the split shape mode information, and thus, the bitstream may be efficiently used. However, the split shape of the square-shaped CU indicated by the split shape mode information should not be interpreted as being limited to only three shapes illustrated in FIG. 18, but should be interpreted as various shapes including the embodiments described above.

In an embodiment, the block shape information or the split shape mode information may be expressed by using binary code, and such information may be directly generated as a bitstream. In addition, the block shape information or the split shape mode information that may be expressed as binary code may not be directly generated as the bitstream, but may be used as binary code input in context adaptive binary arithmetic coding (CABAC).

According to an embodiment, a process in which the image decoding apparatus 100 obtains syntax for the block shape information or the split shape mode information through CABAC is described. A bitstream including binary code for the syntax may be obtained through the bitstream obtainer 110. The image decoding apparatus 100 may detect a syntax element indicating the block shape information or the split shape mode information by de-binarizing a bin string included in the obtained bitstream. According to an embodiment, the image decoding apparatus 100 may obtain a set of binary bin strings corresponding to a syntax element to be decoded, and may decode each bin by using probability information, and the image decoding apparatus 100 may repeat the above process until a bin string including the decoded bins becomes equal to one of the previously obtained bin strings. The image decoding apparatus 100 may determine the syntax element by de-binarizing the bin string.

According to an embodiment, the image decoding apparatus 100 may determine the syntax for the bin string by performing a decoding process of adaptive binary arithmetic coding, and the image decoding apparatus 100 may update a probability model for bins obtained through the bitstream obtainer 110. Referring to FIG. 17, the bitstream obtainer 110 of the image decoding apparatus 100 may obtain the bitstream representing the binary code indicating the split mode information, according to an embodiment. The image decoding apparatus 100 may determine the syntax for the split shape mode information by using the obtained 1-bit or 2-bit binary code. The image decoding apparatus 100 may update the probability for each bit of the 2-bit binary code so as to determine the syntax for the split shape mode information. That is, the image decoding apparatus 100 may update the probability of having a value of 0 or 1 when decoding a next bin, according to whether the value of the first bin in the 2-bit binary code is 0 or 1.

According to an embodiment, in the process of determining the syntax, the image decoding apparatus 100 may update the probability for the bins used in the process of decoding the bins of the bin string for the syntax, and the image decoding apparatus 100 may determine that certain bits in the bin string have the same probability without updating the probability.

Referring to FIG. 17, in the process of determining the syntax by using the bin string indicating the split shape mode information for the non-square-shaped CU, the image decoding apparatus 100 may determine the syntax for the split shape mode information by using one bin having a value of 0 when the non-square-shaped CU is not split. That is, in a case where the block shape information indicates that the current CU is a non-square shape, the first bin of the bin string for the split shape mode information may be 0 when the non-square-shaped CU is not split, and 1 when the non-square-shaped CU is split into two or three CUs. Accordingly, the probability that the first bin of the bin string of the split shape mode information for the non-square-shaped CU is 0 may be ⅓, and the probability that the first bin of the bin string of the split shape mode information for the non-square-shaped CU is 1 may be ⅔. As described above, because the split shape mode information indicating that the non-square-shaped CU is not split may be expressed only as a 1-bit bin string having a value of 0, the image decoding apparatus 100 may determine the syntax for the split shape mode information by determining whether the second bin is 0 or 1 only when the first bin of the split shape mode information is 1. According to an embodiment, the image decoding apparatus 100 may decode the bins by considering that the probability that the second bin is 0 or 1 when the first bin for the split shape mode information is 1 is the same probability.

According to an embodiment, the image decoding apparatus 100 may use various probabilities for each bin in the process of determining the bin of the bin string for the split shape mode information. According to an embodiment, the image decoding apparatus 100 may determine the probability of the bin for the split shape mode information differently according to the direction of the non-square-shaped block. According to an embodiment, the image decoding apparatus 100 may determine the probability of the bin for the split shape mode information differently according to the width or the length of the long side of the current CU. According to an embodiment, the image decoding apparatus 100 may determine the probability of the bin for the split shape mode information differently according to at least one of the shape and the length of the long side of the current CU.

According to an embodiment, the image decoding apparatus 100 may determine that the probability of the bin for the split shape mode information is the same for CUs of a certain size or larger. For example, for CUs with a size of 64 samples or more based on the length of the long side of the CU, the probability of the bin for the split shape mode information may be determined to be the same.

According to an embodiment, the image decoding apparatus 100 may determine an initial probability for bins constituting the bin string of the split shape mode information based on a slice type (e.g., an I slice, a P slice, or a B slice).

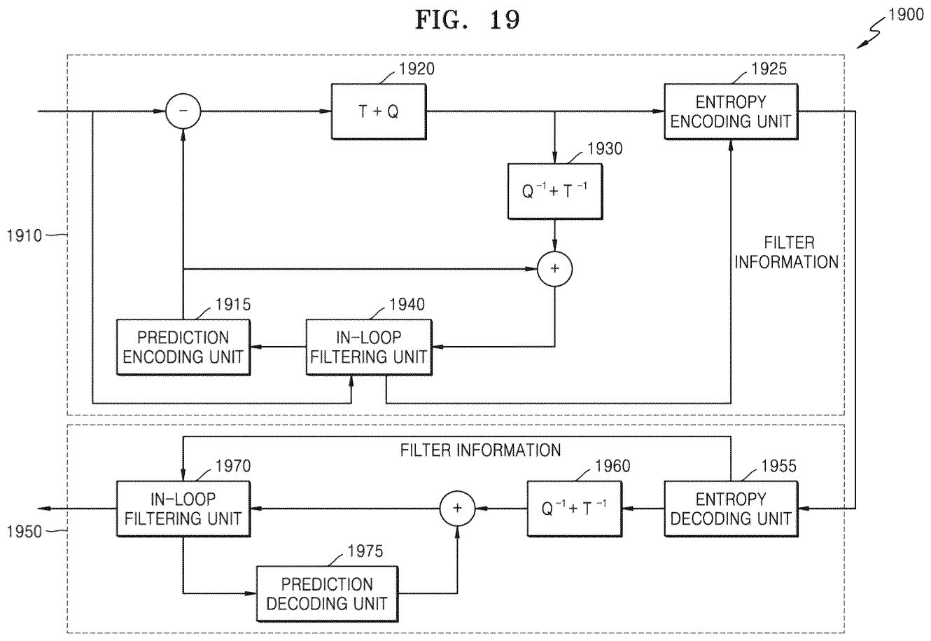

FIG. 19 illustrates a block diagram of an image encoding and decoding system that performs loop filtering.

An encoding stage 1910 of an image encoding and decoding system 1900 transmits an encoded bitstream of an image, and a decoding stage 1950 receives and decodes the bitstream to output a reconstructed image. Here, the encoding stage 1910 may have a configuration similar to a configuration of the image encoding apparatus 200 described below, and the decoding stage 1950 may have a configuration similar to a configuration of the image decoding apparatus 100.

In the encoding stage 1910, a prediction encoder 1915 outputs prediction data through inter-prediction and intra-prediction, and a transformation and quantization unit 1920 outputs quantized transformation coefficients of residual data between the prediction data and a current input image. An entropy encoder 1925 outputs a bitstream by encoding and converting the quantized transformation coefficients. The quantized transformation coefficients are reconstructed to spatial domain data through an inverse quantization and inverse transformation unit 1930, and the reconstructed spatial domain data is output as a reconstructed image through an in-loop filtering unit 1940. The reconstructed image may be used as a reference image for a next input image through the prediction encoder 1915.

Encoded image data in the bitstream received by the decoding stage 1950 is reconstructed to spatial domain residual data through an entropy decoder 1955 and an inverse quantization and inverse transformation unit 1960. Prediction data and residual data output from a prediction decoder 1975 may be combined to form spatial domain image data, and an in-loop filtering unit 1970 may output a reconstructed image for a current original image by performing filtering on the spatial domain image data. The reconstructed image may be used as a reference image for a next original image by the prediction decoder 1975.

The in-loop filtering unit 1940 of the encoding stage 1910 performs loop filtering by using filter information input according to a user input or system settings. The filter information used by the in-loop filtering unit 1940 is output to the entropy encoder 1925 and transmitted to the decoding stage 1950 together with the encoded image data. The in-loop filtering unit 1970 of the decoding stage 1950 may perform loop filtering based on filter information input from the decoding stage 1950.

The various embodiments described above describe operations related to the image decoding method performed by the image decoding apparatus 100. Hereinafter, the operation of the image encoding apparatus 200 that performs the image encoding method corresponding to the reverse process of the image decoding method is described with reference to various embodiments.

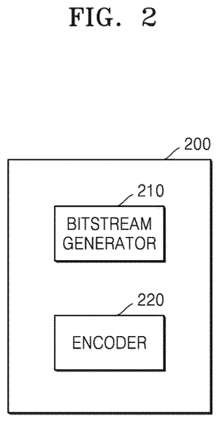

FIG. 2 illustrates a block diagram of the image encoding apparatus 200 capable of encoding an image based on at least one of block shape information and split shape mode information, according to an embodiment.

The image encoding apparatus 200 may include an encoder 220 and a bitstream generator 210. The encoder 220 may receive an input image and encode the input image. The encoder 220 and the bitstream generator 210 may include or be implemented by at least one processor. In addition, encoder 220 and the bitstream generator 210 may include memory that stores instructions that are executed by at least one processor individually or collectively.

The encoder 220 may obtain at least one syntax element by encoding the input image. The syntax element may include at least one of skip flag, prediction mode, motion vector difference, motion vector prediction method (or index), transform quantized coefficient, coded block pattern, coded block flag, intra-prediction mode, direct flag, merge flag, delta QP, reference index, prediction direction, and transform index. The encoder 220 may determine a context model based on block shape information including at least one of a shape, a direction, a width-to-height ratio, or a size of a CU.

The bitstream generator 210 may generate the bitstream based on the encoded input image. For example, the bitstream generator 210 may generate the bitstream by performing entropy encoding on the syntax element based on the context model. In addition, the image encoding apparatus 200 may transmit the bitstream to the image decoding apparatus 100.

According to an embodiment, the encoder 220 of the image encoding apparatus 200 may determine the shape of the CU. For example, the CU may have a square shape or a non-square shape, and information indicating the shape may be included in the block shape information.

According to an embodiment, the encoder 220 may determine the shape into which the CU is split. The encoder 220 may determine the shape of at least one CU included in the CU, and the bitstream generator 210 may generate the bitstream including the split shape mode information including information about the shape of the CU.

According to an embodiment, the encoder 220 may determine whether or not the CU is split. When the encoder 220 determines that the CU is not split or only one CU is included in the CU, the bitstream generator 210 may generate a bitstream that includes split mode information indicating that the CU is not split. In addition, the encoder 220 may split the CU into a plurality of CUs included in the CU, and the bitstream generator 210 may generate a bitstream that includes split shape mode information indicating “split into the plurality of CUs.”

According to an embodiment, information indicating how many CUs the CU is to be split into or in which direction the CU is to be split may be included in the split shape mode information. For example, the split shape mode information may indicate “split in at least one of the vertical direction and the horizontal direction,” or may indicate “not split.”

The image encoding apparatus 200 determines information about the split shape mode based on the split shape mode of the CU. The image encoding apparatus 200 determines a context model based on at least one of a shape, a direction, a width-to-height ratio, or a size of a CU. The image encoding apparatus 200 generates, as the bitstream, information about the split shape mode for splitting the CU based on the context model.

To determine the context model, the image encoding apparatus 200 may obtain an array for matching at least one of the shape, the direction, the width-to-height ratio, or the size of the CU with an index for the context model. The image encoding apparatus 200 may obtain the index for the context model based on at least one of the shape, the direction, the width-to-height ratio, or the size of the CU in the array. The image encoding apparatus 200 may determine the context model based on the index for the context model.

To determine the context model, the image encoding apparatus 200 may determine the context model further based on block shape information including at least one of a shape, a direction, a width-to-height ratio, or a size of a neighboring CU adjacent to the CU. In addition, the neighboring CU may include at least one of CUs positioned on a lower left side, a left side, an upper left side, an upper right side, a right side, or a lower right side of the CU.

In addition, to determine the context model, the image encoding apparatus 200 may compare the length of the width of the upper neighboring CU with the length of the width of the CU. In addition, the image encoding apparatus 200 may compare the length of the height of the left and right neighboring CUs with the length of the height of the CU. In addition, the image encoding apparatus 200 may determine the context model based on the comparison results.

Because the operation of the image encoding apparatus 200 includes similar contents to the operation of the image decoding apparatus 100 described with reference to FIGS. 3 to 19, a detailed description thereof is omitted.

In an embodiment of the present disclosure, an adaptive parameter set (APS) filter set may include a current APS filter set or a previous APS filter set. The APS filter set may be a set of filters obtained or derived for each slice from a slice header or an APS. In addition, at least one APS filter set corresponding to one slice may be obtained or derived.

In an embodiment of the present disclosure, the current APS filter set may represent a set of filters obtained or derived from a slice header for a current slice so as to filter blocks included in the current slice. For example, the image decoding apparatus may obtain or derive four APS filter sets for filtering blocks included in the current slice. On the other hand, the number of APS filter sets for filtering blocks included in the current slice is not limited to the disclosed example and may be less than or more than four.

In an embodiment of the present disclosure, the current APS filter set may represent a set of filters obtained or derived from a slice header for a previous slice so as to filter blocks included in the previous slice. For example, the image decoding apparatus may obtain or derive at least one filter set from the slice header for the previous slice so as to filter blocks included in the previous slice. The image decoding apparatus may use the filter sets obtained from the slice header for the previous slice to filter the blocks included in the current slice. On the other hand, the previous slice may be a previously decoded slice in the current image or a slice included in a previously decoded image.

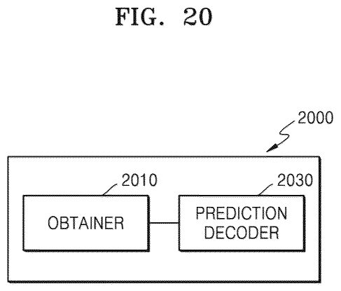

FIG. 20 is a block diagram illustrating a configuration of an image decoding apparatus 2000 according to an embodiment.

Referring to FIG. 20, the image decoding apparatus 2000 may include an obtainer 2010 and a prediction decoder 2030. The obtainer 2010 illustrated in FIG. 20 may correspond to the bitstream obtainer 110 illustrated in FIG. 1, and the prediction decoder 2030 may correspond to the decoder 120 illustrated in FIG. 1. In addition, the obtainer 2010 may correspond to the entropy decoder 1955 illustrated in FIG. 19, and the prediction decoder 2030 may correspond to the prediction decoder 1975 illustrated in FIG. 19.

In an embodiment, the obtainer 2010 and the prediction decoder 2030 may include or be implemented as at least one processor. In an embodiment, the obtainer 2010 and the prediction decoder 2030 may operate according to instructions stored in memory and executed by the at least one processor.

In an embodiment, the image decoding apparatus 2000 may include memory that stores input and output data of the obtainer 2010 and the prediction decoder 2030. In addition, the image decoding apparatus 2000 may include a memory controller that controls data input and output of the memory.

In an embodiment, the obtainer 2010 may obtain a bitstream generated as a result of encoding an image.

In an embodiment, the bitstream may include a result of encoding a current block. The bitstream may include pieces of information that are used to reconstruct the current block. The current block may be a CTU, a CU, a transform unit, a prediction unit, or a filtering unit split from a current image to be decoded. In addition, the current block may be a block of a predefined location that is processed in an encoding or decoding operation being currently performed. A current sample may be any sample included in the current block.

In an embodiment, the prediction decoder 2030 may determine the current block based on block shape information and/or split shape mode information included in the bitstream corresponding to at least one level of a sequence parameter set, a picture parameter set, a video parameter set, a slice header, and a slice segment header.

In an embodiment, the obtainer 2010 may receive the bitstream from the image encoding apparatus through a network.

In an embodiment, the obtainer 2010 may obtain the bitstream from a data storage medium including a magnetic medium, such as hard disk, floppy disk, and magnetic tape, an optical recording medium, such as compact disc read-only memory (CD-ROM) and digital versatile disc (DVD), a magneto-optical medium, such as floptical disk, or the like.

In an embodiment, the obtainer 2010 may obtain syntax elements for decoding an image from the bitstream. Values corresponding to the syntax elements may be included in the bitstream according to a hierarchical structure of the image.

In an embodiment, the obtainer 2010 may obtain bins corresponding to the syntax elements by performing entropy decoding on the bitstream.

In an embodiment, the prediction decoder 2030 may obtain information about adaptive loop filtering from the bitstream. The information about adaptive loop filtering may also be obtained as the syntax elements. The prediction decoder 2030 may obtain all or part of the information about adaptive loop filtering from at least one of a sequence parameter set, a picture parameter set, an APS, a slice header, and slice data of the bitstream. The information about adaptive loop filtering may include at least one of information indicating whether to perform adaptive loop filtering, information about whether to use an APS filter set, a filter set index, information about whether to obtain a current APS filter set, an APS index, information about the number of filters included in each of the current APS filter sets included in the APS filter set, and information about at least one APS filter included in the current APS filter set (e.g., APS filter coefficients, classifier information, etc.).

On the other hand, the APS filter may be referred to as an adaptive filter. In addition, the APS filter set may be referred to as an adaptive filter set. In addition, the APS filter coefficients may be referred to as adaptive filter coefficients.

For example, the information about adaptive loop filtering obtained from the sequence parameter set may be information for an APS filter to be applied to a current sequence. The information about adaptive loop filtering obtained from the picture parameter set may be information for an APS filter to be applied to a current picture. The information about adaptive loop filtering obtained from the slice header or the slice data may be information for an APS filter to be applied to a current slice.

On the other hand, the adaptive loop filter may be a filter that uses one filter set among at least one predefined filter set, at least one previous APS filter set, and at least one current APS filter set. The previous APS filter may be a filter included in the current APS filter set included in the information about adaptive loop filtering obtained for data units decoded before the current block. The information about adaptive loop filtering for the previously decoded data units may be used as information about the previous APS filter. The adaptive loop filtering may include at least one of filtering using the predefined filter set (e.g., first filtering, second filtering, or third filtering) and APS filtering.

In an embodiment, the prediction decoder 2030 may obtain information about whether to use the APS filter set, based on the information indicating whether to perform adaptive loop filtering. For example, when the prediction decoder 2030 determines to perform adaptive loop filtering, the prediction decoder 2030 may obtain information about whether to use the APS filter set.

In an embodiment, the prediction decoder 2030 may obtain at least one of the filter set index, the information about whether to obtain the current APS filter set, and the APS index, based on the information indicating whether to use the APS filter set. For example, when the prediction decoder 2030 determines not to use the APS filter set, the prediction decoder 2030 may obtain the filter set index. When the prediction decoder 2030 determines to use the APS filter set, the prediction decoder 2030 may obtain the APS index and the information about whether to obtain the current APS filter set.

In an embodiment, the prediction decoder 2030 may obtain information about the number of filters included in each of the current APS filter sets included in the APS filter set and information about at least one APS filter included in the current APS filter set, based on the information about whether to obtain the current APS filter set. For example, when the prediction decoder 2030 determines to obtain the current APS filter set, the prediction decoder 2030 may obtain information about the number of filters included in each of the current APS filter sets included in the APS filter set and information about at least one APS filter included in the current APS filter set.

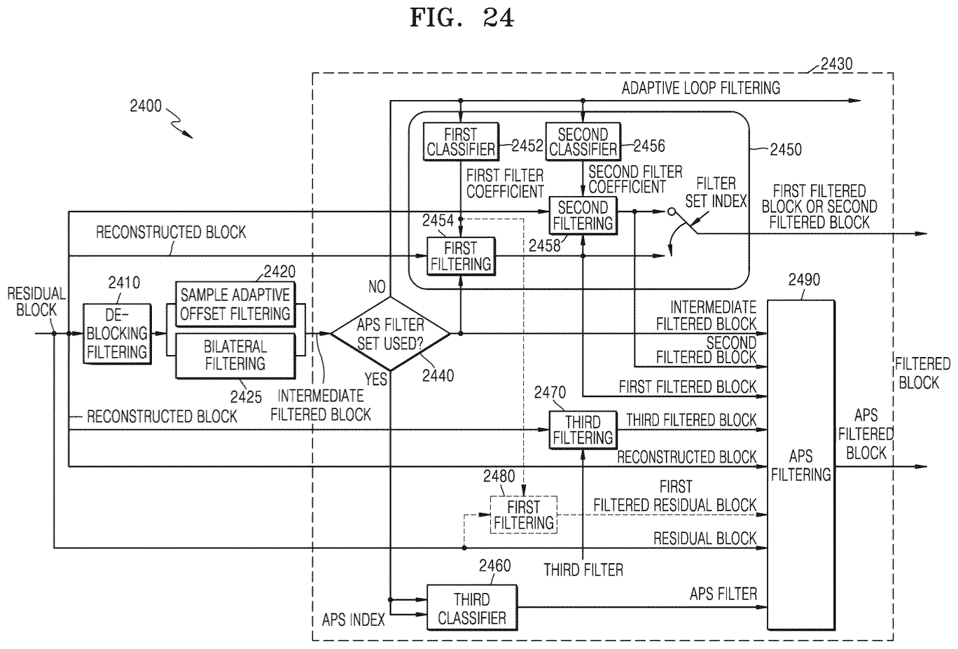

In an embodiment, the prediction decoder 2030 may perform filtering using the predefined filter set for the current block, based on at least one predefined filter set and the filter set index. For example, the prediction decoder 2030 may store, in the memory, the filter set including at least one filter derived from learned data. The prediction decoder 2030 may store at least one filter set in the memory. Hereinafter, details thereof are described with reference to FIG. 24. Hereinafter, the predefined filter may be referred to as a fixed filter. In addition, the predefined filter set may be referred to as a fixed filter set. The filter set index may be referred to as a fixed filter index or a fixed index.

In an embodiment, the prediction decoder 2030 may perform first filtering on the current block by using a reconstructed block, an intermediate filtered block for a current block, and a first filter. The prediction decoder 2030 may obtain a first filtered block including a first filtered sample corresponding to a current sample by performing the first filtering by using the reconstructed block, the intermediate filtered block, and the first filter. The prediction decoder 2030 may obtain a first filtered sample corresponding to the current sample by performing filtering by using the intermediate filtered sample for the current sample and the first filter.

In an embodiment, the prediction decoder 2030 may obtain a second filtered sample corresponding to the current sample by performing second filtering by using the reconstructed block, the first filtered block, and a second filter. The prediction decoder 2030 may obtain a second filtered block including a second filtered sample corresponding to the current sample by performing the second filtering by using the reconstructed block, the first filtered block, and the second filter. The prediction decoder 2030 may obtain a filtered sample corresponding to the current sample by performing filtering by using the first filtered sample and the second filter.

In an embodiment, the prediction decoder 2030 may obtain a third filtered block including a third filtered sample corresponding to the current sample by performing third filtering by using the reconstructed block and a third filter. The prediction decoder 2030 may obtain a third filtered sample corresponding to the current sample by performing filtering by using the reconstructed sample and the third filter.

In an embodiment, the prediction decoder 2030 may perform APS filtering by using at least one of information about adaptive loop filtering and at least one block among an intermediate filtered block, a first filtered block, a second filtered block, a third filtered block, a reconstructed block, a residual block, a first filtered residual block, a second filtered residual block, a third filtered residual block, a third filtered intermediate filtered block, and a differential block. The prediction decoder 2030 may perform adaptive loop filtering by using at least one of an intermediate filtered block, a first filtered block, a second filtered block, a third filtered block, a reconstructed block, a residual block, a first filtered residual block, and an adaptive filter.

In an embodiment, the prediction decoder 2030 may perform adaptive loop filtering based on information about adaptive loop filtering and at least one sample among a reconstructed sample, a first filtered sample, a second filtered sample, a third filtered sample, an intermediate filtered sample, a residual sample, a first filtered residual sample, a second filtered residual sample, a third filtered residual sample, a third filtered intermediate filtered sample, and a differential sample.

In an embodiment, the prediction decoder 2030 may perform filtering based on at least one sample among the reconstructed sample and the neighboring samples of the reconstructed sample, at least one sample among the first filtered sample and the neighboring samples of the first filtered sample, at least one sample among the second filtered sample and the neighboring samples of the second filtered sample, at least one sample among the third filtered sample and the neighboring samples of the third filtered sample, at least one sample among the intermediate filtered sample and the neighboring samples of the intermediate filtered sample, at least one sample among the residual sample and the neighboring samples of the residual sample, at least one sample among the first filtered residual sample and the neighboring samples of the first filtered residual samples, at least one sample among the second filtered residual sample and the neighboring samples of the second filtered residual sample, at least one sample among the third filtered residual sample and the neighboring samples of the third filtered residual sample, at least one sample among the third filtered intermediate filtered sample and the neighboring samples of the third filtered intermediate filtered sample, at least one sample among the differential sample and the neighboring samples of the differential sample, and the information about adaptive loop filtering.

Hereinafter, various methods of performing adaptive loop filtering in the present disclosure are described in detail.

In an embodiment, the image decoding apparatus 2000 may obtain the filtered block by performing adaptive loop filtering on the current block. The image decoding apparatus 2000 may obtain a filtered block, on which adaptive loop filtering has been performed, by performing APS filtering or filtering using the predefined filter set on the current block by using the APS filter or the predefined filter. The filtered block may include an adaptive loop filtered sample.

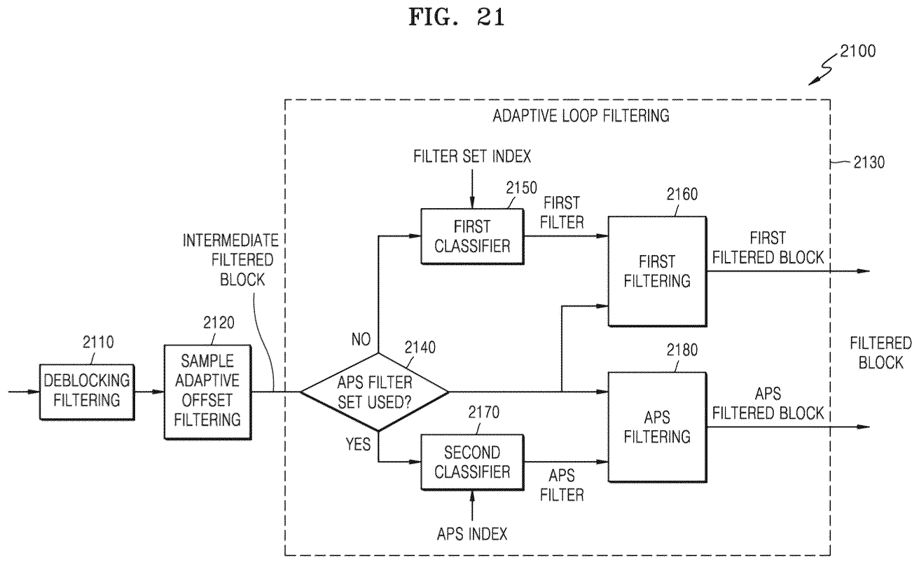

Hereinafter, in the present disclosure, a specific description of the operation of performing adaptive loop filtering is described below with reference to FIGS. 21 to 33.

FIG. 21 is a diagram illustrating an in-loop filtering operation according to an embodiment.

In an embodiment, the in-loop filtering unit of the image encoding apparatus or the in-loop filtering unit of the image decoding apparatus 2000 (hereinafter, an in-loop filtering unit 2100) may perform at least one of deblocking filtering 2110, sample adaptive offset filtering 2120, and adaptive loop filtering 2130.

In an embodiment, the deblocking filtering 2110 may be filtering applied to a boundary of a transform block by using a deblocking filter to reduce blocking artifacts that occur during the process of performing transformation, prediction, and quantization.

In an embodiment, the filter length for the deblocking filtering 2110 may be determined based on image components or the size of minimum transform blocks on both sides. A 4-tap, 8-tap, or 14-tap filter may be applied to transform block for luma samples, and a 6-tap filter may be applied to transform block for chroma samples. On the other hand, the size or length of the tap used for the deblocking filtering 2110 is not limited to the disclosed examples.

In an embodiment, the filter length for the deblocking filtering 2110 may be determined based on the smoothness or boundary condition of boundaries between transform blocks. For example, when performing filtering on image data, the image decoding apparatus 2000 may identify an area including high-dispersion samples as an edge and may not perform deblocking filtering, so as to prevent the edge of an object from being blurred. The image decoding apparatus 2000 may calculate the smoothness within the image data or identify whether the boundary condition is satisfied, and may filter the boundary of the transform block only when the boundary of the transform block is identified as being flat. The boundary condition may differ depending on whether the boundary is a vertical boundary or a horizontal boundary, whether the transform block is for luma samples, or whether the transform block is for chroma samples. The image decoding apparatus 2000 may obtain, from a bitstream, information associated with the boundary condition, and the boundary condition may be preset. In addition, a filter coefficient associated with the deblocking filtering 2110 may be preset.

In an embodiment, the sample adaptive offset filtering 2120 may be filtering that classifies samples of neighboring blocks and uses offsets for the classified samples, so as to reduce ringing artifacts. For example, the sample adaptive offset filtering 2120 may be filtering that reduces an error between a reconstructed image and an original image by adding an offset to at least one sample included in an image on which the deblocking filtering has been performed.

In an embodiment, the sample adaptive offset filtering 2120 may determine sample characteristics within a block as one of using no sample adaptive offset filtering, performing edge offset filtering, or performing band offset filtering.

In an embodiment, the edge offset filtering is filtering that is performed when it is identified that a block has an edge in a specific direction and there is an error for samples in an edge direction. The image decoding apparatus 2000 may perform the edge offset filtering on the block by obtaining a class corresponding to a block and four edge offset values for the purpose of edge offset filtering.

In an embodiment, the band offset filtering is filtering that classifies samples within a block into brightness bands having similar brightness values and uses offsets for a plurality of consecutive bands. The image decoding apparatus 2000 may perform the band offset filtering by obtaining information about a start period of a band and an offset value for each of a plurality of bands so as to obtain information about the plurality of bands.

In an embodiment, the image decoding apparatus 2000 may perform sample adaptive offset filtering on the current block by using information about sample adaptive offset filtering for neighboring blocks. For example, the image decoding apparatus 2000 may perform sample adaptive offset filtering on the current block by using information about sample adaptive offset filtering for an upper block or a left block.

In an embodiment, the adaptive loop filtering 2130 may be filtering that is applied to the current block by using a filter adaptively determined or obtained based on characteristics of the current block. The adaptive loop filtering 2130 may be filtering that is performed by using at least one predefined filter set, at least one APS filter set obtained from an APS, and a filter determined based on at least one of classes of the current block. On the other hand, the operation of obtaining the filter set may include an operation of obtaining filter coefficients for each of a plurality of filters for the adaptive loop filtering 2130 of the current block. In addition, the operation of obtaining the filter may include an operation of obtaining at least one filter coefficient for the filter.

In an embodiment, the image decoding apparatus 2000 may perform the adaptive loop filtering 2130 by using a 7×7 filter, which is a 7×7 diamond-shaped filter, for luma components of the current sample included in the current block and using a 5×5 filter, which is a 5×5 diamond-shaped filter, for chroma components. The adaptive loop filtering 2130 may include first filtering 2160 or APS filtering 2180.

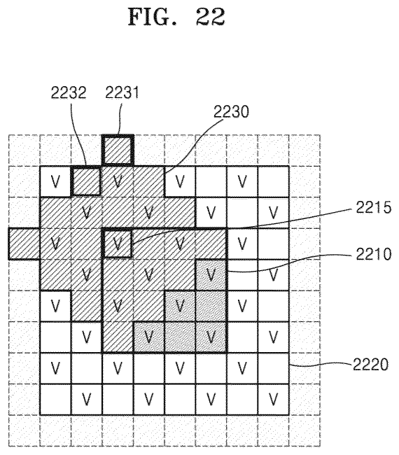

Hereinafter, a filter shape (or tap) used to perform the adaptive loop filtering 2130, according to an embodiment, is described in detail with reference to FIG. 22, 23, or 25. On the other hand, a type of a block and a shape and a size of a filter used to perform the adaptive loop filtering 2130 are not limited to the disclosed examples.

In an embodiment, the image decoding apparatus 2000 may determine a class of the current block as one of a plurality of classes based on characteristics such as directionality and activity of samples within the current block. The characteristics such as directionality and activity of samples within the current block may be determined by using a gradient for the current block. For example, the directionality of the current block included in the current image may be determined as one of five directionalities by calculating horizontal, vertical, and diagonal gradients from the samples included in the current block and the neighboring samples of the current block. In addition, the activity of the current block may be determined as one of five activities by using the gradient calculated for directionality classification. Because the class of the current block may be determined by using the five directionalities and the five activities, the class of the current class may be determined as one of 25 classes.

On the other hand, the number of directionalities, the number of activities, and the number of classes are not limited to the disclosed examples. Hereinafter, the method for determining the class of the current block is described in detail with reference to FIG. 22.

In an embodiment, the image decoding apparatus 2000 may obtain information about adaptive loop filtering from the bitstream. The image decoding apparatus 2000 may obtain information about adaptive loop filtering from a slice header, slice data, or an APS. The information about adaptive loop filtering may include at least one of information indicating whether to perform adaptive loop filtering, information 2140 about whether to use an APS filter set, and at least one APS filter set.

In an embodiment, the image decoding apparatus 2000 may obtain information indicating whether to perform adaptive loop filtering, which is included in the information about adaptive loop filtering.

In an embodiment, the image decoding apparatus 2000 may obtain the information 2140 about whether to use the APS filter set. For example, the image decoding apparatus 2000 may obtain an index indicating whether to use the APS filter set as the information 2140 about whether to use the APS filter set.

In an embodiment, the image decoding apparatus 2000 may determine to perform the adaptive loop filtering 2130 on the current block, without using the APS filter set, based on the information 2140 about whether to use the APS filter set. For example, when the image decoding apparatus 2000 determines not to use the APS filter set, the image decoding apparatus 2000 may perform the first filtering 2160 by using at least one predefined filter set. The at least one predefined filter set may be stored in the memory of the image decoding apparatus 2000.

In an embodiment, when the image decoding apparatus 2000 determines not to use the APS filter set, the image decoding apparatus 2000 may obtain a filter set index indicating one of the at least one predefined filter set. The image decoding apparatus 2000 may determine the first filter for the current block based on the filter set index and the class. The image decoding apparatus 2000 may identify or obtain filter coefficients for the first filter determined based on the filter set index and the class.

For example, the number of predefined filters may be 64, and the number of predefined filter sets may be 16. In addition, each of the filter sets may include information about filters respectively corresponding to the 25 classes.

In an embodiment, the image decoding apparatus 2000 may obtain the filter coefficients for the first filter by inputting the filter set index and the current block to a first classifier 2150. The first classifier 2150 may determine the first filter based on the class determined according to the filter set index and the characteristics of the current block. The image decoding apparatus 2000 may obtain the filter coefficients for the first filter output by the first classifier 2150. The current block may be a 2×2 or 4×4 block. On the other hand, the number of predefined filters, the number of predefined filter sets, and the size of the current block, which is the unit in which filtering is performed, are not limited to the disclosed examples.

In an embodiment, the image decoding apparatus 2000 may perform the first filtering 2160 on the intermediate filtered block for the current block by using the filter coefficients for the first filter. The image decoding apparatus 2000 may obtain a filtered block by performing the first filtering 2160 on the intermediate filtered block. The image decoding apparatus 2000 may obtain, as the filtered block, the first filtered block obtained by performing the first filtering 2160 on the intermediate filtered block.

In an embodiment, the image decoding apparatus 2000 may perform the first filtering 2160 on the current block by performing the first filtering on at least one sample or all samples included in the intermediate filtered block. For example, the image decoding apparatus 2000 may perform filtering on the intermediate filtered sample corresponding to the current sample by adding values obtained by multiplying the difference values between the intermediate filtered block and the neighboring samples of the intermediate filtered sample included in the intermediate filtered block by corresponding first filter coefficients respectively by using a first filter tap for the first filtering 2160. In addition, the image decoding apparatus 2000 may perform the first filtering 2160 on the current block by performing filtering on the intermediate filtered sample on at least one sample or all samples included in the intermediate filtered block.

On the other hand, the intermediate filtered block may represent a block on which at least one of deblocking filtering, sample adaptive offset filtering, and bilateral filtering has been performed. In addition, the intermediate filtered block may represent a reconstructed block when it is determined that deblocking filtering, sample adaptive offset filtering, and bilateral filtering has not been performed.

In an embodiment, the image decoding apparatus 2000 may determine to perform the adaptive loop filtering 2130 by using the APS filter set, based on the information 2140 about whether to use the APS filter set.

In an embodiment, when the image decoding apparatus 2000 determines to perform the adaptive loop filtering 2130 by using the APS filter set, the image decoding apparatus 2000 may obtain information about whether to obtain the current APS filter set. The image decoding apparatus 2000 may obtain the current APS filter set based on the information about whether to obtain the current APS filter set. When the image decoding apparatus 2000 determines to obtain the current APS filter set, the image decoding apparatus 2000 may obtain an APS index indicating one filter set among at least one current APS filter set and at least one previous APS filter set. In the present disclosure, the APS index may be an index indicating a filter set including a filter to be applied to the current block among at least one APS filter set.

In an embodiment, the image decoding apparatus 2000 may not obtain the current APS filter set based on the information about whether to obtain the current APS filter set. When the image decoding apparatus 2000 determines not to use the current APS filter set, the image decoding apparatus 2000 may obtain an APS index indicating one filter set among at least one previous APS filter sets. In an embodiment, the image decoding apparatus 2000 may obtain the APS index from a slice header, slice data, or an APS.

In an embodiment, the image decoding apparatus 2000 may perform APS filtering 2180 based on the APS index. The image decoding apparatus 2000 may obtain the APS filter of the current block by using the class of the current block and the APS filter set indicated by the APS index. The image decoding apparatus 2000 may perform the APS filtering 2180 on the current block by using the APS filter.

For example, the image decoding apparatus 2000 may obtain four current APS filter sets and two previous APS filter sets as APS filter sets for the current slice. Each of the APS filter sets may include information about filters respectively corresponding to up to 25 classes. The image decoding apparatus 2000 may obtain an APS index having the index value of one among indices from 0 to 5 respectively corresponding to the four current APS filter sets and the two previous APS filter sets. On the other hand, the number of current APS filter sets and the number of previous APS filter sets are not limited to the disclosed examples.

In an embodiment, the image decoding apparatus 2000 may obtain the filter coefficients for the APS filter by inputting the APS index and the current block to a second classifier 2170. The second classifier 2170 may determine the APS filter based on the class determined according to the APS index and the characteristics of the current block. The image decoding apparatus 2000 may obtain the filter coefficients for the APS filter output by the second classifier 2170. Hereinafter, in the present disclosure, obtaining the filter from the classifier may include obtaining filter coefficients for each filter. In addition, in the present disclosure, using each filter may include using filter coefficients for each filter.

In an embodiment, the image decoding apparatus 2000 may perform the APS filtering 2180 on the intermediate filtered block by using the filter coefficients for the APS filter. The image decoding apparatus 2000 may obtain a filtered block by performing the APS filtering 2180 on the intermediate filtered block. The image decoding apparatus 2000 may obtain, as the filtered block, the APS filtered block obtained by performing the APS filtering 2180 on the intermediate filtered block.

On the other hand, an operation of performing certain filtering on a certain block may include an operation of performing certain filtering by using a sample value included in the certain block. In addition, an operation of performing filtering by using a certain filter on a certain sample may include an operation of performing filtering by using sample values of the certain sample and neighboring samples of the certain sample.

In an embodiment, the image decoding apparatus 2000 may minimize an error between an original sample of a current image and a filtered sample by performing the adaptive loop filtering 2130 including the first filtering 2160 or the APS filtering 2180. Therefore, an image with less error from the original may be provided by performing the adaptive loop filtering 2130.

FIG. 22 is a diagram for describing an operation of performing filtering on a current sample, according to an embodiment.

In an embodiment, the image decoding apparatus 2000 may adaptively determine a filter based on characteristics such as directionality and activity of a current block 2210. The image decoding apparatus 2000 may filter the current block 2210 by using the adaptively determined filter.

In an embodiment, the image decoding apparatus 2000 may determine a class of the current block 2210 by using the directionality and the activity of the current block 2210 according to Equation 1 below.

$$C = 5 D + \hat{A} \qquad [ Equation 1 ]$$

In an embodiment, the image decoding apparatus 2000 may determine the directionality D and the activity A of the current block 2210 based on a gradient for the current block 2210. The image decoding apparatus 2000 may determine the gradient for the current block 2210 including a vertical gradient, a horizontal gradient, a gradient connecting the top left and the bottom right, and a gradient connecting the top right and the bottom left.

In an embodiment, the gradient for the current block 2210 may be determined by taking into account not only the samples included in the current block 2210 but also neighboring samples 2230 of the current block 2210. The gradient for the current block 2210 may be calculated based on samples included in an extension block 2220 including the current block 2210. On the other hand, the extension block 2220 is not limited to the example disclosed in FIG. 22, and may be another block covering the current block 2210.

In an embodiment, the vertical gradient gᵥ for the current block 2210 may be determined according to Equation 2 below. The horizontal gradient gₕ for the current block 2210 may be determined according to Equation 3 below. The gradient gai connecting the top left and the bottom right with respect to the current block 2210 may be determined according to Equation 4 below. The gradient g_{d2} connecting the top right and the bottom left with respect to the current block 2210 may be determined according to Equation 5 below. R(i,j) representing a current sample 2215 may be a top left sample of the current block 2210.

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad [ Equation 2 ]$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert \qquad [ Equation 3 ]$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad [ Equation 4 ]$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert \qquad [ Equation 5 ]$$

On the other hand, Equations 2 to 5 above may be to perform one-dimensional Laplacian calculations on some samples indicated by V so as to reduce the complexity or computational amount of class determination, or may be to perform one-dimensional Laplacian calculations on all samples included in the extension block 2220.

In an embodiment, the image decoding apparatus 2000 may use maximum and minimum values of the horizontal and vertical gradients and maximum and minimum values of the diagonal gradients so as to determine directionality. For example, the image decoding apparatus 2000 may determine the maximum value

$${g}_{h , v}^{max}$$

and the minimum value

$${g}_{h , v}^{min}$$

of the horizontal or vertical gradient as follows. In addition, the image decoding apparatus 2000 may determine the maximum value

$${g}_{d 0 , d 1}^{max}$$

and minimum value

$${g}_{d 0 , d 1}^{min}$$

of the diagonal gradient as follows,

$${g}_{h , v}^{max} = max ( {g}_{h} , {g}_{v} )$$

$${g}_{h , v}^{min} = min ( {g}_{h} , {g}_{v} )$$

$${g}_{d 0 , d 1}^{max} = max ( {g}_{d 0} , {g}_{d 1} )$$

$${g}_{d 0 , d 1}^{min} = min ( {g}_{d 0} , {g}_{d 1} )$$

In an embodiment, the image decoding apparatus 2000 may determine the value of the directionality D based on conditions using the maximum and minimum values of the horizontal and vertical gradients and the maximum and minimum values of the diagonal gradients. For example, when the conditions

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are satisfied, the value of the directionality D may be determined as 0. When the image decoding apparatus 2000 satisfies

$${g}_{h , v}^{max} / {g}_{h , v}^{min} > {g}_{d 0 , d 1}^{max} / {g}_{d 0 , d 1}^{min} and {g}_{h , v}^{max} > {t}_{2} \cdot {g}_{h , v}^{min} ,$$

the image decoding apparatus 2000 may determine the value of the directionality D as 2. When the image decoding apparatus 2000 satisfies

$${g}_{h , v}^{max} / {g}_{h , v}^{min} > {g}_{d 0 , d 1}^{max} / {g}_{d 0 , d 1}^{min}$$

but does not satisfy

$${g}_{h , v}^{max} > {t}_{2} \cdot {g}_{h , v}^{min} ,$$

the image decoding apparatus 2000 may determine the value of the directionality D as 1. When the image decoding apparatus 2000 does not satisfy

$${g}_{h , v}^{max} / {g}_{h , v}^{min} > {g}_{d 0 , d 1}^{max} / {g}_{d 0 , d 1}^{min}$$

but satisfies

$${g}_{d 0 , d 1}^{max} > {t}_{2} \cdot {g}_{d 0 , d 1}^{min} ,$$

the image decoding apparatus 2000 may determine the value of the directionality D as 4. When the image decoding apparatus 2000 does not satisfy

$${g}_{h , v}^{max} / {g}_{h , v}^{min} > {g}_{d 0 , d 1}^{max} / {g}_{d 0 , d 1}^{min}$$

and does not satisfy

$${g}_{d 0 , d 1}^{max} > {t}_{2} \cdot {g}_{d 0 , d 1}^{min} ,$$

the image decoding apparatus 2000 may determine the value of the directionality D as 3.

In an embodiment, the image decoding apparatus 2000 may determine the value of the activity Â by using the horizontal gradient and the vertical gradient. The activity Â may be a value that represents the activity value A quantized into a range from 0 to 4. The activity value A may be a value determined according to Equation 6 below.

$$A = {\sum }_{k = i - 2}^{i + 3} {\sum }_{l = j - 2}^{j + 3} ( {V}_{k , l} + {H}_{k , l} ) \qquad [ Equation 6 ]$$

In an embodiment, the image decoding apparatus 2000 may determine the class of the current block 2210 by using the determined directionality and activity values. The image decoding apparatus 2000 may perform filtering on the current sample 2215 included in the current block 2210 by using the determined filter. For example, the image decoding apparatus 2000 may determine, as the first filter, one filter included in one of at least one predefined filter set by using the determined class of the current block 2210. Alternatively, the image decoding apparatus 2000 may determine, as the APS filter, one filter included in the APS filter set among at least the APS filter sets by using the determined class of the current block 2210.

In an embodiment, the image decoding apparatus 2000 may perform adaptive loop filtering on the current block 2210 by filtering at least one sample or all samples included in the current block 2210 by using the determined filter. The image decoding apparatus 2000 may perform filtering on the current sample 2215 based on the current sample 2215, the neighboring samples 2230 of the current sample, and the determined filter. The image decoding apparatus 2000 may perform adaptive loop filtering on the current block 2210 by filtering at least one sample or all samples included in the current block 2210 in the same or similar manner as the operation of filtering the current sample 2215.

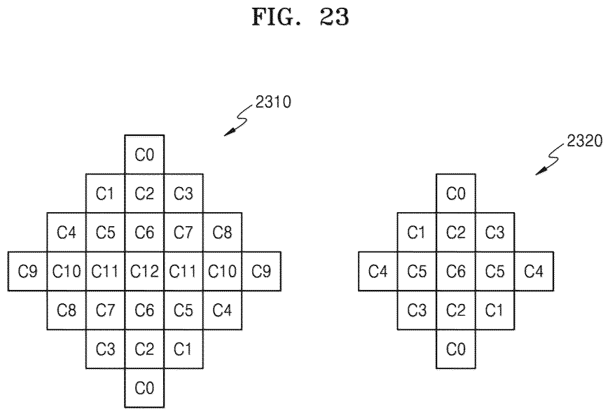

Hereinafter, the operation of performing adaptive loop filtering is described in detail with reference to FIG. 23.

FIG. 23 is a diagram for describing an operation of performing adaptive loop filtering, according to an embodiment.

In an embodiment, the image decoding apparatus 2000 may perform adaptive loop filtering on the current block. The image decoding apparatus 2000 may perform adaptive loop filtering on the current block by performing filtering on all samples included in the current block by using the determined filter. The image decoding apparatus 2000 may perform filtering on the current sample for the current block by using at least one tap.

In an embodiment, the image decoding apparatus 2000 may perform adaptive loop filtering by using a 7×7 filter 2310, which is a 7×7 diamond-shaped, for luma components of the current sample included in the current block and using a 5×5 filter 2320, which is a 5×5 diamond-shaped, for chroma components.

In an embodiment, the image decoding apparatus 2000 may determine one filter set among at least one APS filter set, or may determine one filter set among at least one predefined filter set. The image decoding apparatus 2000 may obtain or determine one of the filters included in the determined filter set as a filter to be used for adaptive loop filtering. Hereinafter, the operation of performing adaptive loop filtering by performing APS filtering on the current block is described in detail with reference to an example.

For example, the image decoding apparatus 2000 may determine one APS filter set based on at least one APS filter set and an APS index. Referring to FIG. 22, the image decoding apparatus 2000 may determine the gradient for the current block 2210 and determine the directionality and activity by using the determined gradient. The image decoding apparatus 2000 may determine the class by using the values of the determined directionality and activity. The image decoding apparatus 2000 may obtain one APS filter included in the determined APS filter set by using the determined class value.

In an embodiment, the image decoding apparatus 2000 may obtain the APS filter by obtaining APS filter coefficients, which are filter coefficients for the APS filter. The APS filter may include a 7×7 filter and a 5×5 filter. The APS filter coefficients may include values C0 to C12 within the 7×7 filter 2310 and values C0 to C12 within the 5×5 filter 2320. The image decoding apparatus 2000 may obtain values C0 to C12 within the 7×7 filter 2310, which are filter coefficients for luma components of the current sample included in the current block. The image decoding apparatus 2000 may obtain values C0 to C6 within the 5×5 filter 2320, which are filter coefficients for chroma components of the current sample.

In an embodiment, the image decoding apparatus 2000 may perform APS filtering on the current block by performing filtering on at least one sample or all samples included in the current block by using the APS filter. The image decoding apparatus 2000 may perform filtering on the current sample by performing filtering on the current sample included in the current block using the APS filter coefficients. In addition, the image decoding apparatus 2000 may perform APS filtering on the current block by performing filtering on the current sample with respect to at least one sample or all samples included in the current block.

In an embodiment, referring to FIG. 22, the image decoding apparatus 2000 may perform filtering by using the current sample 2215 of FIG. 22, the neighboring samples 2230 of the current sample, and the 7×7 filter 2310 of FIG. 23. When the image decoding apparatus 2000 matches the current sample 2215 with the location of C12, which is a filter coefficient positioned in the center of the 7×7 filter 2310, the image decoding apparatus 2000 may perform filtering on the current sample by using the neighboring samples of the current sample corresponding to locations of C0 to C11.

For example, the image decoding apparatus 2000 may match the current sample 2215 of FIG. 22 and a first sample 2231 included in the neighboring samples 2230 of the current sample with the upper filter coefficient C0 among the filter coefficients in the 7×7 filter 2310. The image decoding apparatus 2000 may match the current sample 2215 of FIG. 22 and a second sample 2232 included in the neighboring samples 2230 of the current sample with the upper filter coefficient C1 among the filter coefficients in the 7×7 filter 2310. The image decoding apparatus 2000 may match the current sample 2215 of FIG. 22 and the samples included in the neighboring samples 2230 of the current sample with the filter coefficients within the 7×7 filter 2310 in the same manner as the method of matching the first sample and the second sample with the filter coefficients within the 7×7 filter 2310.

In an embodiment, the image decoding apparatus 2000 may perform APS filtering by using filter coefficients C0 to C11 for the neighboring samples of the current sample corresponding to locations of filter coefficients C0 to C11 when the filter coefficient C12 positioned in the center of the 7×7 filter 2310 is matched with the current sample.

For example, the image decoding apparatus 2000 may perform filtering by applying filter coefficients included in the 7×7 filter 2310 corresponding to the location of each sample to the difference values obtained by subtracting the sample value R(i,j) of the intermediate filtered sample from the sample values R(+k,j+1) of the intermediate filtered sample corresponding to the current sample of FIG. 22 and the neighboring samples 2230 of the intermediate filtered sample. The image decoding apparatus 2000 may perform APS filtering on the current sample according to Equation 7 below.

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad [ Equation 7 ]$$

On the other hand, in the above equation, R(i,j) may represent the intermediate filtered sample corresponding to the current sample, and R′(i,j) may represent the filtered block obtained by performing APS filtering on the intermediate filtered sample. In addition, f(k,l) may represent the filter coefficient, and K(x,y) may be a clipping function that clips a value of x to a value between −y and y. In addition, c(k,l) may represent clipping parameters. k and l may be integers between

$$- \frac{L}{2} and \frac{L}{2} ,$$

and L may represent a filter length. The image decoding apparatus 2000 may obtain the filter coefficients and the clipping parameters from at least one of a bitstream, a slice header, slice data, and an APS. Alternatively, the filter coefficients and the clipping parameters may be values predefined in the memory.

In an embodiment, the image decoding apparatus 2000 may obtain the filtered block by performing an operation on at least one sample or all samples included in the current block according to Equation 7 above.

On the other hand, the present disclosure is not limited to the disclosed examples. The above-described filter may be a filter obtained from a predefined filter set rather than a filter obtained from an APS filter set, and the first filtering using the first filter may be performed by using APS filtering in the same or similar manner as the method of performing APS filtering. In addition, the equation for performing filtering on the current sample is not limited to Equation 7 above. Samples other than the reconstructed sample may be used, and the filter coefficients may include parameters for the other samples as well as parameters for the reconstructed sample. In addition, the image decoding apparatus 2000 may perform adaptive loop filtering, including APS filtering or filtering using the predefined filter set, by using only the filter coefficients, without using the clipping function and the clipping parameters.

On the other hand, for convenience of explanation, the method of performing filtering on the luma components of the current sample included in the current block by using the 7×7 filter 2310 has been described in detail, but adaptive loop filtering for the current block may be performed by performing filtering on other samples included in the current block in the same manner. In addition, filtering may be performed on the chroma components of the current sample by using the 5×5 filter 2320 in the same or similar manner as the method of performing filtering on the luma components of the current sample by using the 7×7 filter 2310. In addition, although the APS filter has been described as an example, the first filter, the second filter, and the third filter of the present disclosure may also perform filtering in the same or similar manner as the method disclosed in FIG. 23.

FIG. 24 is a diagram illustrating a filtering operation performed in an in-loop filter, according to an embodiment.

In an embodiment, an in-loop filtering unit 2400 may perform at least one of deblocking filtering 2410, sample adaptive offset filtering 2420, bilateral filtering 2425, and adaptive loop filtering 2430.

In an embodiment, the deblocking filtering 2410 and the sample adaptive offset filtering 2420 of the in-loop filtering unit 2400 may correspond to the deblocking filtering 2110 and the sample adaptive offset filtering 2120 of FIG. 21, respectively, and thus, the same description thereof is omitted.

In an embodiment, the bilateral filtering 2425 may be filtering that takes into account not only spatial parameters but also intensity parameters of the neighboring samples for the current sample so as to reduce ringing artifacts. The bilateral filtering 2425 may be filtering that is performed in parallel with sample adaptive offset filtering after deblocking filtering, or may be filtering that is performed before or after sample adaptive offset filtering.

In an embodiment, the image decoding apparatus 2000 may perform the bilateral filtering 2425 on the current sample by assigning a larger weight to a sample that is adjacent to the current sample and has a smaller difference in spatial parameters among the neighboring samples of the current sample and/or a sample that has a smaller difference in intensity parameters from the current sample among the neighboring samples.

In an embodiment, the image decoding apparatus 2000 may obtain the intermediate filtered block including the intermediate filtered sample corresponding to the current sample by performing at least one of deblocking filtering, sample adaptive offset filtering, and bilateral filtering on the reconstructed block of the current block.

In an embodiment, the image decoding apparatus 2000 may obtain information about adaptive loop filtering. The image decoding apparatus 2000 may obtain information 2440 about whether to use the APS filter set included in the information about adaptive loop filtering. The image decoding apparatus 2000 may obtain a filter set index included in the information about adaptive loop filtering.

In an embodiment, the image decoding apparatus 2000 may perform the adaptive loop filtering 2430 on the current block based on the information 2440 about whether to use the APS filter set.

In an embodiment, the image decoding apparatus 2000 may perform filtering 2450 using the predefined filter set when the image decoding apparatus 2000 determines not to use the APS filter set, based on the information 2440 about whether to use the APS filter set. The image decoding apparatus 2000 may perform the adaptive loop filtering 2430 by performing the filtering 2450 using the predefined filter set.

In an embodiment, the operation of performing the filtering 2450 using the predefined filter set may include an operation of performing first filtering 2454 on the current block or an operation of performing a second filtering 2458 on the current block.

In an embodiment, when the image decoding apparatus 2000 performs the filtering 2450 using the predefined filter set, the image decoding apparatus 2000 may obtain a filter set index from a bitstream, a slice header, slice data, or an APS. The filter set index of FIG. 24 may be an index that performs the same or similar role as the filter set index of FIG. 21, or may be an index that performs a different role from the filter set index of FIG. 21. The image decoding apparatus 2000 may obtain the filter set index in block units of one of a CTU, a CU, a prediction block, and a transform block.

In an embodiment, the image decoding apparatus 2000 may perform the filtering 2450 using the predefined filter set for the current block by using at least one filter, based on at least one predefined filter set and the filter set index. For example, at least one filter may include the first filter or the second filter. The filtering 2450 using the predefined filter set may include at least one of first filtering, second filtering, and third filtering.

In an embodiment, the image decoding apparatus 2000 may store at least one predefined filter set in the memory. Each of the predefined filter sets may include information about filters respectively corresponding to a plurality of classes. For example, the number of predefined filters may be 512. The number of predefined filter sets may be two. In addition, each of the filter sets may include information about filters respectively corresponding to 7,168 classes. Each of the predefined filter sets may have the same or different sizes of the extension blocks used to determine the classes.

On the other hand, the number of predefined filters and the number of predefined filter sets are not limited to the disclosed examples.

In an embodiment, the image decoding apparatus 2000 may obtain the first filter by inputting an intermediate filtered block to a first classifier 2452. On the other hand, obtaining or determining the filters may be obtaining or determining filter coefficients. For example, obtaining the first filter may be obtaining at least one first filter coefficient. Obtaining the second filter may be obtaining at least one second filter coefficient. Obtaining the third filter may be obtaining at least one third filter coefficient. Obtaining the APS filter may be obtaining at least one APS filter coefficient.

In an embodiment, the first classifier 2452 may receive the intermediate filtered block and determine the class of the current block. The first classifier 2452 may output a determined filter by using the determined class and a first predefined filter set. The image decoding apparatus 2000 may obtain the filter coefficients for the first filter from the first classifier 2452. The first classifier 2452 may be a Laplacian classifier that determines the class based on directionality and activity.

In an embodiment, the image decoding apparatus 2000 may determine the class by using the Laplacian classifier according to Equation 8 below.

$${C}_{i} = {\hat{A}}_{i} * {M}_{D , i} + {D}_{i} \qquad [ Equation 8 ]$$

On the other hand, in the above equation, M_{D,i} may represent the number of directionality values. In addition, Cᵢ, Âᵢ, and Dᵢ may correspond to C, Â₀, and D₀ in Equation 1 above, respectively, and the descriptions thereof are redundant with those provided above and thus omitted herein. On the other hand, i may be a value representing a classifier. For example, when i=0, it may represent a value for the first classifier 2452. For example, in the first classifier 2452, the class C₀ may be determined based on the activities Â₀ and D₀.

In an embodiment, the image decoding apparatus 2000 may determine a ratio

$${r}_{h , v}^{i}$$

between the maximum value and the minimum value of the horizontal or vertical gradients and a ratio

$${r}_{d 1 , d 2}^{i}$$

between the maximum value and the minimum value of the diagonal gradient as follows according to the following equation.

$${r}_{h , v}^{i} = {g}_{h , v}^{max} / {g}_{h , v}^{min}$$

$${r}_{d 1 , d 2}^{i} = {g}_{d 0 , d 1}^{max} / {g}_{d 0 , d 1}^{min}$$

In an embodiment, the image decoding apparatus 2000 may determine directionality by using a threshold value list. The image decoding apparatus 2000 may calculate horizontal and vertical edge intensity

$${E}_{HV}^{i}$$

and diagonal edge intensity

$${E}_{D}^{i} .$$

The image decoding apparatus 2000 may determine directionality by comparing the horizontal and vertical edge intensity

$${E}_{HV}^{i}$$

and the diagonal edge intensity

$${E}_{D}^{i}$$

with elements included in the threshold value list.

For example, the image decoding apparatus 2000 may use the threshold value list Th=[1.25, 1.5, 2, 3, 4.5, 8] The threshold value list Th=[1.25, 1.5, 2, 3, 4.5, 8] may be a threshold list for the first classifier 2452. When

$${r}_{h , v}^{i} \leq Th [ 0 ]$$

is satisfied, the image decoding apparatus 2000 may determine the horizontal and vertical edge intensity

$${r}_{h , v}^{i} > Th [ 0 ] ,$$

as 0. In addition, when

$${E}_{HV}^{i}$$

the image decoding apparatus 2000 may determine the maximum integer satisfying

$${r}_{h , v}^{i} > Th [ {E}_{HV}^{i} - 1 ]$$

as the horizontal and vertical edge intensity

$${E}_{HV}^{i} .$$

### When

$${r}_{d 1 , d 2}^{i} \leq Th [ 0 ]$$

is satisfied, the image decoding apparatus 2000 may determine the diagonal edge intensity

$${E}_{D}^{i}$$

as 0. In addition, when

$${r}_{d 1 , d 2}^{i} > Th [ 0 ] ,$$

the image decoding apparatus 2000 may determine the maximum integer satisfying

$${r}_{d 1 , d 2}^{i} > Th [ {E}_{D}^{i} - 1 ]$$

as the diagonal edge intensity

$${E}_{D}^{i} .$$

On the other hand, the threshold value list may be identical or different depending on whether it is horizontal and vertical edge intensity or diagonal edge intensity, and is not limited to the disclosed examples.

In an embodiment, after determining the horizontal and vertical edge intensity

$${E}_{HV}^{i}$$

and the diagonal edge intensity

$${E}_{D}^{i} ,$$

the image decoding apparatus 2000 may determine the directionality according to Table 1 when

$${r}_{h , v}^{i} > {r}_{d 1 , d 2}^{i} .$$

### When not

$${r}_{h , v}^{i} > {r}_{d 1 , d 2}^{i} ,$$

the image decoding apparatus 2000 may determine the directionality according to Table 2.

TABLE 1

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

In an embodiment, the image decoding apparatus 2000 may determine the value of the activity Â by using the horizontal gradient and the vertical gradient. The activity Â may be a value that represents the activity value A quantized into a range from 0 to n. The activity value A may be a value determined according to Equation 9 below. On the other hand, the quantization parameter n used to determine the activity Â₀ determined by the first classifier 2452 may be 15.

$$A = \sum \sum ( {V}_{k , l} + {H}_{k . l} ) \qquad [ Equation 9 ]$$

In an embodiment, the image decoding apparatus 2000 may determine the class by using the Laplacian classifier according to Equation 10 below.

$${C}_{i}^{′} = {C}^{′} * 896 + {C}_{i} \qquad [ Equation 10 ]$$

In an embodiment, the image decoding apparatus 2000 may update the class of the first filter by using the class based on Equation 8 above according to Equation 10.

In an embodiment, the image decoding apparatus 2000 may calculate a mean value of sample values included in the extension block of the current block. The image decoding apparatus 2000 may calculate the difference between the sample value and the mean value for each sample included in the current block. The image decoding apparatus 2000 may determine a scaling factor based on the activity derived in the process of calculating the class according to Equation 8 above.

In an embodiment, the image decoding apparatus 2000 may obtain C′ by quantizing, as the scaling factor, the square root of the sum of the squares of the differences between the sample values and the mean value for each sample value included in the current block. For example, the value of C′ may be an integer between 0 and 7.

In an embodiment, the image decoding apparatus 2000 may perform the first filtering 2454 on the current block by using the reconstructed block, the intermediate filtered block for the current block, and the first filter. The image decoding apparatus 2000 may obtain the first filtered block including the first filtered sample corresponding to the current sample by performing the first filtering 2454 by using the reconstructed block, the intermediate filtered block, and the first filter.

In an embodiment, the image decoding apparatus 2000 may obtain the first filtered sample by performing filtering by using at least one sample among the reconstructed sample corresponding to the shape of the tap for the first filtering and the neighboring samples of the reconstructed sample, the intermediate filtered sample, and the first filter.

For example, when the reconstructed sample matches the location of the filter coefficient positioned in the center of the tap for the first filtering, the image decoding apparatus 2000 may perform filtering on the current sample by using the reconstructed sample and the neighboring samples of the reconstructed sample corresponding to the locations of the remaining filter coefficients. The image decoding apparatus 2000 may perform the first filtering 2454 on the current block by performing filtering on at least one sample or all samples included in the current block in the same or similar manner as the filtering on the current sample.

For example, the image decoding apparatus 2000 may perform filtering by applying the first filter to the difference between the values of the reconstructed sample corresponding to the current sample included in the reconstructed block and the neighboring samples of the reconstructed sample and the value of the intermediate filtered sample corresponding to the current sample included in the intermediate filtered block, and thus, obtain the first filtered sample. In addition, the image decoding apparatus 2000 may obtain the neighboring samples of the first filtered sample by performing filtering on the neighboring samples of the reconstructed sample in the same manner as the method of obtaining the first filtered sample. In addition, the image decoding apparatus 2000 may perform the first filtering 2454 on the current block by performing filtering on at least one sample included in the current block in the same or similar manner as the filtering on the current sample.

On the other hand, the neighboring samples of the first filtered sample may be samples positioned around the first filtered sample corresponding to the current sample, and may be samples on which filtering by the first filter has been performed.

Hereinafter, the first filtering, the second filtering, the third filtering, and the APS filtering of the present disclosure may be performed in the same or similar manner as the filtering using the first filter.

In an embodiment, the image decoding apparatus 2000 may obtain the second filter by inputting an intermediate filtered block to a second classifier 2456. The second classifier 2456 may receive an intermediate filtered block and determine the class of the current block. The second classifier 2456 may output a determined filter by using the determined class and a second predefined filter set. The image decoding apparatus 2000 may obtain the filter coefficients for the second filter from the second classifier 2456. The second classifier 2456 may be a Laplacian classifier that determines the class based on directionality and activity.

On the other hand, the second classifier 2456 of FIG. 24 may perform a different role from the second classifier 2170 of FIG. 21, or may perform an identical or similar role to the second classifier 2170 of FIG. 21.

On the other hand, the size of the extension block considered for determining the class in the first classifier 2452 may be different from the size of the extension block considered for determining the class in the second classifier 2456. For example, when the size of the current block is 2×2, the size of the extension block in the first classifier 2452 may be 4×4, and the size of the extension block in the second classifier 2456 may be 12×12. However, the size of the current block, the size of the extension block in the first classifier 2452, and the size of the extension block in the second classifier 2456 are not limited to the disclosed examples.

In an embodiment, the image decoding apparatus 2000 may determine the class in the second classifier 2456 in the same or similar manner as the method of determining the class in the first classifier 2452. For example, the image decoding apparatus 2000 may determine the class in the second classifier 2456 according to Equation 8 or 10 above. However, when the size of the extension block considered for determining the class in the first classifier 2452 is different from the size of the extension block considered for determining the class in the second classifier 2456, the number of samples used for determining directionality or activity may be different. However, the image decoding apparatus 2000 may determine the directionality D₁ in the second classifier 2456 by using Table 1 or Table 2 used in the first classifier 2452. In addition, the quantization parameter n used to determine the activity Â₁ determined by the second classifier 2456 may be 15.

In an embodiment, the image decoding apparatus 2000 may obtain a second filtered sample corresponding to the current sample by performing second filtering 2458 by using the reconstructed block, the first filtered block, and the second filter. The image decoding apparatus 2000 may obtain the second filtered block including the second filtered sample corresponding to the current sample by performing the second filtering 2458 by using the reconstructed block, the first filtered block, and the second filter.

In an embodiment, the image decoding apparatus 2000 may obtain the second filtered sample by performing filtering on the current sample by using at least one sample among the first filtered sample corresponding to the shape of the tap for the second filtering and the neighboring samples of the first filtered sample, the intermediate filtered sample, and the second filter.

For example, when the first filtered sample matches the location of the filter coefficient positioned in the center of the tap for the second filtering, the image decoding apparatus 2000 may perform filtering on the current sample by using the first filtered sample and the neighboring samples of the first filtered sample corresponding to the locations of the remaining filter coefficients. The image decoding apparatus 2000 may perform the second filtering 2458 on the current block by performing filtering on at least one sample or all samples included in the current block in the same or similar manner as the filtering on the current sample.

On the other hand, the image decoding apparatus 2000 may obtain the neighboring samples of the second filtered sample by performing filtering on the neighboring samples of the first filtered sample in the same manner as the method of obtaining the second filtered sample.

On the other hand, the operation of obtaining the second filtered sample may be identical to or similar to the operation of obtaining the first filtered sample.

On the other hand, embodiments of the present disclosure are not limited to the disclosed examples. When the tap for the filtering includes only one filter coefficient, the filtering may be performed by using only the current sample (or a certain sample corresponding to the current sample) and one filter coefficient. In addition, when the tap for the second filtering includes a plurality of filter coefficients, the second filtering 2458 may be performed in the same or similar manner as the first filtering 2454.

On the other hand, in the present disclosure, even when a case where a plurality of filter coefficients are included is described below, the filtering may be performed by using one filter coefficient and one sample corresponding to the current sample when the tap includes only one filter coefficient.

For example, when a second filter tap includes only one filter coefficient, the image decoding apparatus 2000 may perform second filtering by applying one filter coefficient included in the second filter tap to the difference between the first filtered sample and the reconstructed sample, and thus, obtain the second filtered sample. On the other hand, in some cases, the filter or tap of the present disclosure, as well as the second filter, may include only one filter coefficient, and the same description thereof is omitted.

In an embodiment, the image decoding apparatus 2000 may obtain the first filtered block or the second filtered block as the filtered block based on the filter set index. For example, when the image decoding apparatus 2000 obtains, from the bitstream, the filter set index for the current block which has a value of 0, the image decoding apparatus 2000 may obtain the first filtered block as the filtered block. When the image decoding apparatus 2000 obtains, from the bitstream, the filter set index for the current block which has a value of 1, the image decoding apparatus 2000 may obtain the second filtered block as the filtered block.

In an embodiment, the image decoding apparatus 2000 may perform APS filtering 2490 using the APS filter set when the image decoding apparatus 2000 determines to use the APS filter set, based on the information 2440 about whether to use the APS filter set. The image decoding apparatus 2000 may perform the adaptive loop filtering 2430 by performing the APS filtering 2490.

In an embodiment, the image decoding apparatus 2000 may obtain information about adaptive loop filtering from a bitstream, a slice header, slice data, or an APS. The information about adaptive loop filtering may include at least one of information about whether to obtain the current APS filter set, the number of filters included in each current APS filter set, at least one APS filter included in the current APS filter set, and an APS index.

On the other hand, the APS index of FIG. 24 may be an index that performs the same or similar role as the APS index of FIG. 21.

In an embodiment, the image decoding apparatus 2000 may perform the APS filtering 2490 on the current block by using the APS filter obtained based on at least one APS filter set and the APS index.

In an embodiment, the image decoding apparatus 2000 may obtain at least one current APS filter set or at least one previous APS filter set based on the information about adaptive loop filtering obtained from the slice header, the slice data, or the APS.

In an embodiment, the image decoding apparatus 2000 may obtain information about the current APS filter set or obtain index information indicating a slice or a block to be referenced so as to obtain the previous APS filter set. For example, the current APS filter set may have up to four filters, the previous APS filter set may have up to eight filters, and each of the APS filter sets may include up to 25 filters. Each of the APS filter sets may include information about filters respectively corresponding to 25 classes. In addition, each of the APS filter sets may include filter coefficients for filters included in each of the APS filter sets. Each of the APS filter sets may include classifier information indicating which type of classifier to use to determine the class.

On the other hand, the maximum number of current APS filter sets, the maximum number of previous APS filter sets, and the maximum number of filters included in each filter set are not limited to the disclosed examples.

In an embodiment, the third classifier 2460 may be determined as one of a plurality of classifiers. The image decoding apparatus 2000 may determine one of the plurality of classifiers as the third classifier 2460 based on the classifier information included in each APS filter set. For example, the image decoding apparatus 2000 may determine, as the third classifier 2460, one of a Laplacian classifier that determines the class determined according to directionality and activity based on the classifier information included in each APS filter set, a band-based classifier that determines the class based on the sum of sample values included in an intermediate filtered block for the current block, and a residual-based classifier that determines the class based on the sum of sample values included in a residual block for the current block.

In an embodiment, the band-based classifier may determine the class by using Equation 11 below. On the other hand, the sum in Equation 11 below may represent the sum of the sample values included in the intermediate filtered block.

$$class\_index ( {sum}^{*} 25 ) ≫ ( sample bit depth + 2 ) \qquad [ Equation 11 ]$$

In an embodiment, the residual-based classifier may determine the class by using Equation 12 below. On the other hand, “sum” in Equation 12 may represent the sum of absolute values of the extended residual block including the residual block corresponding to the current block.

$$classIdx = sum ≫ ( sample bit depth - 4 ) \qquad [ Equation 12 ]$$

In an embodiment, the image decoding apparatus 2000 may determine at least one of the Laplacian classifier, the band-based classifier, and the residual-based classifier as the third classifier 2460, based on at least one APS filter set and the APS index. For example, the image decoding apparatus 2000 may determine, as the third classifier 2460, the classifier corresponding to the APS filter set indicated by the APS index, based on the classifier information included in the APS filter set indicated by the APS index.

In an embodiment, the image decoding apparatus 2000 may obtain the APS filter by inputting the APS filter set indicated by the APS index to the third classifier 2460. The image decoding apparatus 2000 may determine the class by using the determined third classifier 2460. In addition, the third classifier 2460 may determine the APS filter based on the APS filter set indicated by the APS index and the determined class. The image decoding apparatus 2000 may obtain the APS filter by inputting the intermediate filtered block or the residual block to the third classifier 2460. For example, when the image decoding apparatus 2000 uses the Laplacian classifier or the band-based classifier as the third classifier 2460, the image decoding apparatus 2000 may receive the intermediate filtered block and determine the class of the current block. When the image decoding apparatus 2000 uses the residual-based classifier as the third classifier 2460, the image decoding apparatus 2000 may receive the residual block and determine the class of the current block.

In an embodiment, when the image decoding apparatus 2000 uses the Laplacian classifier as the third classifier, the image decoding apparatus 2000 may determine the class of the current block in the same or similar manner as the method of determining the class in the first classifier 2452 or the second classifier 2456. For example, the image decoding apparatus 2000 may determine the class in the third classifier according to Equation 1 or 8 above. However, when the size of the extension block considered for determining the class in the first classifier 2452 is different from the size of the extension block considered for determining the class in the third classifier, the number of samples used for determining directionality or activity may be different.

For example, the image decoding apparatus 2000 may determine the class according to Equation 1 above. In addition, the directionality D₂ and the activity Â₂ may be determined according to the operation of determining the directionality and the activity disclosed in FIG. 22. The image decoding apparatus 2000 may determine the class of the current block by using the determined directionality D₂ and activity Â₂.

In an embodiment, when the image decoding apparatus 2000 uses the band-based classifier as the third classifier, the image decoding apparatus 2000 may determine the class by using the sample values included in the intermediate filtered block for the current block. For example, when the size of the current block is 2×2, the image decoding apparatus 2000 may determine or obtain the class of the current block based on the sample values of the samples included in the intermediate filtered block with a size of 2×2 obtained by performing at least one of deblocking filtering, sample adaptive offset filtering, and bilateral filtering on the reconstructed block for the current block.

In an embodiment, when the image decoding apparatus 2000 uses the residual-based classifier as the third classifier, the image decoding apparatus 2000 may determine the class by using the sample values included in the residual block for the current block. For example, when the size of the current block is 2×2, the image decoding apparatus 2000 may determine or obtain the class of the current block based on the sample values of the samples included in the residual block with a size of 2×2 for the current block.

In an embodiment, the image decoding apparatus 2000 may perform the adaptive loop filtering 2430 by performing the APS filtering 2490 on the current block by using the APS filter. The image decoding apparatus 2000 may perform filtering using the APS filter on the current sample included in the current block. In addition, the image decoding apparatus 2000 may perform the APS filtering 2490 on the current block by performing filtering on at least one sample or all samples included in the current block in the same or similar manner as the filtering using the APS filter on the current sample.

In an embodiment, the image decoding apparatus 2000 may perform the APS filtering 2490 by using the intermediate filtered block, the first filtered block, the second filtered block, the third filtered block, the reconstructed block, the residual block, the first filtered residual block, and the APS filter. The image decoding apparatus 2000 may obtain, as the filtered block, the APS filtered block obtained by performing the APS filtering 2490.

In an embodiment, the image decoding apparatus 2000 may obtain filter coefficients for the third filter, which is the predefined filter, so as to perform the APS filtering 2490. The filter coefficients for the third filter may be information prestored in the memory. The image decoding apparatus 2000 may obtain a third filtered block by performing third filtering 2470 by using the reconstructed block and the third filter.

In an embodiment, the image decoding apparatus 2000 may use the result of the filtering 2450 using the predefined filter set so as to perform the APS filtering 2490. For example, the image decoding apparatus 2000 may use the first filtered block and the second filtered block to perform the APS filtering 2490.

In an embodiment, the image decoding apparatus 2000 may further use the first filter, which is used in the filtering 2450 using the predefined filter set, to perform the APS filtering 2490. For example, the image decoding apparatus 2000 may obtain the first filtered residual block by performing the first filtering 2480 by using the residual block and the first filter. For example, the first filter may be a filter that determines the class through the first classifier 2452 and is determined by using the determined class and the predefined filter set.

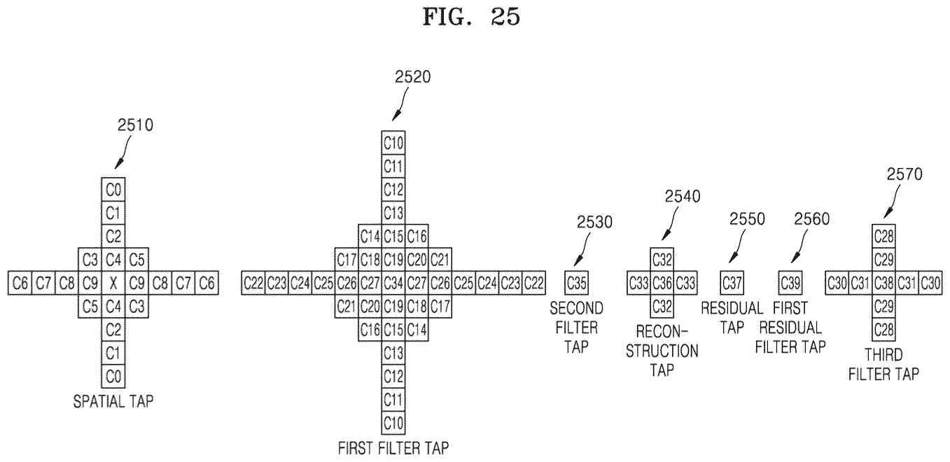

On the other hand, the APS filtering 2490 may be performed on the current block by performing the filtering using the APS filter on at least one sample or all samples included in the current block in the same or similar manner as the method of performing the filtering using the APS filter on the current sample included in the current block. On the other hand, the operation of performing the filtering using the APS filter on the current sample is described in detail with reference to FIG. 25.

In an embodiment, the image decoding method may use, for the APS filtering 2490, the first filtered block or the second filtered block obtained through the filtering 2450 using the predefined filter set. Because the operation of obtaining the first filtered block and the second filtered block has been described in detail above, the same description thereof is omitted.

In an embodiment, the image decoding apparatus 2000 may obtain a third filtered block including a third filtered sample corresponding to the current sample by performing third filtering by using a reconstructed block, an intermediate filtered block, and a third filter. For example, the image decoding apparatus 2000 may obtain the third filtered sample by performing filtering by using at least one sample among the reconstructed sample corresponding to the shape of the tap for the third filtering and the neighboring samples of the reconstructed sample, the intermediate filtered sample, and the third filter.

In addition, the image decoding apparatus 2000 may obtain the neighboring samples of the third filtered sample by performing filtering on the neighboring samples of the reconstructed sample in the same manner as the method of obtaining the third filtered sample.

On the other hand, because the operation of obtaining the third filtered sample may be identical to or similar to the operation of obtaining the first filtered sample or the second filtered sample, the same description there is omitted.

In an embodiment, the image decoding apparatus 2000 may obtain the first filtered residual block by performing the first filtering 2480 by using the residual block for the current block and the first filter. The image decoding apparatus 2000 may obtain the first filtered residual block including the first filtered residual sample corresponding to the current sample. The image decoding apparatus 2000 may obtain the first filtered residual sample corresponding to the current sample by filtering the current sample by using the first filter and at least one sample among the residual sample corresponding to the tap for the first filtering and the neighboring samples of the residual sample.

For example, when the residual sample matches the location of the filter coefficient positioned in the center of the tap for the first filtering, the image decoding apparatus 2000 may perform filtering on the current sample by using the residual sample and the neighboring samples of the residual sample corresponding to the locations of the remaining filter coefficients. The image decoding apparatus 2000 may perform the first filtering 2480 on the current block by performing filtering on at least one sample or all samples included in the current block in the same or similar manner as the filtering on the current sample.

For example, the image decoding apparatus 2000 may perform filtering by applying the first filter to each of the values of the residual sample and the neighboring samples of the residual sample, and thus, obtain the first filtered residual sample.

The image decoding apparatus 2000 may obtain the first filtered residual block by performing filtering on at least one block or all blocks included in the residual block in the same or similar manner as the method of obtaining the first filtered residual sample. In addition, the image decoding apparatus 2000 may obtain the neighboring samples of the first filtered residual sample by performing filtering on the neighboring samples of the residual sample in the same manner as the method of obtaining the first filtered residual sample.

On the other hand, the first filtering 2480 may be filtering using a filter that is identical to or similar to the first filter used in the first filtering 2454 included in the filtering 2450 using the predefined filter set. For example, the first filtering 2480 may be filtering that uses all or some of the filter coefficients used in the first filtering 2454.

In an embodiment, the image decoding apparatus 2000 may obtain an adaptive loop filtering sample by using at least one adaptive filter coefficient (APS filter coefficient) obtained from information about adaptive loop filtering for an intermediate filtered sample, a first filtered sample, a second filtered sample, a third filtered sample, a reconstructed sample, and a residual sample.

In an embodiment, the image decoding apparatus 2000 may perform adaptive loop filtering on the current block by using at least one sample among the intermediate filtered sample and the neighboring samples of the intermediate filtered sample, at least one sample among the first filtered sample and the neighboring samples of the first filtered sample, at least one sample among the second filtered sample and the neighboring samples of the second filtered sample, at least one sample among the third filtered sample and the neighboring samples of the third filtered sample, at least one sample among the reconstructed sample corresponding to the current sample included in the reconstructed block and the neighboring samples of the reconstructed sample, and at least one sample among the residual sample corresponding to a current sample included in the residual block and the neighboring samples of the residual sample.

For example, the image decoding apparatus 2000 may obtain the adaptive loop filtered sample by performing pixel-wise filtering by applying an adaptive filter coefficient to at least one sample among the intermediate filtered sample and the neighboring samples of the intermediate filtered sample, at least one sample among the first filtered sample and the neighboring samples of the first filtered sample, at least one sample among the second filtered sample and the neighboring samples of the second filtered sample, at least one sample among the third filtered sample and the neighboring samples of the third filtered sample, at least one sample among the reconstructed sample and the neighboring samples of the reconstructed sample, and at least one sample among the residual sample and the neighboring samples of the residual sample. The image decoding apparatus 2000 may perform the adaptive loop filtering by performing the APS filtering 2490 on the current block. In addition, the image decoding apparatus 2000 may obtain, as the adaptive loop filtered block, the APS filtered block obtained by performing the APS filtering 2490.

In an embodiment, the image decoding apparatus 2000 may perform the adaptive loop filtering on the current block by using at least one sample among the first filtered residual sample and the neighboring samples of the first filtered residual sample. The image decoding apparatus 2000 may obtain, from the bitstream, whether to use at least one sample among the first filtered residual sample and the neighboring samples of the first filtered residual sample. The image decoding apparatus 2000 may obtain whether to use at least one sample among the first filtered residual sample and the neighboring samples of the first filtered residual sample from at least one of a slice header, slice data, and an APS.

In addition, whether to use at least one sample among the first filtered residual sample and the neighboring samples of the first filtered residual sample may be determined by the number of filter coefficients and parameters associated with the filter coefficients.

Hereinafter, the shape of the tap for APS filtering is described in detail with reference to FIG. 25.

FIG. 25 is a diagram for describing an operation of performing filtering on a current sample, according to an embodiment.

In an embodiment, the image decoding apparatus 2000 may perform filtering on the current sample by using at least one of a spatial tap 2510, a first filter tap 2520, a second filter tap 2530, a reconstruction tap 2540, a residual tap 2550, a first residual filter tap 2560, and a third filter tap 2570. In addition, the image decoding apparatus 2000 may perform APS filtering on the current block by performing filtering on at least one sample or all samples included in the current block in the same or similar manner as the method of performing filtering on the current sample.

In an embodiment, the operation in which the image decoding apparatus 2000 performs APS filtering on the current block may include an operation of performing filtering on the current sample by using at least one of the spatial tap 2510, the first filter tap 2520, the second filter tap 2530, the reconstruction tap 2540, the residual tap 2550, the first residual filter tap 2560, and the third filter tap 2570 according to Equation 13 above.

$$\tilde{R} ( x , y ) = R ( x , y ) + [ {\sum }_{i = 0}^{9} {c}_{i} ( {f}_{i , 0} + {f}_{i , 1} ) ] + [ {\sum }_{i = 10}^{27} {c}_{i} ( {g}_{i , 0} + {g}_{i , 1} ) ] + [ {\sum }_{i = 32}^{33} {c}_{i} ( {h}_{i , 0} + {h}_{i , 1} ) ] + [ {\sum }_{i = 34}^{35} {c}_{i} {g}_{i} ] + [ {\sum }_{i = 36}^{36} {c}_{i} {h}_{i} ] + [ {\sum }_{i = 37}^{37} {c}_{i} {r}_{i} ] + [ {\sum }_{i = 39}^{39} {c}_{i} {rFilterd}_{i} ] + [ {\sum }_{i = 28}^{31} {c}_{i} ( {k}_{i , 0} + {k}_{i , 1} ) ] + [ {\sum }_{i = 38}^{38} {c}_{i} {k}_{i} ] \qquad [ Equation 13 ]$$

In an embodiment, R(x,y) may represent the intermediate filtered sample corresponding to the current sample. R(x,y) may represent the filtered sample. Cᵢ may represent the filter coefficients.

In an embodiment, the image decoding apparatus 2000 may perform APS filtering by using the intermediate filtered blocks and the spatial tap 2510. For example, when the intermediate filtered sample matches the central location of a spatial tap 2510, the image decoding apparatus 2000 may perform filtering by using the spatial tap 2510 and at least one sample among the neighboring samples of the intermediate filtered sample corresponding to the locations of APS filter coefficients C0 to C9 included in the spatial tap 2510.

For example, the image decoding apparatus 2000 may perform filtering by multiplying the respective APS filter coefficients by the difference value of the intermediate filtered sample and the neighboring samples of the intermediate filtered sample corresponding to the locations of the APS filter coefficients C0 to C9 included in the spatial tap 2510. The operation of performing filtering by using the APS filter coefficients C0 to C9 included in the spatial tap 2510 and the neighboring samples of the intermediate filtered sample may be described by the following equation. In the following equation, f_{i,j} may represent the difference value between the intermediate filtered sample R(x,y) and each value of the neighboring samples of the intermediate filtered sample, or a value obtained by clipping the difference value based on a clipping parameter.

$${\sum }_{i = 0}^{9} {c}_{i} ( {f}_{i , 0} + {f}_{i , 1} )$$

In an embodiment, the image decoding apparatus 2000 may perform APS filtering by using the first filtered block and the first filter tap 2520. For example, when the image decoding apparatus 2000 matches the first filtered sample with the filter coefficient C34 positioned in the center of the first filter tap 2520, the image decoding apparatus 2000 may perform filtering by using the first filter tap 2520 and at least one sample among the first filtered sample and the neighboring samples of the first filtered sample corresponding to the locations of the APS filter coefficients C10 to C27 included in the first filter tap 2520.

For example, the image decoding apparatus 2000 may perform filtering by multiplying the respective APS filter coefficients by the difference value of the intermediate filtered sample and the neighboring samples of the first filtered sample corresponding to the locations of the APS filter coefficients C10 to C27 included in the first filter tap 2520. The operation of performing filtering by using the APS filter coefficients C10 to C27 included in the first filter tap 2520 and the neighboring samples of the first filtered sample may be described by the following equation. In the following equation, g_{i,j} may represent a difference value obtained by subtracting the value of the intermediate filtered sample from the value of each of the neighboring samples of the first filtered sample, or a value obtained by clipping the difference value based on a clipping parameter.

$${\sum }_{i = 10}^{27} {c}_{i} ( {g}_{i , 0} + {g}_{i , 1} )$$

In an embodiment, the image decoding apparatus 2000 may perform filtering by multiplying the APS filter coefficient C34 by the difference value of the intermediate filtered sample and the first filtered sample corresponding to the location of the APS filter coefficient C34 included in the first filter tap 2520.

In an embodiment, the image decoding apparatus 2000 may perform APS filtering by using the second filtered blocks and the second filter tap 2530. For example, the image decoding apparatus 2000 may perform filtering by using the second filtered sample and the APS filter coefficient C35 included in the second filter tap 2530. For example, the image decoding apparatus 2000 may perform filtering by multiplying the APS filter coefficient C35 by the difference value between the second filtered sample and the intermediate filtered sample.

In an embodiment, the operation of performing filtering by using the first filtered sample and the APS filter coefficient C34 included in the first filter tap 2520 and the operation of performing filtering by using the second filtered sample and the APS filter coefficient C35 included in the second filter tap 2530 may be described by the following equation. In the following equation, gᵢ may represent the difference value obtained by subtracting the value of the intermediate filtered sample from the value of the first filtered sample or the difference value obtained by subtracting the value of the intermediate filtered sample from the value of the second filtered sample. Alternatively, gᵢ may represent the value obtained by clipping the difference values based on the clipping parameter.

$${\sum }_{i = 34}^{35} {c}_{i} {g}_{i}$$

In an embodiment, the image decoding apparatus 2000 may perform APS filtering by using the reconstructed blocks and the reconstruction tap 2540. The image decoding apparatus 2000 may perform APS filtering that includes the operation of performing filtering by using the reconstructed sample and the reconstruction tap 2540. For example, when the image decoding apparatus 2000 matches the reconstructed sample with the filter coefficient C36 positioned in the center of the reconstruction tap 2540, the image decoding apparatus 2000 may perform filtering by using the reconstruction tap 2540 and at least one sample among the reconstructed sample and the neighboring samples of the reconstructed sample corresponding to the locations of the APS filter coefficients C32 to C33 included in the reconstruction tap 2540.

For example, the image decoding apparatus 2000 may perform filtering by multiplying the respective APS filter coefficients by the difference value of the intermediate filtered sample and the neighboring samples of the reconstructed sample corresponding to the locations of the APS filter coefficients C32 and C33 included in the reconstruction tap 2540. The operation of performing filtering by using the APS filter coefficients C32 and C33 included in the reconstruction tap 2540 and the neighboring samples of the reconstructed sample may be described by the following equation. In the following equation, h_{i,j} may represent a difference value obtained by subtracting the value of the intermediate filtered sample from the value of each of the neighboring samples of the reconstructed sample, or a value obtained by clipping the difference value based on a clipping parameter.

$${\sum }_{i = 32}^{33} {c}_{i} ( {h}_{i , 0} + {h}_{i , 1} )$$

In an embodiment, the image decoding apparatus 2000 may perform filtering by multiplying the APS filter coefficient C36 by the difference value of the intermediate filtered sample and the reconstructed sample corresponding to the location of the APS filter coefficient C36 included in the reconstruction tap 2540. The operation of performing filtering by using the reconstructed sample and the APS filter coefficient C36 included in the reconstruction tap 2540 may be described by the following equation. In the following equation, ft may represent a difference value obtained by subtracting the value of the intermediate filtered sample from the value of the reconstructed sample, or a value obtained by clipping the difference value based on a clipping parameter.

$${\sum }_{i = 36}^{36} {c}_{i} {h}_{i}$$

In an embodiment, the image decoding apparatus 2000 may perform APS filtering by using the residual block and the residual tap 2550. For example, the image decoding apparatus 2000 may perform filtering by using the residual sample and the APS filter coefficient C37 included in the residual tap 2550. For example, the image decoding apparatus 2000 may perform filtering by multiplying the residual sample by the APS filter coefficient C37 included in the residual tap 2550. The operation of performing filtering by using the residual sample and the APS filter coefficient C37 included in the residual tap 2550 may be described by the following equation. In the following equation, rᵢ may represent the value of the residual sample or the value obtained by clipping the value of the residual sample based on the clipping parameter.

$${\sum }_{i = 37}^{37} {c}_{i} {r}_{i}$$

In an embodiment, the image decoding apparatus 2000 may perform APS filtering by using the first filtered residual block and the first residual filter tap 2560. For example, the image decoding apparatus 2000 may perform filtering by using the first filtered residual sample and the APS filter coefficient C39 included in the first residual filter tap 2560. For example, the image decoding apparatus 2000 may perform filtering by multiplying the first filtered residual sample by the APS filter coefficient C39 included in the first residual filter tap 2560. The operation of performing filtering by using the first filtered residual sample and the APS filter coefficient C39 included in the first residual filter tap 2560 may be described by the following equation. In the following equation, rFilterdᵢ may represent the value of the first filtered residual sample or the value obtained by clipping the value of the first filtered residual sample.

$${\sum }_{i = 39}^{39} {c}_{i} {rFilterd}_{i}$$

In an embodiment, the image decoding apparatus 2000 may perform APS filtering by using the third filtered block and the third filter tap 2570. For example, when the image decoding apparatus 2000 matches the third filtered sample with the filter coefficient C38 positioned in the center of the third filter tap 2570, the image decoding apparatus 2000 may perform filtering by using the third filter tap 2570 and at least one sample among the third filtered sample and the neighboring samples of the third filtered sample corresponding to the locations of the APS filter coefficients C28 to C31 included in the third filter tap 2570.

For example, the image decoding apparatus 2000 may perform filtering by multiplying the respective APS filter coefficients by the difference value of the intermediate filtered sample and the neighboring samples of the third filtered sample corresponding to the locations of the APS filter coefficients C28 to C31 included in the third filter tap 2570. The operation of performing filtering by using the APS filter coefficients C28 to C31 included in the third filter tap 2570 and the neighboring samples of the third filtered sample may be described by the following equation. In the following equation, k_{i,j} may represent a difference value obtained by subtracting the value of the intermediate filtered sample from the value of each of the neighboring samples of the third filtered sample, or a value obtained by clipping the difference value based on a clipping parameter.

$${\sum }_{i = 28}^{31} {c}_{i} ( {k}_{i , 0} + {k}_{i , 1} )$$

In an embodiment, the image decoding apparatus 2000 may perform filtering by multiplying the APS filter coefficient C38 by the difference value of the intermediate filtered sample and the third filtered sample corresponding to the location of the APS filter coefficient C38 included in the third filter tap 2570.

In an embodiment, the operation of performing filtering by using the third filtered sample and the APS filter coefficient C38 included in the third filter tap 2570 may be described by the following equation. In the following equation, Kᵢ may represent a difference value obtained by subtracting the value of the intermediate filtered sample from the value of the third filtered sample, or a value obtained by clipping the difference value based on a clipping parameter.

$${\sum }_{i = 38}^{38} {c}_{i} {k}_{i}$$

On the other hand, the spatial tap 2510, the first filter tap 2520, the second filter tap 2530, the reconstruction tap 2540, the residual tap 2550, the first residual filter tap 2560, and the third filter tap 2570 disclosed in FIG. 25 are not limited to the disclosed examples, and the image decoding apparatus 2000 may perform APS filtering by using the respective taps and all or some of the samples corresponding to the respective taps and the neighboring samples thereof. In addition, the image decoding apparatus 2000 may perform APS filtering on the current block by using other samples not disclosed in FIG. 25.

On the other hand, in the present disclosure, for the convenience of explanation, the clipping operation based on the clipping parameters is omitted.

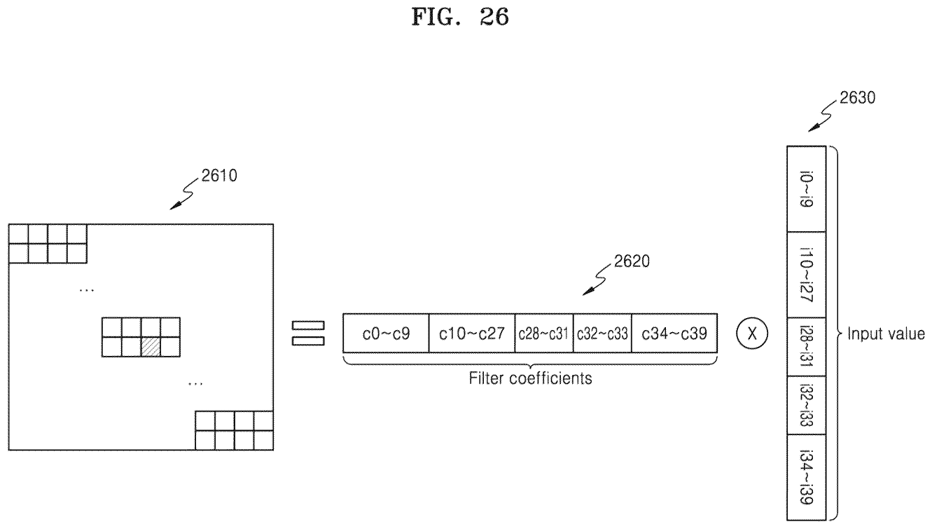

FIG. 26 is a diagram for describing an operation of performing filtering on a current sample, according to an embodiment.

In an embodiment, the image decoding apparatus 2000 may perform adaptive loop filtering on a current block. The operation in which the image decoding apparatus 2000 performs adaptive loop filtering on the current block may include an operation of performing APS filtering on the current block. In addition, the operation in which the image decoding apparatus 2000 performs APS filtering on the current block may include an operation of performing filtering on the current sample.

In an embodiment, the image decoding apparatus 2000 may obtain a filtered block by performing APS filtering on the current block. The image decoding apparatus 2000 may obtain the filtered block by performing filtering on each of at least one sample or all samples included in the current block. The image decoding apparatus 2000 may obtain the filtered block including the filtered sample corresponding to the current sample by performing APS filtering on the current block including the current sample.

In an embodiment, the image decoding apparatus 2000 may obtain the filtered sample by adding values obtained by multiplying at least one APS filter coefficient 2620 by at least one input value 2630 correspond to each of the at least one APS filter coefficient 2620 with respect to the intermediate filtered sample.

In an embodiment, referring to FIG. 25, the image decoding apparatus 2000 may obtain, as input values of i0 to i9, a difference value obtained by subtracting the sample value of the intermediate filtered sample from the sample value of each of the neighboring samples of the intermediate filtered sample corresponding to the locations of APS filter coefficients C0 to C9 included in the spatial tap 2510.

In an embodiment, the image decoding apparatus 2000 may obtain, as input values of i10 to i27, a difference value obtained by subtracting the sample value of the intermediate filtered sample from the sample value of each of the neighboring samples of the first filtered sample corresponding to the locations of APS filter coefficients C10 to C27 included in the first filter tap 2520.

In an embodiment, the image decoding apparatus 2000 may obtain, as input values of i28 to i31, a difference value obtained by subtracting the sample value of the intermediate filtered sample from the sample value of each of the neighboring samples of the third filtered sample corresponding to the locations of APS filter coefficients C28 to C31 included in the third filter tap 2570.

In an embodiment, the image decoding apparatus 2000 may obtain, as input values of i32 and i33, a difference value obtained by subtracting the sample value of the intermediate filtered sample from the sample value of each of the neighboring samples of the reconstructed sample corresponding to the locations of APS filter coefficients C32 and C33 included in the reconstruction tap 2540.

In an embodiment, the image decoding apparatus 2000 may obtain a difference value between the first filtered sample and the intermediate filtered sample as an input value of i34. The image decoding apparatus 2000 may obtain a difference value between the second filtered sample and the intermediate filtered sample as an input value of i35. The image decoding apparatus 2000 may obtain a difference value between the reconstructed sample and the intermediate filtered sample as an input value of i36. The image decoding apparatus 2000 may obtain the sample value of the residual sample as an input value of i37. The image decoding apparatus 2000 may obtain a difference value between the third filtered sample and the intermediate filtered sample as an input value of i38. The image decoding apparatus 2000 may obtain the sample value of the first filtered residual sample as an input value of i37.

In an embodiment, the image decoding apparatus 2000 may obtain the filtered sample by adding the inner product values of the APS filter coefficients C0 to C39 and the input values i0 to i39 with respect to the intermediate filtered sample.

On the other hand, embodiments of the present disclosure are not limited to the disclosed examples, and the image decoding apparatus 2000 may perform filtering on the current sample by using APS filter coefficients having structures different from the structures of the APS filter coefficients of the present disclosure, or by using input values having structures different from the structures of the input values of the present disclosure.

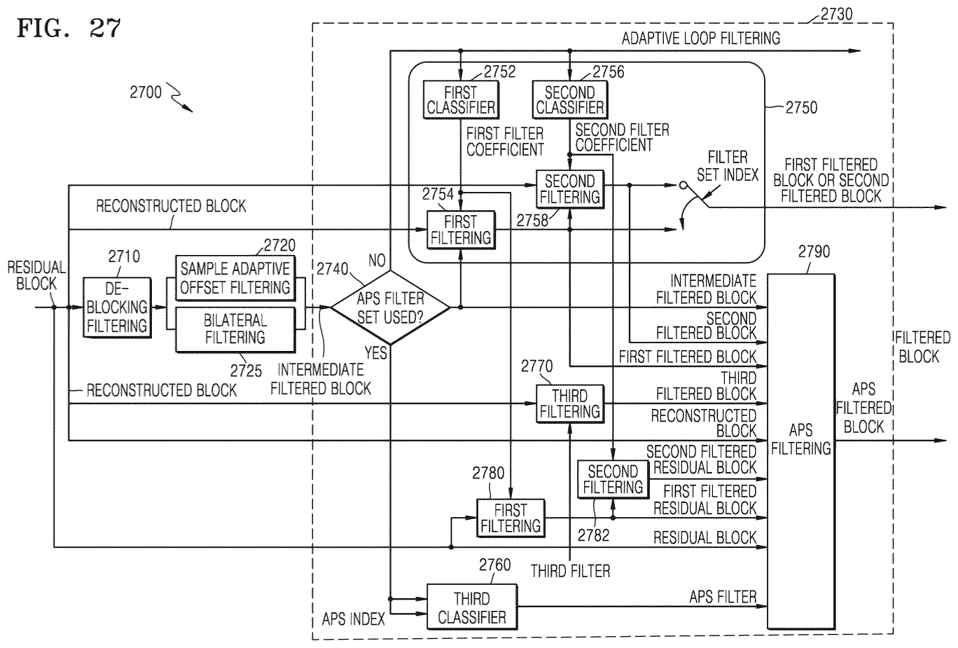

FIG. 27 is a diagram illustrating adaptive loop filtering performed in an in-loop filtering unit, according to an embodiment.

In an embodiment, an in-loop filtering unit 2700 may perform at least one of deblocking filtering 2710, sample adaptive offset filtering 2720, bilateral filtering 2725, and adaptive loop filtering 2730.

In an embodiment, the deblocking filtering 2710, the sample adaptive offset filtering 2720, and the bilateral filtering 2725 in the in-loop filtering unit 2700 of FIG. 27 may correspond to the deblocking filtering 2410, the sample adaptive offset filtering 2420, and the bilateral filtering 2425 of FIG. 24, respectively, and thus, the same description thereof is omitted.

In an embodiment, information 2740 about whether to use an APS filter set, filtering 2750 using a predefined filter set, a first classifier 2752, first filtering 2754, a second classifier 2756, second filtering 2758, a third classifier 2760, third filtering 2770, first filtering 2780, and APS filtering 2790 in FIG. 27 may correspond to the information 2440 about whether to use the APS filter set, the filtering 2450 using the predefined filter set, the first classifier 2452, the first filtering 2454, the second classifier 2456, the second filtering 2458, the third classifier 2460, the third filtering 2470, the first filtering 2480, and the APS filtering 2490 in FIG. 24, respectively, and thus, the same description thereof is omitted.

In an embodiment, the image decoding apparatus 2000 may obtain a first filtered residual block by performing the first filtering 2780 by using a residual block for the current block and a first filter. The image decoding apparatus 2000 may obtain a first filtered residual sample corresponding to the current sample by performing filtering by using the residual sample for the current sample and the first filter. The image decoding apparatus 2000 may obtain the first filtered residual block including the first filtered residual sample corresponding to the current sample by performing filtering on the residual block by using the first filter.

In addition, the image decoding apparatus 2000 may obtain the first filtered residual block based on performing filtering on at least one sample or all samples included in the residual block in the same or similar manner as the method of obtaining the first filtered residual sample.

In an embodiment, the image decoding apparatus 2000 may obtain the first filtered residual sample by performing filtering by using the residual sample and the first filter. The image decoding apparatus 2000 may obtain the first filtered residual sample by performing filtering by using the residual sample and filter coefficients predefined for the first filter.

In an embodiment, the image decoding apparatus 2000 may obtain the first filtered residual sample by performing filtering by using the first filter and at least one sample among the residual sample corresponding to the filter coefficient predefined for the first filtering 2780 on the residual block or the residual sample and the neighboring samples of the residual sample. On the other hand, the filter coefficient predefined for the first filtering 2780 may be used as the first filter.

For example, the image decoding apparatus 2000 may obtain the first filtered residual sample by adding values obtained by applying the filter coefficients corresponding to the respective samples and predefined for the first filter with respect to at least one sample among the residual sample and the neighboring samples of the residual sample.

On the other hand, the first filtering 2780 may be filtering using a filter that is identical to or similar to the first filter used in the first filtering 2754 included in the filtering 2750 using the predefined filter set. For example, the first filtering 2780 may be filtering that uses all or some of the filter coefficients used in the first filtering 2754.

In an embodiment, the image decoding apparatus 2000 may obtain a second filtered residual block by performing the second filtering 2790 by using a first filtered residual block for the current block and a second filter. The image decoding apparatus 2000 may obtain a second filtered residual sample corresponding to the current sample by performing filtering by using the first filtered residual sample for the current sample and the second filter. The image decoding apparatus 2000 may obtain a second filtered residual block including a second filtered residual sample corresponding to the current sample by performing filtering by using the first filtered residual sample and the second filter.

In addition, the image decoding apparatus 2000 may obtain the second filtered residual block based on performing filtering by using at least one sample or all samples included in the first filtered residual block in the same or similar manner as the method of obtaining the second filtered residual sample.

In an embodiment, the image decoding apparatus 2000 may obtain the second filtered residual sample by performing filtering by using the first filtered residual sample corresponding to the filter coefficient predefined for the second filtering 2790 on the first filtered residual block or residual sample and the filter coefficient predefined for the second filter. On the other hand, the filter coefficient predefined for the second filtering 2790 may be used as the second filter.

For example, the image decoding apparatus 2000 may obtain the second filtered residual sample by applying the filter coefficient predefined for the second filter to the first filtered residual sample.

On the other hand, the second filtering 2782 may be filtering using a filter that is identical to or similar to the second filter used in the second filtering 2758 included in the filtering 2750 using the predefined filter set. For example, the second filtering 2782 may be filtering that uses all or some of the filter coefficients used in the second filtering 2758.

In an embodiment, the image decoding apparatus 2000 may perform the adaptive loop filtering 2730 by performing the APS filtering 2790. The image decoding apparatus 2000 may perform APS filtering on the current block by using the first filtered residual sample and the second filtered residual sample. The image decoding apparatus 2000 may obtain an adaptive loop filtered sample by performing the APS filtering 2790. The image decoding apparatus 2000 may obtain, as the adaptive loop filtered sample for the current sample, the APS filtered sample obtained by performing the APS filtering 2790.

For example, the image decoding apparatus 2000 may perform the APS filtering 2790 by using an APS filter obtained based on the first filtered residual sample, at least one sample among the second filtered residual sample and the neighboring samples of the second filtered residual sample, and information about adaptive loop filtering.

In an embodiment, the image decoding apparatus 2000 may obtain the APS filter set based on the information about adaptive loop filtering. In addition, the image decoding apparatus 2000 may obtain the APS filter based on index information indicating at least one APS filter included in the APS filter set. The image decoding apparatus 2000 is an APS filter and may obtain at least one adaptive filter coefficient. On the other hand, as described above, the APS filter set and the APS filter may be referred to as an adaptive filter set and an adaptive filter.

In an embodiment, the image decoding apparatus 2000 may obtain the adaptive loop filtered sample by using at least one adaptive filter coefficient obtained from the first filtered residual sample, the second filtered residual sample, and the information about adaptive loop filtering. On the other hand, the at least one adaptive filter coefficient may include a filter coefficient for the first filtered residual sample and/or a filter coefficient for the second filtered residual sample.

In an embodiment, the image decoding apparatus 2000 may apply, to the first filtered residual sample, the filter coefficient for the first filtered residual sample obtained based on the information about adaptive loop filtering. The image decoding apparatus 2000 may apply, to the second filtered residual sample, the filter coefficient for the first filtered residual sample obtained based on the information about adaptive loop filtering. The image decoding apparatus 2000 may obtain the adaptive loop filtered sample by using a value obtained by applying the filter coefficient for the first filtered residual sample to the first filtered residual sample and a value obtained by applying the filter coefficient for the second filtered residual sample to the second filtered residual sample.

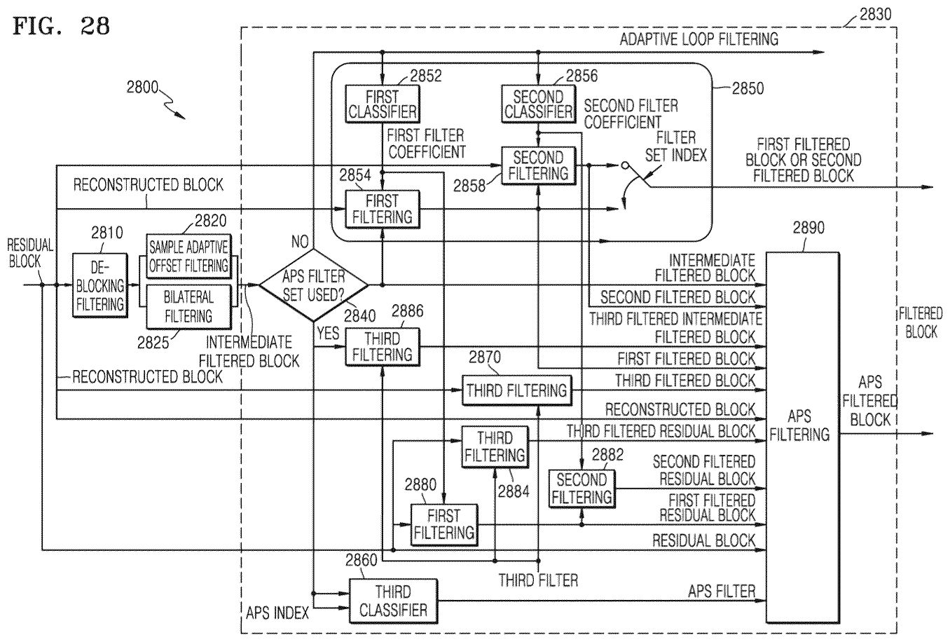

In an embodiment, to obtain the adaptive loop filtered sample, the adaptive loop filtered sample may be obtained by using methods disclosed in FIGS. 28 to 30.

In an embodiment, the effect of subjective or objective image quality improvement may be achieved through the in-loop filtering of FIG. 27.

FIG. 28 is a diagram illustrating adaptive loop filtering performed in an in-loop filtering unit, according to an embodiment.

In an embodiment, an in-loop filtering unit 2800 may perform at least one of deblocking filtering 2810, sample adaptive offset filtering 2820, bilateral filtering 2825, and adaptive loop filtering 2830.

In an embodiment, the deblocking filtering 2810, the sample adaptive offset filtering 2820, and the bilateral filtering 2825 in the in-loop filtering unit 2800 of FIG. 28 may correspond to the deblocking filtering 2410, the sample adaptive offset filtering 2420, and the bilateral filtering 2425 of FIG. 24, respectively, and thus, the same description thereof is omitted.

In an embodiment, information 2840 about whether to use an APS filter set, filtering 2850 using a predefined filter set, a first classifier 2852, first filtering 2854, a second classifier 2856, second filtering 2858, a third classifier 2860, third filtering 2870, first filtering 2880, and APS filtering 2890 in FIG. 28 may correspond to the information 2440 about whether to use the APS filter set, the filtering 2450 using the predefined filter set, the first classifier 2452, the first filtering 2454, the second classifier 2456, the second filtering 2458, the third classifier 2460, the third filtering 2470, the first filtering 2480, and the APS filtering 2490 in FIG. 24, respectively, and thus, the same description thereof is omitted.

In an embodiment, the first filtering 2880 and the second filtering 2882 of FIG. 28 may correspond to the first filtering 2780 and the second filtering 2782 of FIG. 27, respectively, and thus, the same description thereof is omitted.

In an embodiment, the image decoding apparatus 2000 may obtain a third filtered residual block by performing the third filtering 2884 by using a residual block for a current block and a third filter. The image decoding apparatus 2000 may obtain a third filtered residual sample corresponding to the current sample by performing filtering by using the residual sample for the current sample and the third filter. The image decoding apparatus 2000 may obtain the third filtered residual block including the third filtered residual sample corresponding to the current sample by performing filtering on the residual block by using the third filter.

In addition, the image decoding apparatus 2000 may obtain the third filtered residual block based on performing filtering by using at least one sample or all samples included in the residual block in the same or similar manner as the method of obtaining the third filtered residual sample.

In an embodiment, the image decoding apparatus 2000 may obtain the third filtered residual sample by performing filtering by using the residual sample and the third filter. The image decoding apparatus 2000 may obtain the third filtered residual sample by performing filtering by using the residual sample and filter coefficients predefined for the third filter.

In an embodiment, the image decoding apparatus 2000 may obtain the third filtered residual sample by performing filtering by using the third filter and at least one sample among the residual sample corresponding to the filter coefficient predefined for the third filtering 2884 on the residual block or the residual sample and the neighboring samples of the residual sample. On the other hand, the filter coefficient predefined for the third filtering 2884 may be used as the third filter.

For example, the image decoding apparatus 2000 may obtain the third filtered residual sample by adding values obtained by applying the filter coefficients corresponding to the respective samples and predefined for the third filter with respect to at least one sample among the residual sample and the neighboring samples of the residual sample.

In an embodiment, the image decoding apparatus 2000 may obtain a third filtered intermediate filtered block by performing the third filtering 2886 by using an intermediate filtered block for the current block and the third filter. The image decoding apparatus 2000 may obtain the third filtered intermediate filtered sample corresponding to the current sample by performing filtering by using the intermediate filtered sample for the current sample and the third filter. The image decoding apparatus 2000 may obtain the third filtered residual block including the third filtered intermediate filtered sample corresponding to the current sample by performing filtering on the intermediate filtered block by using the third filter.

In addition, the image decoding apparatus 2000 may obtain the third filtered intermediate filtered block based on performing filtering by using at least one sample or all samples included in the intermediate filtered block in the same or similar manner as the method of obtaining the third filtered intermediate filtered sample.

In an embodiment, the image decoding apparatus 2000 may obtain the third filtered intermediate filtered sample by performing filtering by using the intermediate filtered sample and the third filter. The image decoding apparatus 2000 may obtain the third filtered residual sample by performing filtering by using the intermediate filtered sample and filter coefficients predefined for the third filter.

In an embodiment, the image decoding apparatus 2000 may obtain the third filtered intermediate filtered sample by performing filtering by using the third filter and the intermediate filter corresponding to the filter coefficient predefined for the third filtering 2886 on the intermediate filtered block or the intermediate filtered sample.

For example, the image decoding apparatus 2000 may obtain the third filtered intermediate filtered sample by using a value obtained by applying the filter coefficient predefined for the third filter to the intermediate filtered sample.

On the other hand, the third filtering 2884 for the residual block and the third filtering 2886 for the intermediate filtered block may be filtering using a filter that is identical to or similar to the third filter, which is the predefined filter used in the third filtering 2870 for the reconstructed block. For example, the third filtering 2884 or the third filtering 2886 may be filtering that uses all or some of the filter coefficients used in the third filtering 2870.

In an embodiment, the image decoding apparatus 2000 may perform the adaptive loop filtering 2830 by performing the APS filtering 2890. The image decoding apparatus 2000 may perform APS filtering by using the third filtered residual sample. The image decoding apparatus 2000 may obtain an adaptive loop filtered sample by performing the APS filtering 2890. The image decoding apparatus 2000 may obtain, as the adaptive loop filtered sample for the current sample, the APS filtered sample obtained by performing the APS filtering 2890.

For example, the image decoding apparatus 2000 may perform the APS filtering 2890 by using an APS filter obtained based on the third filtered residual sample and information about adaptive loop filtering.

In an embodiment, the image decoding apparatus 2000 may obtain the adaptive loop filtered sample by using at least one adaptive filter coefficient obtained from the third filtered residual sample and the information about adaptive loop filtering. On the other hand, the at least one adaptive filter coefficient may include a filter coefficient for the third filtered residual sample.

In an embodiment, the image decoding apparatus 2000 may apply, to the third filtered residual sample, the filter coefficient for the third filtered residual sample obtained based on the information about adaptive loop filtering. The image decoding apparatus 2000 may obtain the adaptive loop filtered sample by using a value obtained by applying the filter coefficient for the third filtered residual sample to the third filtered residual sample. In an embodiment, the image decoding apparatus 2000 may perform the adaptive loop filtering 2830 by performing the APS filtering 2890. The image decoding apparatus 2000 may perform APS filtering by using the third filtered intermediate filtered sample.

For example, the image decoding apparatus 2000 may perform the APS filtering 2890 by using an APS filter obtained based on the third filtered intermediate filtered sample and information about adaptive loop filtering.

In an embodiment, the image decoding apparatus 2000 may obtain the adaptive loop filtered sample by using at least one adaptive filter coefficient obtained from the third filtered intermediate filtered sample and the information about adaptive loop filtering. On the other hand, the at least one adaptive filter coefficient may include a filter coefficient for the third filtered intermediate filtered sample.

In an embodiment, the image decoding apparatus 2000 may apply, to the third filtered intermediate filtered sample, the filter coefficient for the third filtered intermediate filtered sample obtained based on the information about adaptive loop filtering. The image decoding apparatus 2000 may obtain the adaptive loop filtered sample by using a value obtained by applying the filter coefficient for the third filtered intermediate filtered sample to the third filtered intermediate filtered sample.

In an embodiment, the effect of subjective or objective image quality improvement may be achieved through the in-loop filtering of FIG. 28.

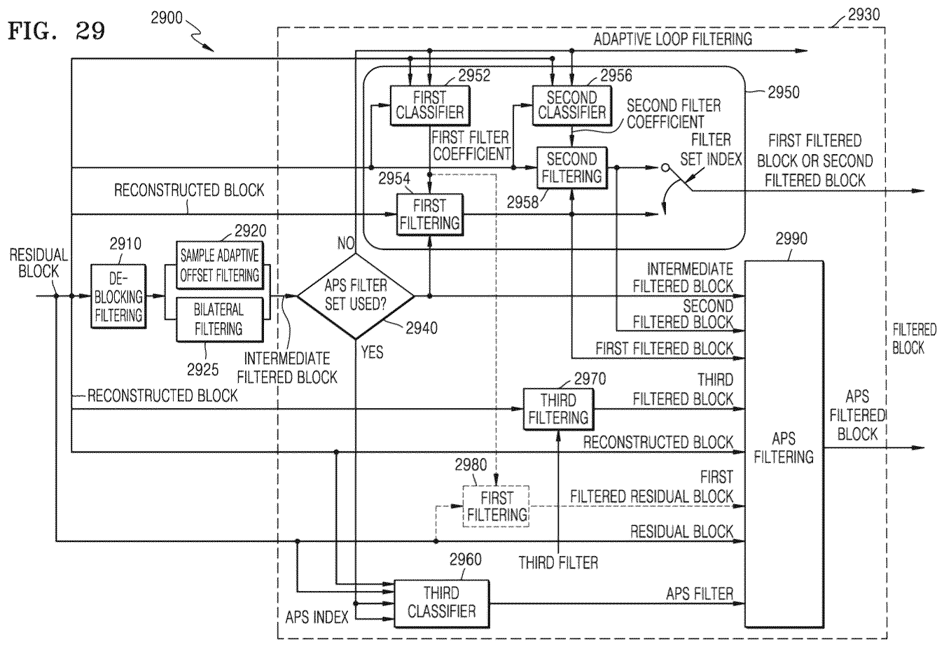

FIG. 29 is a diagram illustrating adaptive loop filtering performed in an in-loop filtering unit, according to an embodiment.

In an embodiment, an in-loop filtering unit 2900 may perform at least one of deblocking filtering 2910, sample adaptive offset filtering 2920, bilateral filtering 2925, and adaptive loop filtering 2930.

In an embodiment, the deblocking filtering 2910, the sample adaptive offset filtering 2920, and the bilateral filtering 2925 in the in-loop filtering unit 2900 of FIG. 29 may correspond to the deblocking filtering 2410, the sample adaptive offset filtering 2420, and the bilateral filtering 2425 of FIG. 24, respectively, and thus, the same description thereof is omitted.

In an embodiment, information 2940 about whether to use an APS filter set, filtering 2950 using a predefined filter set, a first classifier 2952, first filtering 2954, a second classifier 2956, second filtering 2958, a third classifier 2960, third filtering 2970, first filtering 2980, and APS filtering 2990 in FIG. 29 may correspond to the information 2440 about whether to use the APS filter set, the filtering 2450 using the predefined filter set, the first classifier 2452, the first filtering 2454, the second classifier 2456, the second filtering 2458, the third classifier 2460, the third filtering 2470, the first filtering 2480, and the APS filtering 2490 in FIG. 24, respectively, and thus, the same description thereof is omitted.

In an embodiment, the image decoding apparatus 2000 may obtain a first filter by inputting at least one of a reconstructed block, an intermediate filtered block, and a residual block to the first classifier 2952. The first filter used for the first filtering 2954 may be determined based on at least one of the reconstructed block, the intermediate filtered block, and the residual block. On the other hand, the image decoding apparatus 2000 may obtain an intermediate filtered block by performing filtering on the reconstructed block by using at least one of a deblocking filter, a sample adaptive offset filter, and a bilateral filter.

In an embodiment, the first classifier 2952 may receive at least one of the reconstructed block, the intermediate filtered block, and the residual block and determine a class of the current block. For example, the first classifier 2952 may determine directionality and activity based on the reconstructed block or may determine directionality and activity based on the residual block, so as to determine the class of the current block. Alternatively, the first classifier 2952 may use sample values included in the reconstructed block or sample values included in the residual block as parameters for determining the class of the current block.

In an embodiment, the image decoding apparatus 2000 may obtain a second filter by inputting at least one of the reconstructed block, the intermediate filtered block, and the residual block to the second classifier 2956. The second filter used for the second filtering 2958 may be determined based on at least one of the reconstructed block, the intermediate filtered block, and the residual block.

In an embodiment, the second classifier 2956 may receive at least one of the reconstructed block, the intermediate filtered block, and the residual block and determine the class of the current block. For example, the second classifier 2956 may determine directionality and activity based on the reconstructed block or may determine directionality and activity based on the residual block, so as to determine the class of the current block. Alternatively, the second classifier 2956 may use sample values included in the reconstructed block or sample values included in the residual block as parameters for determining the class of the current block.

In an embodiment, the image decoding apparatus 2000 may obtain at least one APS filter set and an APS index. Each of the APS filter sets may include classifier information indicating which type of classifier to use to determine the class. For example, the image decoding apparatus 2000 may use one of a Laplacian classifier, a band-based classifier, and a residual-based classifier as a third classifier, according to classifier information included in the APS filter set indicated by the APS index.

In an embodiment, the image decoding apparatus 2000 may obtain the APS filter by inputting at least one of the reconstructed block, the intermediate filtered block, and the residual block to the third classifier 2960. The APS filter (adaptive filter) used for the APS filtering 2990 may be determined based on at least one of the reconstructed block, the intermediate filtered block, and the residual block.

In an embodiment, the image decoding apparatus 2000 may perform the adaptive loop filtering 2930 by performing the APS filtering 2990. The image decoding apparatus 2000 may perform filtering by using the APS filter determined based on at least one of the reconstructed block, the intermediate filtered block, and the residual block. The image decoding apparatus 2000 may perform filtering by using the APS filter. The image decoding apparatus 2000 may obtain the adaptive loop filtered sample by using an adaptive filter determined based on a differential block.

In an embodiment, the third classifier 2960 may receive at least one of the reconstructed block, the intermediate filtered block, and the residual block and determine the class of the current block. For example, when a Laplacian classifier is used as the third classifier 2960, the image decoding apparatus 2000 may determine directionality and activity based on the reconstructed block or determine directionality and activity based on the residual block, so as to determine the class of the current block. In the image decoding apparatus 2000, the third classifier 2960 may use sample values included in the reconstructed block or sample values included in the residual block as parameters for determining the class of the current block.

In an embodiment, the effect of subjective or objective image quality improvement may be achieved through the in-loop filtering of FIG. 29.

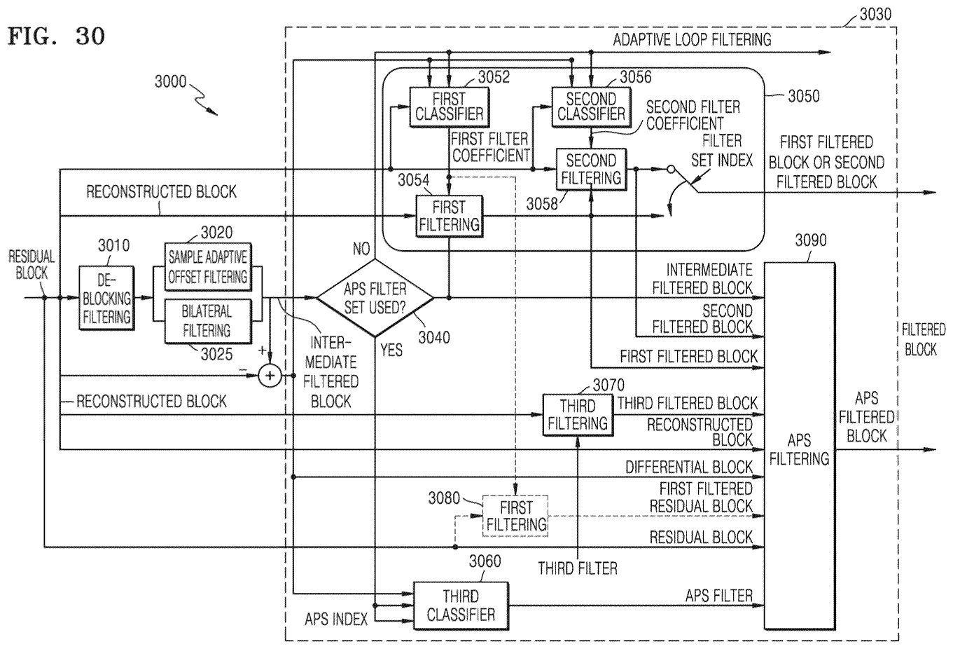

FIG. 30 is a diagram illustrating adaptive loop filtering performed in an in-loop filtering unit, according to an embodiment.

In an embodiment, an in-loop filtering unit 3000 may perform at least one of deblocking filtering 3010, sample adaptive offset filtering 3020, bilateral filtering 3025, and adaptive loop filtering 3030.

In an embodiment, the deblocking filtering 3010, the sample adaptive offset filtering 3020, and the bilateral filtering 3025 in the in-loop filtering unit 3000 of FIG. 30 may correspond to the deblocking filtering 2410, the sample adaptive offset filtering 2420, and the bilateral filtering 2425 of FIG. 24, respectively, and thus, the same description thereof is omitted.

In an embodiment, information 3040 about whether to use an APS filter set, filtering 3050 using a predefined filter set, a first classifier 3052, first filtering 3054, a second classifier 3056, second filtering 3058, a third classifier 3060, third filtering 3070, first filtering 3080, and APS filtering 3090 in FIG. 30 may correspond to the information 2440 about whether to use the APS filter set, the filtering 2450 using the predefined filter set, the first classifier 2452, the first filtering 2454, the second classifier 2456, the second filtering 2458, the third classifier 2460, the third filtering 2470, the first filtering 2480, and the APS filtering 2490 in FIG. 24, respectively, and thus, the same description thereof is omitted.

In an embodiment, the image decoding apparatus 2000 may perform APS filtering based on a differential block representing a difference between a residual block and an intermediate filtered block. In an embodiment, the image decoding apparatus 2000 may obtain a first filter by inputting the differential block to the first classifier 3052. The first filter used for the first filtering 3054 may be determined based on the differential block.

In an embodiment, the first classifier 3052 may receive the differential block and determine a class of a current block. For example, the first classifier 3052 may determine directionality and activity based on the differential block so as to determine the class of the current block. Alternatively, the first classifier 3052 may use sample values included in the differential block as parameters for determining the class of the current block.

In an embodiment, the image decoding apparatus 2000 may obtain a second filter by inputting the differential block to the second classifier 3056. The second filter used for the second filtering 3058 may be determined based on the differential block.

In an embodiment, the second classifier 3056 may receive the differential block and determine the class of the current block. For example, the second classifier 3056 may determine directionality and activity based on the differential block so as to determine the class of the current block. Alternatively, the second classifier 3056 may use sample values included in the differential block as parameters for determining the class of the current block.

In an embodiment, the image decoding apparatus 2000 may obtain an APS filter by inputting the differential block to the third classifier 3060. The APS filter used for the APS filtering 3090 may be determined based on the differential block.

In an embodiment, the image decoding apparatus 2000 may perform filtering by using the APS filter determined based on the differential block. The image decoding apparatus 2000 may perform the adaptive loop filtering by performing the APS filtering 2490 by using the APS filter.

In an embodiment, the third classifier 3060 may receive the differential block and determine the class of the current block. For example, when a Laplacian classifier is used as the third classifier 3060, the image decoding apparatus 2000 may determine directionality and activity based on the differential block so as to determine the class of the current block. In the image decoding apparatus 2000, the third classifier 3060 may use sample values included in the differential block as parameters for determining the class of the current block.

In an embodiment, the image decoding apparatus 2000 may perform the adaptive loop filtering 3030 by performing the APS filtering 3090. The image decoding apparatus 2000 may perform the APS filtering 3090 on the current block by using the differential block including a differential sample corresponding to the current sample.

In an embodiment, the image decoding apparatus 2000 may perform the APS filtering 3090 by using the differential sample and the APS filter. The image decoding apparatus 2000 may perform the APS filtering 3090 by applying the APS filter to the differential sample and neighboring samples of the differential sample. In addition, the image decoding apparatus 2000 may obtain, as a filtered block for the current block, the APS filtered block obtained by performing the APS filtering 3090.

In an embodiment, the image decoding apparatus 2000 may obtain the adaptive loop filtered sample by using at least one adaptive filter coefficient obtained from the differential sample and the information about adaptive loop filtering. On the other hand, the at least one adaptive filter coefficient may include a filter coefficient for the differential sample.

In an embodiment, the image decoding apparatus 2000 may apply, to the differential sample, the filter coefficient for the differential sample obtained based on the information about adaptive loop filtering. The image decoding apparatus 2000 may obtain the adaptive loop filtered sample by using a value obtained by applying the filter coefficient for the differential sample to the differential sample.

In an embodiment, the effect of subjective or objective image quality improvement may be achieved through the in-loop filtering of FIG. 30.

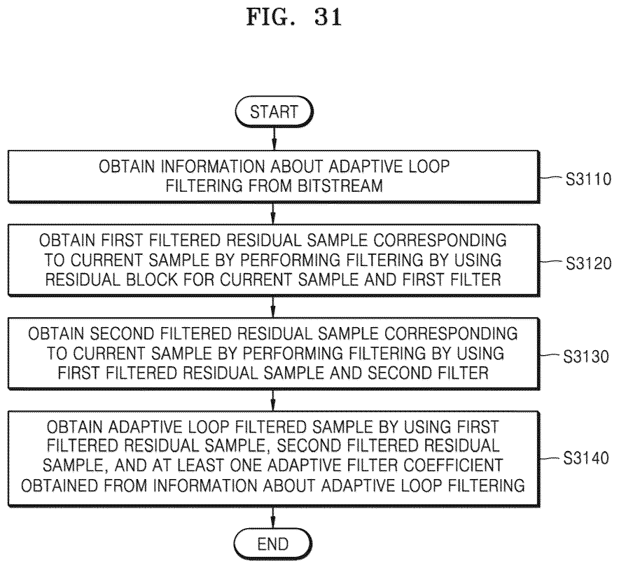

FIG. 31 is a flowchart of an image decoding method according to an embodiment.

In operation S3110, the image decoding apparatus 2000 may obtain information about adaptive loop filtering from a bitstream. The image decoding apparatus 2000 may obtain the information about adaptive loop filtering from an APS. The image decoding apparatus 2000 may obtain the information about adaptive loop filtering from a slice header.

In an embodiment, the image decoding apparatus 2000 may obtain information indicating whether to perform adaptive loop filtering, which is included in the information about adaptive loop filtering. The image decoding apparatus 2000 may obtain information about whether to use an APS filter set included in the information about adaptive loop filtering. The image decoding apparatus 2000 may obtain a filter set index included in the information about adaptive loop filtering.

In an embodiment, the image decoding apparatus 2000 may obtain information about whether to obtain a current APS filter set included in the information about adaptive loop filtering. The image decoding apparatus 2000 may obtain information about the number of filters included in each current APS filter set included in the information about adaptive loop filtering. The image decoding apparatus 2000 may obtain information about at least one APS filter included in the current APS filter set included in the information about adaptive loop filtering. The image decoding apparatus 2000 may obtain an APS index included in the information about adaptive loop filtering.

On the other hand, embodiments of the present disclosure are not limited to the disclosed examples, and the information about adaptive loop filtering may include information necessary to perform adaptive loop filtering.

In operation S3120, the image decoding apparatus 2000 may obtain a first filtered residual sample corresponding to the current sample by performing filtering by using the residual block for the current sample and the first filter.

In an embodiment, the image decoding apparatus 2000 may perform first filtering by using the residual block and the first filter. The image decoding apparatus 2000 may obtain the first filtered residual block including the first filtered residual sample by performing the first filtering by using the residual block and the first filter.

In an embodiment, the image decoding apparatus 2000 may obtain the first filtered residual sample by performing filtering by using the first filter and the residual sample corresponding to the filter coefficient predefined for the first filtering on the residual block or the residual sample. On the other hand, the first filter may be referred to as a filter coefficient predefined for the first filtering.

For example, the image decoding apparatus 2000 may obtain the first filtered residual sample by adding values obtained by applying the filter coefficients corresponding to the respective samples and predefined for the first filter with respect to at least one sample among the residual sample and the neighboring samples of the residual sample. On the other hand, embodiments of the present disclosure are not limited to the disclosed examples, and the image decoding apparatus 2000 may obtain the first filtered residual sample by using a value obtained by multiplying a predefined filter coefficient with respect to the residual sample.

Because operation S3120 has been described in detail with reference to FIGS. 21 to 30, the same description thereof is omitted.

In operation S3130, the image decoding apparatus 2000 may obtain a second filtered residual sample corresponding to the current sample by performing filtering by using the first filtered residual sample and the second filter.

In an embodiment, the image decoding apparatus 2000 may perform second filtering by using the first filtered residual block and the second filter. The image decoding apparatus 2000 may obtain the second filtered residual block including the second filtered residual sample by performing the second filtering by using the first filtered residual block and the second filter.

In an embodiment, the image decoding apparatus 2000 may obtain the second filtered residual sample by performing filtering by using the second filter and the first filtered residual sample corresponding to the filter coefficient predefined for the second filtering on the first filtered residual block or the first filtered residual sample. On the other hand, the second filter may be referred to as a filter coefficient predefined for the second filtering.

For example, the image decoding apparatus 2000 may obtain the second filtered residual sample by applying the filter coefficient predefined for the second filter to the first filtered residual sample. On the other hand, embodiments of the present disclosure are not limited to the disclosed examples, and the image decoding apparatus 2000 may obtain the second filtered residual sample by using a value obtained by multiplying a predefined filter coefficient with respect to the first filtered residual sample.

Because operation S3130 has been described in detail with reference to FIGS. 21 to 30, the same description thereof is omitted.

In operation S3140, the image decoding apparatus 2000 may obtain an adaptive loop filtered sample by using the first filtered residual sample, the second filtered residual sample, and at least one adaptive filter coefficient obtained from the information about adaptive loop filtering.

In an embodiment, the image decoding apparatus 2000 may determine to perform adaptive loop filtering based on information indicating whether to perform adaptive loop filtering included in the information about adaptive loop filtering. The image decoding apparatus 2000 may determine to perform adaptive loop filtering by using the APS filter set based on information about whether to use the APS filter set included in the information about adaptive loop filtering.

In an embodiment, the image decoding apparatus 2000 may obtain at least one current APS filter set included in the information about adaptive loop filtering. The image decoding apparatus 2000 may determine the APS filter set to be used for filtering the current block among at least one APS filter set by using the APS index included in the information about adaptive loop filtering.

In an embodiment, the image decoding apparatus 2000 may perform APS filtering by using the APS filter determined based on at least one of the reconstructed block, the intermediate block, the residual block, and the differential block. To perform the APS filtering, the image decoding apparatus 2000 may determine one of at least one APS filter included in the APS filter set as the APS filter for adaptive loop filtering by using the class determined based on at least one of the reconstructed block, the intermediate filtered block, the residual block, and the differential block.

In an embodiment, the image decoding apparatus 2000 may perform filtering by using the APS filter determined based on the differential block representing the difference between the reconstructed block and the intermediate filtered block. To perform the adaptive loop filtering, the image decoding apparatus 2000 may determine one of at least one APS filter included in the APS filter set by using the class determined based on the differential block.

In an embodiment, the image decoding apparatus 2000 may determine one APS filter for APS filtering based on the determined APS filter set and the class of the current block. The image decoding apparatus 2000 may obtain the adaptive loop filtered sample by performing adaptive loop filtering by using the determined APS filter, the first filtered residual sample, and the second filtered residual sample.

In an embodiment, the image decoding apparatus 2000 may obtain the adaptive loop filtered sample by using a value obtained by adding the intermediate filtered sample to a value obtained by multiplying at least one adaptive filter coefficient included in the APS filter determined for the first filtered residual sample and the second filtered residual sample. The image decoding apparatus 2000 may obtain the adaptive loop filtered block by obtaining adaptive loop filtered samples for at least one sample or all samples included in the current block.

In an embodiment, the image decoding apparatus 2000 may obtain a third filtered residual sample corresponding to the current sample by performing filtering by using the residual sample and the third filter.

In an embodiment, the image decoding apparatus 2000 may obtain the adaptive loop filtered sample by performing APS filtering by using the third filtered residual sample and at least one adaptive filter coefficient. In an embodiment, the image decoding apparatus 2000 may obtain the adaptive loop filtered sample by using a value obtained by adding the intermediate filtered sample to a value obtained by multiplying the APS filter coefficients included in the APS filter determined for at least one sample among the third filtered residual sample and the neighboring samples of the third filtered residual sample. In an embodiment, the image decoding apparatus 2000 may obtain the adaptive loop filtered sample by performing APS filtering by using the third filtered intermediate filtered sample and at least one adaptive filter coefficient. For example, the image decoding apparatus 2000 may obtain the adaptive loop filtered sample by using a value obtained by adding the intermediate filtered sample to a value obtained by multiplying the APS filter coefficient by the difference value between the third filtered intermediate filtered sample and the intermediate filtered sample.

Because operation S3140 has been described in detail with reference to FIGS. 21 to 30, the same description thereof is omitted.

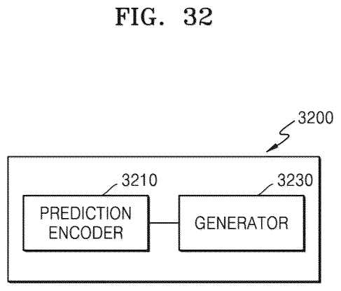

FIG. 32 is a block diagram illustrating a configuration of an image encoding apparatus according to an embodiment.

Referring to FIG. 32, an image encoding apparatus 3200 may include a prediction encoder 3210 and a generator 3230.

The prediction encoder 3210 and the generator 3230, according to an embodiment, may include or be implemented as at least one processor. In an embodiment, the prediction encoder 3210 and the generator 3230 may operate according to at least one instruction stored in at least one memory and executed by the at least one processor individually or collectively.

In an embodiment, the image encoding apparatus 3200 may include at least one memory that stores input and output data of the prediction encoder 3210 and the generator 3230. In addition, the image encoding apparatus 3200 may include a memory controller that controls data input and output of the memory.

In an embodiment, the prediction encoder 3210 may correspond to the prediction encoder 1915 illustrated in FIG. 19, and the generator 3230 may correspond to the entropy encoder 1925 illustrated in FIG. 19.

In an embodiment, the prediction encoder 3210 may obtain a divided slice by dividing one slice into at least one slice. The prediction encoder 3210 may determine at least one APS filter for at least one block included in the divided slice. The prediction encoder 3210 may obtain an APS filter set including the determined at least one APS filter. The prediction encoder 3210 may obtain the APS filter set from each divided slice.

In an embodiment, the prediction encoder 3210 may determine at least one APS filter coefficient corresponding to at least one preset tap so as to determine the APS filter.

In an embodiment, the prediction encoder 3210 may determine at least one APS filter coefficient corresponding to at least one tap or included in at least one tap among a spatial tap, a first filter tap, a second filter tap, a third filter tap, a reconstruction tap, a residual tap, a first residual filter tap, a second residual filter tap, a third residual filter tap, a third intermediate filter tap, and a differential tap.

In an embodiment, the prediction encoder 3210 may determine which filter to use for the current block among the APS filters included in at least one APS filter set and the filters included in at least one predefined filter set. The prediction encoder 3210 may determine, as a filter for adaptive loop filtering of the current block, a filter that generates a filtered block having a small difference from an original block among filtered blocks obtained by performing adaptive loop filtering by using APS filters included in at least one APS filter set and filtered blocks obtained by performing adaptive loop filtering by using filters included in at least one predefined filter set.

In an embodiment, the prediction encoder 3210 may determine to use the APS filter so as to perform adaptive loop filtering on the current block. The prediction encoder 3210 may determine or obtain information about adaptive loop filtering required to obtain the APS filter in the prediction decoder 2030. The information about adaptive loop filtering may include at least one of whether to obtain the current APS filter set, the number of filters included in the current APS filter set, at least one APS filter included in the current APS filter set, and an APS index. The current block may be a CTU, a CU, a transform unit, a prediction unit, or a filtering unit split from a current image to be encoded.

In an embodiment, the prediction encoder 3210 may determine to use the filter included in the predefined filter set, so as to perform adaptive loop filtering on the current block. The prediction encoder 3210 may determine or obtain information about adaptive loop filtering required to obtain the APS filter from the prediction decoder 2030. The information about adaptive loop filtering may include a filter set index.

In an embodiment, the prediction encoder 3210 may compare the difference between the original block and the filtered block obtained by performing adaptive loop filtering with the difference between the original block and the intermediate filtered block, and when it is determined that it is not appropriate to use no adaptive loop filtering, the prediction encoder 3210 may determine information indicating whether to perform adaptive loop filtering as not performing adaptive loop filtering.

In an embodiment, when the filter for the determined adaptive loop filtering of the current block is an APS filter included in at least one APS filter or a filter included in at least one predefined filter set, the prediction encoder 3210 may determine information indicating whether to perform adaptive loop filtering as performing adaptive loop filtering.

In an embodiment, the prediction encoder 3210 may determine the filter set index when the filter for the adaptive loop filtering of the current block is the filter included in at least one predefined filter set, and may determine information about whether to use the APS filter set as not using the APS filter set.

In an embodiment, when the filter for the adaptive loop filtering of the current block is the APS filter included in at least one APS filter set, the prediction encoder 3210 may determine at least one of information about whether to obtain the current APS filter set, information about the number of filters included in each current APS filter set, information about at least one APS filter included in the current APS filter set, and an APS index.

In an embodiment, the prediction encoder 3210 may generate a bitstream including information about adaptive loop filtering, including at least one of information indicating whether to perform adaptive loop filtering, information about whether to use an APS filter set, and a filter set index.

In an embodiment, the prediction encoder 3210 may generate a bitstream including information about adaptive loop filtering, including at least one of information indicating whether to perform adaptive loop filtering, information about whether to obtain the current APS filter set, information about the number of filters included in each current APS filter set, information about at least one APS filter included in the current APS filter set, and an APS index.

In an embodiment, at least one piece of information included in the information about adaptive loop filtering may be included as a flag or an index.

In an embodiment, at least some pieces of the information about adaptive loop filtering may be included in a sequence parameter set, a picture parameter set, an adaptive parameter set, a slice header, or slice data of the bitstream.

In an embodiment, the prediction encoder 3210 may determine information about adaptive loop filtering for the current block according to a predefined method. In this case, the information about adaptive loop filtering may not be included in the bitstream.

In an embodiment, the encoding of the current block may refer to a process of generating information that enables the image decoding apparatus 2000 to reconstruct the current block. The information generated through encoding may be included in the bitstream.

In an embodiment, the generator 3230 may generate the bitstream including the result of encoding the image. The bitstream may include the result of encoding the current block.

In an embodiment, the generator 3230 may transmit the bitstream to the image decoding apparatus 2000 through a network.

In an embodiment, the generator 3230 may store the bitstream in a data storage medium including a magnetic medium, such as hard disk, floppy disk, and magnetic tape, an optical recording medium, such as CD-ROM and DVD, a magneto-optical medium, such as floptical disk, or the like.

In an embodiment, the generator 3230 may generate the bitstream including syntax elements generated through the encoding of the image. Values corresponding to the syntax elements may be included in the bitstream according to a hierarchical structure of the image.

In an embodiment, bitstreams generated when the generator 3230 performs entropy encoding on the syntax elements may be included in the bitstream.

In an embodiment, the bitstream may include information regarding adaptive loop filtering of the current block within the current image. In addition, the information about adaptive loop filtering may be determined based on at least one APS filter set. On the other hand, because the information about adaptive loop filtering has been described above, the same description thereof is omitted.

In an embodiment, because the operation of the image encoding apparatus 3200 may be the same as the operation of the image decoding apparatus 2000, the description of the operation of the image decoding apparatus 2000 may be equally applicable to the image encoding apparatus 3200.

In an embodiment, because the operation of the prediction encoder 3210 of the image encoding apparatus 3200 may be the same as the operation of the prediction decoder 2030 of the image decoding apparatus 2000, the description of the operation of the prediction decoder 2030 may be equally applied to the prediction encoder 3210.

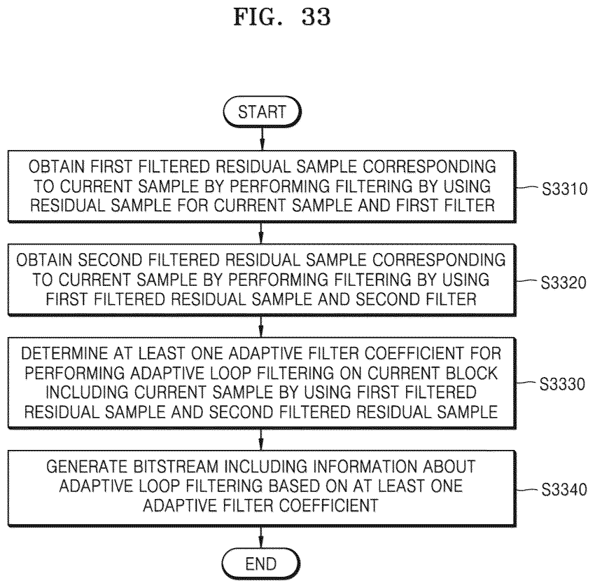

FIG. 33 is a flowchart of an image encoding method according to an embodiment.

In operation S3310, the image encoding apparatus 3200 may obtain a first filtered residual sample corresponding to a current sample by performing filtering by using a residual sample for the current sample and a first filter.

In an embodiment, the image encoding apparatus 3200 may perform filtering on a residual block for a current block by using the first filter. For example, the image encoding apparatus 3200 may determine the first filter corresponding to a class determined according to the current block among filters included in a first predefined filter set.

In an embodiment, the image encoding apparatus 3200 may obtain a first filtered residual block by performing first filtering by using the residual block and the first filter. The image encoding apparatus 3200 may obtain the first filtered residual block including the first filtered residual sample corresponding to the current sample by performing filtering on the residual block by using the first filter. The image encoding apparatus 3200 may obtain the first filtered residual sample by performing filtering on the residual sample by using the first filter.

In an embodiment, the image encoding apparatus 3200 may obtain the first filtered residual sample by performing filtering by using a filter coefficient predefined for the first filtering on the residual sample or the residual block, and the residual sample corresponding to the predefined filter coefficient. On the other hand, the filter coefficient predefined for the first filtering on the residual block may be at least one filter coefficient included in the first filter.

For example, the image encoding apparatus 3200 may obtain, as a value of the first filtered residual sample, a value obtained by calculating the inner product of at least one filter coefficient for the first filtering and a value of at least one sample among the residual sample corresponding to the at least one filter coefficient for the first filtering and neighboring samples of the residual sample.

In operation S3320, the image encoding apparatus 3200 may obtain a second filtered residual sample corresponding to the current sample by performing filtering by using the first filtered residual sample and a second filter.

In an embodiment, the image encoding apparatus 3200 may perform filtering on the first filtered residual block by using the second filter. For example, the image encoding apparatus 3200 may determine the second filter corresponding to a class determined according to the current block among filters included in a second predefined filter set.

In an embodiment, the image encoding apparatus 3200 may obtain a second filtered residual block by performing second filtering by using the first filtered residual block and the second filter. The image encoding apparatus 3200 may obtain the second filtered residual block including the second filtered residual sample corresponding to the current sample by performing filtering on the first filtered residual block by using the second filter. The image encoding apparatus 3200 may obtain the second filtered residual sample by performing filtering on the first filtered residual sample by using the second filter.

In an embodiment, the image encoding apparatus 3200 may obtain the second filtered residual sample by performing filtering by using a filter coefficient predefined for the second filtering on the first filtered residual sample or residual block, and the first filtered residual sample corresponding to the predefined filter coefficient. On the other hand, the filter coefficient predefined for the second filtering on the first filtered residual block may be at least one filter coefficient included in the second filter.

For example, the image encoding apparatus 3200 may obtain, as a value of the second filtered residual sample, a value obtained by calculating the inner product of at least one filter coefficient for the second filtering and a value of at least one sample among the first filtered residual sample corresponding to the at least one filter coefficient for the second filtering and neighboring samples of the first filtered residual sample.

In operation S3330, the image encoding apparatus 3200 may determine at least one adaptive filter coefficient for performing adaptive loop filtering by using the first filtered residual sample and the second filtered residual sample. The at least one adaptive filter coefficient for performing the adaptive loop filtering may be referred to as an APS filter or an adaptive filter.

In an embodiment, the image encoding apparatus 3200 may determine at least one APS filter to be applied to the first filtered residual sample and the second filtered residual sample. The image encoding apparatus 3200 may determine an APS filter set including at least one APS filter.

In an embodiment, the image encoding apparatus 3200 may obtain a divided slice by dividing one slice into at least one slice. The image encoding apparatus 3200 may determine at least one APS filter for at least one block included in the divided slice. The image encoding apparatus 3200 may obtain an APS filter set including the determined at least one APS filter. The image encoding apparatus 3200 may obtain the APS filter set from each divided slice. The image encoding apparatus 3200 may obtain or determine at least one APS filter set for one slice. The image encoding apparatus 3200 may obtain or determine at least one APS filter set including filter coefficients for performing APS filtering on the current block.

For example, the image encoding apparatus 3200 may divide one slice into four slices. The image encoding apparatus 3200 may determine 25 APS filters for at least one block included in four divided slices, and may obtain an APS filter set including the 25 APS filters. The image encoding apparatus 3200 may obtain an APS filter set including the 25 APS filters from each of the four divided slices.

In an embodiment, the image encoding apparatus 3200 may determine at least one adaptive filter coefficient for samples corresponding to the location of at least one preset tap so as to determine the APS filter.

In an embodiment, the image encoding apparatus 3200 may determine at least one adaptive filter coefficient corresponding to at least one tap or included in at least one tap among a spatial tap, a first filter tap, a second filter tap, a third filter tap, a reconstruction tap, a first residual filter tap, a second residual filter tap, a third residual filter tap, a third intermediate filter tap, and a differential tap.

In an embodiment, the image encoding apparatus 3200 may determine at least one APS filter coefficient (adaptive filter coefficient) for at least one sample among an intermediate filtered sample included in the spatial tap and neighboring samples of the intermediate filtered sample, a first filtered sample corresponding to the first filter tap and neighboring samples of the first filtered sample, a second filtered sample corresponding to the second filter tap and neighboring samples of the second filtered sample, a third filtered sample corresponding to the third filter tap and neighboring samples of the third filtered sample, a reconstructed sample corresponding to the reconstruction tap and neighboring samples of the reconstructed sample, a residual sample corresponding to the residual tap and neighboring samples of the residual sample, a first filtered residual sample corresponding to the first residual filter tap and neighboring samples of the first filtered residual sample, a second filtered residual sample corresponding to the second residual filter tap and neighboring samples of the second filtered residual sample, a third filtered residual sample corresponding to the third residual filter tap and neighboring samples of the third filtered residual sample, a third filtered intermediate filtered sample corresponding to the third intermediate filter tap and neighboring samples of the third filtered intermediate filtered sample, and a differential sample corresponding to the differential tap and neighboring samples of the differential sample.

In an embodiment, the image encoding apparatus 3200 may determine at least one adaptive filter coefficient to be applied to at least one sample among an intermediate filtered sample, a first filtered sample, a second filtered sample, a third filtered sample, a reconstructed sample, a residual sample, a first filtered residual sample, a second filtered residual sample, a third filtered residual sample, and a third filtered intermediate filtered sample.

In an embodiment, the image encoding apparatus 3200 may determine the adaptive filter coefficient to be applied to the first filtered residual sample and the second filtered residual sample. In an embodiment, the image encoding apparatus 3200 may determine at least one adaptive filter coefficient to be applied to the first filtered residual sample and the second filtered residual sample. In addition, when the image encoding apparatus 3200 uses the neighboring samples of the first filtered residual sample and/or the neighboring samples of the second filtered residual sample so as to perform filtering on the current sample, the image encoding apparatus 3200 may determine at least one adaptive filter coefficient corresponding to each of the neighboring samples of the first filtered residual sample and/or the neighboring samples of the second filtered residual sample.

In an embodiment, the image encoding apparatus 3200 may determine the adaptive filter coefficient to be applied to the third filtered residual sample. For example, the image encoding apparatus 3200 may determine at least one adaptive filter coefficient corresponding to at least one sample among the third filtered residual sample corresponding to the third residual filter tap and the neighboring samples of the third filtered residual sample.

In an embodiment, the image encoding apparatus 3200 may determine the adaptive filter coefficient to be applied to the third filtered intermediate filtered sample. In an embodiment, the image encoding apparatus 3200 may determine at least one adaptive filter coefficient corresponding to at least one sample among the third filtered intermediate filtered sample and the neighboring samples of the third filtered intermediate filtered sample.

In an embodiment, the image encoding apparatus 3200 may determine the adaptive filter coefficient to be applied to the differential sample. For example, the image encoding apparatus 3200 may determine at least one adaptive filter coefficient corresponding to at least one sample among the differential sample corresponding to the differential tap and the neighboring samples of the differential sample.

In operation S3340, the image encoding apparatus 3200 may generate a bitstream including information about adaptive loop filtering based on at least one adaptive filter coefficient.

In an embodiment, the image encoding apparatus 3200 may determine at least one APS filter. The image encoding apparatus 3200 may determine or obtain an APS filter set including at least one APS filter. The image encoding apparatus 3200 may determine or obtain at least one APS filter set. On the other hand, each APS filter may include at least one adaptive filter coefficient.

In an embodiment, the image encoding apparatus 3200 may determine the most appropriate APS filter among at least one APS filter included in each APS filter set. For example, the image encoding apparatus may determine an index indicating one APS filter set among at least one APS filter set and/or an index indicating one APS filter among at least one APS filter.

For example, the image encoding apparatus 3200 may determine, as a filter for adaptive loop filtering of the current block, a filter that generates a filtered block having a small difference from an original block, among an adaptive loop filtered block including adaptive loop filtered samples obtained by performing adaptive loop filtering by using at least one APS filter included in at least one APS filter set and a filtered block obtained by performing adaptive loop filtering by using a filter included in at least one predefined filter set. In addition, the determined filter may be an adaptive filter.

In an embodiment, one filter among the at least one APS filter may be based on the determined at least one adaptive filter coefficient.

On the other hand, the at least one APS filter set may include at least one current APS filter set including at least one APS filter determined for the current block or the current slice, or at least one previous APS filter set including at least one APS filter determined for the previous block or the previous slice.

In an embodiment, the image encoding apparatus 3200 may compare the difference between the original block and the filtered block obtained by performing adaptive loop filtering with the difference between the original block and the intermediate filtered block, and when it is determined that it is not appropriate to use no adaptive loop filtering, the image encoding apparatus 3200 may determine information indicating whether to perform adaptive loop filtering as not performing adaptive loop filtering.

In an embodiment, when the filter for the determined adaptive loop filtering of the current block is an APS filter included in at least one APS filter set or a filter included in at least one predefined filter set, the image encoding apparatus 3200 may determine information indicating whether to perform adaptive loop filtering as performing adaptive loop filtering.

In an embodiment, the image encoding apparatus 3200 may determine the filter set index when the filter for the adaptive loop filtering of the current block is the filter included in at least one predefined filter set, and may determine information about whether to use the APS filter set as not using the APS filter set.

In an embodiment, when the filter for the adaptive loop filtering of the current block is the APS filter included in at least one APS filter set, the image encoding apparatus 3200 may determine at least one of information about whether to obtain the current APS filter set, information about the number of filters included in each current APS filter set, information about at least one APS filter included in the current APS filter set, and an APS index.

In an embodiment, the image encoding apparatus 3200 may generate a bitstream including information about adaptive loop filtering, including at least one of information indicating whether to perform adaptive loop filtering, information about whether to use an APS filter set, and a filter set index.

In an embodiment, the image encoding apparatus 3200 may generate a bitstream including information about adaptive loop filtering, including at least one of information indicating whether to perform adaptive loop filtering, information about whether to obtain the current APS filter set, information about the number of filters included in each current APS filter set, information about at least one APS filter included in the current APS filter set, and an APS index.

In an embodiment, the information about adaptive loop filtering may be included in a sequence parameter set, a picture parameter set, an adaptive parameter set, a slice header, or slice data of the bitstream.

In an embodiment of the present disclosure, an image decoding method for adaptive loop filtering is provided. The image decoding method may include obtaining information about adaptive loop filtering from a bitstream (S3110). The image decoding method may include obtaining a first filtered residual sample corresponding to a current sample by performing filtering by using a residual sample for the current sample and a first filter (S3120). The image decoding method may include obtaining a second filtered residual sample corresponding to the current sample by performing filtering by using the first filtered residual sample and a second filter (S3130). The image decoding method may include obtaining an adaptive loop filtered sample by using the first filtered residual sample, the second filtered residual sample, and at least one adaptive filter coefficient obtained from the information about the adaptive loop filtering (S3140).

In an embodiment, the image decoding method may further include obtaining a third filtered residual sample corresponding to the current sample by performing filtering by using the residual sample and a third filter. The image decoding method may include obtaining the adaptive loop filtered sample by using the third filtered residual sample and the at least one adaptive filter coefficient.

In an embodiment, the image decoding method may further include obtaining a third filtered intermediate filtered sample corresponding to the current sample by performing filtering by using a third filter and an intermediate filtered sample obtained by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on a reconstructed block for a current block. The image decoding method may include obtaining the adaptive loop filtered sample by using the third filtered intermediate filtered sample and the at least one adaptive filter coefficient.

In an embodiment, the first filter and the second filter may be determined based on at least one of a reconstructed block for a current block, an intermediate filtered block obtained by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on the reconstructed block, and a residual block.

In an embodiment, the image decoding method may include using an adaptive filter determined based on at least one of a reconstructed block for a current block, an intermediate filtered block obtained by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on the reconstructed block, and a residual block.

In an embodiment, the first filter and the second filter may be determined based on a differential block representing a difference between a reconstructed block for a current block and an intermediate filtered block obtained by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on the reconstructed block.

In an embodiment, the image decoding method may include using an adaptive filter determined based on a differential block representing a difference between a reconstructed block for a current block and an intermediate filtered block obtained by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on the reconstructed block.

In an embodiment, the image decoding method may include performing APS filtering 2790, 2890, 2990, and 3090 on the current block by using a differential sample included in the differential block and at least one adaptive filter coefficient.

In an embodiment, the information about the adaptive loop filtering may include information indicating whether to perform the adaptive loop filtering.

In an embodiment, the information about the adaptive loop filtering may include information about whether to use an adaptive filter set.

In an embodiment, the information about the adaptive loop filtering may include information about at least one adaptive filter included in an adaptive filter set.

In an embodiment, the image decoding method may include obtaining an intermediate filtered sample corresponding to the current sample by performing at least one of deblocking filtering 2410, 2710, 2810, 2910, and 3010, sample adaptive offset filtering 2420, 2720, 2820, 2920, and 3030, and bilateral filtering 2425, 2725, 2825, 2925, and 3025 on a reconstructed block for a current block. The image decoding method may include obtaining a first filtered sample corresponding to the current sample by performing filtering by using a reconstructed sample included in the reconstructed block, the intermediate filtered sample, and the first filter. The image decoding method may include obtaining a second filtered sample corresponding to the current sample by performing filtering by using the reconstructed sample, the first filtered sample, and the second filter. The image decoding method may include obtaining a third filtered sample corresponding to the current sample by performing filtering by using the reconstructed sample, the intermediate filtered sample, and a third filter.

In an embodiment, the image decoding method may include obtaining the adaptive loop filtered sample by using the intermediate filtered sample, the first filtered sample, the second filtered sample, the third filtered sample, the reconstructed sample, the residual sample, and the at least one adaptive filter coefficient.

In an embodiment, an image decoding apparatus 2000 for adaptive loop filtering may include at least one memory storing at least one instruction and at least one processor operating according to the at least one instruction. The at least one processor may obtain information about adaptive loop filtering from a bitstream. The at least one processor may obtain a first filtered residual sample corresponding to the current sample by performing filtering on the residual sample for the current sample by using the first filter. The at least one processor may obtain a second filtered residual sample corresponding to the current sample by performing filtering by using the first filtered residual sample and a second filter. The at least one processor may obtain an adaptive loop filtered sample by using the first filtered residual sample, the second filtered residual sample, and at least one adaptive filter coefficient obtained from the information about the adaptive loop filtering.

In an embodiment, an image encoding method for adaptive loop filtering is provided. The image encoding method may include obtaining a first filtered residual sample corresponding to a current sample by performing filtering by using a residual sample for the current sample and a first filter (S3310). The image encoding method may include obtaining a second filtered residual sample corresponding to the current sample by performing filtering by using the first filtered residual sample and a second filter (S3320). The image encoding method may include determining at least one adaptive filter coefficient for performing adaptive loop filtering on a current block including the current sample by using the first filtered residual sample and the second filtered residual sample (S3330). The image encoding method may include generating a bitstream including information about the adaptive loop filtering based on the at least one adaptive filter coefficient (S3340).

In an embodiment, the image encoding method may further include obtaining a third filtered residual sample corresponding to the current sample by performing filtering by using the residual sample and a third filter, wherein the determining of the at least one adaptive filter coefficient for performing the adaptive loop filtering on the current block (S3330) may include determining the at least one adaptive filter coefficient for performing the adaptive loop filtering on the current block by using the third filtered residual sample.

In an embodiment, an image encoding apparatus 3200 for adaptive loop filtering may include at least one memory storing at least one instruction and at least one processor operating according to the at least one instruction. The at least one processor may obtain a first filtered residual sample corresponding to the current sample by performing filtering by using the residual sample for the current sample and the first filter. The at least one processor may obtain a second filtered residual sample corresponding to the current sample by performing filtering by using a first filtered residual block and a second filter. The at least one processor may determine at least one adaptive filter coefficient for performing adaptive loop filtering on a current block by using the first filtered residual sample and the second filtered residual sample. The at least one processor may generate a bitstream including information about adaptive loop filtering based on at least one adaptive filter coefficient.

In an embodiment, a computer-readable recording medium having a bitstream recorded thereon is provided. The bitstream may include information about adaptive loop filtering. The information about the adaptive loop filtering may be based on at least one adaptive filter coefficient for performing adaptive loop filtering on a current block including the current sample, wherein the at least one adaptive filter coefficient may be determined by using a first filtered residual sample and a second filtered residual sample, wherein the first filtered residual sample corresponding to the current sample may be obtained by performing filtering by using a residual sample for the current sample and a first filter, and wherein the second filtered residual sample corresponding to the current sample may be obtained by performing filtering by using the first filtered residual sample and a second filter.

A machine-readable storage medium may be provided in the form of a non-transitory storage medium. The “non-transitory storage medium” is a tangible device and only means not including a signal (e.g., electromagnetic waves). This term does not distinguish between a case where data is semi-permanently stored in a storage medium and a case where data is temporarily stored in a storage medium. For example, the “non-transitory storage medium” may include a buffer in which data is temporarily stored.

The methods according to various embodiments may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

What is claimed is:

1. An image decoding method comprising:
obtaining information regarding adaptive loop filtering from a bitstream;
obtaining a first filtered residual sample corresponding to a current sample by performing filtering based on a residual sample for the current sample and a first filter;
obtaining a second filtered residual sample corresponding to the current sample by performing filtering based on the first filtered residual sample and a second filter; and
obtaining an adaptive loop filtered sample based on the first filtered residual sample, the second filtered residual sample, and at least one adaptive filter coefficient obtained from the information regarding the adaptive loop filtering.

2. The image decoding method of claim 1, further comprising obtaining a third filtered residual sample corresponding to the current sample by performing filtering based on the residual sample and a third filter,
wherein the obtaining the adaptive loop filtered sample comprises obtaining the adaptive loop filtered sample based on the third filtered residual sample and the at least one adaptive filter coefficient.

3. The image decoding method of claim 1, further comprising obtaining a third filtered intermediate filtered sample corresponding to the current sample by performing filtering based on a third filter and an intermediate filtered sample obtained by performing at least one of deblocking filtering, sample adaptive offset filtering, and bilateral filtering on a reconstructed block for a current block including the current sample,
wherein the obtaining the adaptive loop filtered sample comprises obtaining the adaptive loop filtered sample based on the third filtered intermediate filtered sample and the at least one adaptive filter coefficient.

4. The image decoding method of claim 1, wherein the first filter and the second filter are determined based on at least one of a reconstructed block for a current block including the current sample, an intermediate filtered block obtained by performing at least one of deblocking filtering, sample adaptive offset filtering, and bilateral filtering on the reconstructed block, and a residual block including the residual sample.

5. The image decoding method of claim 1, wherein the obtaining the adaptive loop filtered sample comprises obtaining the adaptive loop filtered sample based on an adaptive filter determined based on at least one of a reconstructed block for a current block including the current sample, an intermediate filtered block obtained by performing at least one of deblocking filtering, sample adaptive offset filtering, and bilateral filtering on the reconstructed block, and a residual block including the residual sample.

6. The image decoding method of claim 1, wherein the first filter and the second filter are determined based on a differential block representing a difference between a reconstructed block for a current block including the current sample and an intermediate filtered block obtained by performing at least one of deblocking filtering, sample adaptive offset filtering, and bilateral filtering on the reconstructed block.

7. The image decoding method of claim 1, wherein the obtaining the adaptive loop filtered sample comprises using an adaptive filter determined based on a differential block representing a difference between a reconstructed block for a current block including the current sample and an intermediate filtered block obtained by performing at least one of deblocking filtering, sample adaptive offset filtering, and bilateral filtering on the reconstructed block.

8. The image decoding method of claim 6, wherein the obtaining the adaptive loop filtered sample comprises obtaining the adaptive loop filtered sample based on a differential sample included in the differential block and the at least one adaptive filter coefficient.

9. The image decoding method of claim 1, wherein the information regarding the adaptive loop filtering comprises information indicating whether to perform the adaptive loop filtering.

10. The image decoding method of claim 1, wherein the information regarding the adaptive loop filtering comprises information regarding whether to use an adaptive filter set.

11. The image decoding method of claim 1, wherein the information regarding the adaptive loop filtering comprises information regarding at least one adaptive filter included in an adaptive filter set.

12. The image decoding method of claim 1, further comprising:
obtaining an intermediate filtered sample corresponding to the current sample by performing at least one of deblocking filtering, sample adaptive offset filtering, and bilateral filtering on a reconstructed block for a current block including the current sample;
obtaining a first filtered sample corresponding to the current sample by performing filtering based on a reconstructed sample included in the reconstructed block, the intermediate filtered sample, and the first filter;
obtaining a second filtered sample corresponding to the current sample by performing filtering based on the reconstructed sample, the first filtered sample, and the second filter; and
obtaining a third filtered sample corresponding to the current sample by performing filtering based on the reconstructed sample, the intermediate filtered sample, and a third filter,
wherein the obtaining the adaptive loop filtered sample comprises obtaining the adaptive loop filtered sample by using the intermediate filtered sample, the first filtered sample, the second filtered sample, the third filtered sample, the reconstructed sample, the residual sample, and the at least one adaptive filter coefficient.

13. An image encoding method comprising:
obtaining a first filtered residual sample corresponding to a current sample by performing filtering based on a residual sample for the current sample and a first filter;
obtaining a second filtered residual sample corresponding to the current sample by performing filtering based on the first filtered residual sample and a second filter;
determining at least one adaptive filter coefficient for performing adaptive loop filtering on a current block including the current sample by using the first filtered residual sample and the second filtered residual sample; and
generating a bitstream including information regarding the adaptive loop filtering based on the at least one adaptive filter coefficient.

14. The image encoding method of claim 13, further comprising obtaining a third filtered residual sample corresponding to the current sample by performing filtering based on the residual sample and a third filter,
wherein the determining the at least one adaptive filter coefficient for performing the adaptive loop filtering on the current block comprises determining the at least one adaptive filter coefficient for performing the adaptive loop filtering on the current block based on the third filtered residual sample.

15. A method for transmitting a bitstream, comprising:
performing the image encoding method of claim 13 to generate the bitstream, and
transmitting the bitstream.
